(19) United States
(12) Patent Application Publication
(10) Pub. No.: US 2002/0032798 A1
(43) Pub. Date: Mar. 14, 2002

(54) Systems and methods for packet sequencing

(76) Inventor: Wei Xu, North Bethesda, MD (US)

Correspondence Address: Michele M. Burris, SHAW PITTMAN LLP, 1650 Tysons Boulevard, McLean, VA, 22102, US

(21) Appl. No.: 09/930,471

(22) Filed: Aug. 16, 2001

Related U.S. Application Data
(60) Provisional application No. 60/231,230, filed on Sep. 8, 2000.

(51) Int. Cl. G06F 15/173

(52) U.S. Cl. 709/238; 713/201; 709/246; 709/249

(57) ABSTRACT

Embodiments of the present invention relate to methods and systems of managing delivery of a network service. In an embodiment, a data packet including a service address and a payload is received. A plurality of network applications associated with the service address of the data packet are identified. The plurality of network applications associated with the service address include a first network application and a second network application, where the first network application is different than the network application. At least the payload of the data packet is sent to the first network application, and a first network application response packet is received from the first network application. A second network application packet is sent to the second network application, and the second network application packet is based at least in part on the first network application response packet.

This application claims the benefit of U.S. Provisional Application No. 60/231,230 filed Sep. 8, 2000, which is herein incorporated by reference in its entirety.

### BACKGROUND

1. Field of the Invention

Embodiments of the present invention relate to the provision of advanced network services. More particularly, embodiments of the present invention relate to the dynamic creation of customized service environments over existing networks.

2. Background of the Invention

Network applications encompass a vast variety of applications typically used to accomplish one or more tasks. Common examples of network applications include software applications, front-end and back-end database applications, and other information processing and retrieval applications that can be accessed via a network. In addition to such application-based applications, network applications also include systems and applications designed to enhance network capabilities. For example, network applications include security-related systems such as firewalls, intrusion detection systems (IDS), virus scanning systems, system and user authentication, encryption, Internet access control, and the like. Network applications also include bandwidth management, load balancing systems, redundancy management systems, and other applications that enhance network utilization and availability. Another class of network applications include applications that extend the capabilities of the network, such as virtual private networks (VPNs), voice over IP servers, gateways to wireless devices, and the like.

Network applications may be provided by an application service provider (ASP), an Internet service provider (ISP), by internal enterprise service providers, or by some combination of these or other providers. With such a wide variety of network applications, service providers, and product vendors, implementation and management of diverse network applications has typically required extensive planning, configuration management, compatibility testing, and the like, in addition to highly skilled technicians to perform these and similar tasks. Accordingly, known provisioning of network applications typically has fallen into one or more of the following scenarios: “Hard-wired,” “Big Box,” and “Big Brother.” Each of these known technology categories is described below:

A. Hard-wired

In a hard-wired solution, service providers (such as application service providers, managed web hosters, or providers of outsourced security) and corporate end-users enlist the services of expensive engineers to configure “hard-wired” network environments that deliver a desired combination and sequence of applications. An example of a typical hard-wired network is shown in FIG. 1. Firewall 60, VPN 50, virus scanning appliance 55, switch 40, and application servers 71-74 are under the control of either (i) a service provider supporting its subscribers, or (ii) a large corporate customer servicing its end-users. As used herein, the terms “user,” “end-user,” “user system,” “client,” “client system,” and “subscriber” encompass a person, entity, computer, or device utilizing network applications. In this example, end-users 21-23 require access to one or more of application servers 71-74. Firewall 60, VPN 50, virus scanning appliance 55, and switch 40 have been inserted into the path to secure and optimize the network traffic between the users and the application servers. The configuration shown in FIG. 1 is “hard-wired” in that all network traffic flowing from end-users 21-23 to application servers 71-74 via network 30 must be inspected by the firewall 60, VPN 50, and virus scanning appliance 55. Network 30 may be any network providing a communications path between the systems. An example of network 30 is the well-known Internet.

Hard-wired environments have several limitations. For example, they are labor-intensive to configure and integrate. Additionally, there is little flexibility for the end-users because end-users 21-23 are forced to use the predefined set of intermediate devices (i.e., those systems that have been inserted into the IP path) whenever they access application servers 71-74. Such inflexibility is further accentuated because the predefined set of systems incorporates specific vendor products and supports only specific versions of those products. If a potential subscriber does not want its traffic to be processed by all of the systems in the sequence, or wants to change one or more of the systems in the sequence, or has existing systems that are not compatible with the predefined products and versions, a separate sequence of compatible systems must be “hard-wired” to suit the new subscriber's requirements. The result is an overly complex environment populated by redundant hardware and/or software that is often poorly optimized. Because of this inflexibility, network infrastructure is typically dedicated to the subscriber or to a particular service and cannot be shared between subscribers/services.

Another problem with hard-wired solutions is difficulty in performing system migration (e.g., upgrades) and system maintenance, each of which typically results in service interruption. Additionally, as noted above, implementation relies upon scarce, well-trained, human resources. Accordingly, the “hard-wired” path is expensive and time consuming to change and maintain.

Configuration of these “hard-wired” services is closely tied to IP addressing and the use of subnets. Designing and maintaining the address schema and assignments is a complex and time-consuming process. Hard-wired environments are closely tied to IP addressing because individual end applications are primarily defined at the IP address layer. For example, when one of end-users 21-23 attempts to access one of application servers 71-74, the network packets are sent to a particular IP address tied to a particular application server or a particular group of identically configured application servers. Conventional IP topology issues prevent the sharing of infrastructure because of this reliance on IP addresses for access to identify a particular application server. Furthermore, service infrastructure must be dedicated to support compatibility or customization. The dedication of resources results in the under-utilization of data center infrastructure and causes needless expense in the areas of human resources, hardware and software acquisition, and ongoing maintenance.

B. Big Box

Some vendors have sought to simplify provisioning and management of network applications by merging several of the “hard-wired” network components into a single chassis that has a shared backplane. As shown schematically in FIG. 2, “Big Box” 80 incorporates firewall 61, VPN 51, and virus scanning appliances 56 as separate boards or “blades” internal to Big Box 80. Traffic from clients 21-23 still must pass through Big Box 80 and its integral firewall 61, VPN 51, and virus scanning appliance 56. This approach reduces the number of physical systems that must be maintained. However, there are several limitations with the Big Box approach for both the vendor and customer of the Big Box solution.

The vendor typically must negotiate with the originator of each component technology to gain the right to incorporate it into the Big Box. Furthermore, the vendor usually must gain an extensive understanding of each network component. It is time consuming and expensive to integrate the network component functions into the single chassis. Accordingly, it is difficult to react to customer requests for modified or additional capabilities. The vendor's sales (and therefore profits) are restricted by the long lead time required to introduce new capabilities to the marketplace. Finally, vendors must also engage in an ongoing effort to maintain compatibility and currency with each network component of the Big Box.

For the customer, the Big Box solution provides only a narrow set of available network component functions. The Big Box is not well adapted to provide the customized solution that a customer may require. Further, there is no way to address compatibility issues that may arise between the customer's existing systems and the components of the Big Box. As noted above, new capabilities are introduced very slowly in Big Box solutions due to the complexity and compatibility problems faced by vendors. Finally, should any of the components of the Big Box become obsolete due to the introduction of new technology, the value of the entire Big Box is undermined.

C. “Big Brother”

A third system approach for provisioning and maintaining network applications includes use of centralized systems that reach out “machine-to-machine” to modify the parameters and settings used by several network components. FIG. 3 shows an illustration of “Big Brother” system 1984 that modifies parameters and settings on a variety of network components. As shown in FIG. 3, network traffic between the users 21-23 and the application servers 71-74 travels a path that includes systems updated and managed by Big Brother system 1984. Big Brother system 1984 provides automated management of the hard-wired environment by updating parameters and settings on the network components 61, 50, and 55 to implement and maintain the applications required by the subscriber or end-user. The Big Brother solution utilizes a hard-wired environment, which has the limitations described above. Further, the use of Big Brother has other inherent limitations that make the solution undesirable for many users. For example, the approach requires an extensive understanding of each network component's interface. Also, the approach requires an ongoing effort to maintain compatibility with each network component's interfaces, such as command line, application programming interface (API), and simple network management protocol (SNMP) management information base (MIB). The parameters and settings on the network components can be changed whenever desired, however, only a few network components, such as bandwidth and quality of service (QoS) management devices, support dynamic reconfiguration. Most network components must be restarted to effect changes.

To summarize, conventional approaches for provisioning and maintaining network services make inefficient use of infrastructure, make it prohibitively expensive to configure customized network services for subscribers, and strictly limit the customization options that are available. In view of the foregoing, it can be appreciated that a substantial need exists for systems and methods that enable the simple, flexible, and dynamic delivery of customized network services.

### SUMMARY OF THE INVENTION

Embodiments of the present invention relate to methods and systems of managing delivery of a network service. In an embodiment, a data packet including a service address and a payload is received. A plurality of network applications associated with the service address of the data packet are identified. The plurality of network applications associated with the service address include a first network application and a second network application, where the first network application is different than the second network application. At least the payload of the data packet is sent to the first network application, and a first network application response packet is received from the first network application. A second network application packet is sent to the second network application, and the second network application packet is based at least in part on the first network application response packet.

### BRIEF DESCRIPTION OF THE DRAWINGS

FIG. 1 is a schematic diagram illustrating “Hard-wired” technology of known art.

FIG. 2 is a schematic diagram illustrating the “Big Box” technology of known art.

FIG. 3 is a schematic diagram illustrating the “Big Brother” technology of the known art.

FIG. 4 is a schematic diagram illustrating an embodiment of the invention.

FIG. 5 is a schematic diagram showing the flow of network traffic for an embodiment of the present invention including a single server.

FIG. 5A is a table detailing the flow of packets between the nodes shown in FIG. 5.

FIG. 5B is a schematic diagram showing the flow of network traffic for an embodiment of the present invention including a single server operating in loopback mode.

FIG. 5C is a table detailing the flow of packets between the nodes shown in FIG. 5B.

FIG. 5D is a sequence table that can be maintained by the packeting engine shown in FIG. 5B.

FIG. 5E is a schematic diagram showing the flow of network traffic for an embodiment of the present invention including a single server operating in alias mode.

FIG. 5F is a table detailing the flow of packets between the nodes shown in FIG. 5E.

FIG. 5G is a sequence table that can be maintained by the packeting engine shown in FIG. 5E.

FIG. 5H is a schematic diagram showing the flow of network traffic for an embodiment of the present invention including a single server that is addressed using NAT.

FIG. 5I is a table detailing the flow of packets between the nodes shown in FIG. 5H.

FIG. 5J is a sequence table that can be maintained by the packeting engine shown in FIG. 5H.

FIG. 6 is a schematic diagram showing the flow of network traffic for an embodiment of the present invention including two servers and two applications, accessible via the same service IP address.

FIG. 6A is a table detailing the flow of packets between the nodes shown in FIG. 6.

FIG. 6B is a sequence table that can be maintained by the packeting engine shown in FIG. 6.

FIG. 7 is a schematic diagram showing the flow of network traffic for an embodiment of the present invention including multiple appliances and application servers.

FIG. 7A is a table detailing the flow of packets between the nodes shown in FIG. 7.

FIG. 7B is a sequence table that can be maintained by the packeting engine shown in FIG. 7.

FIG. 8 is a schematic diagram showing the flow of network traffic for an embodiment of the present invention including dynamic translation of the service port before communicating with an application server.

FIG. 8A is a table showing the translation of service ports for the embodiment shown in FIG. 8.

FIG. 8B is a table detailing the flow of packets between the nodes shown in FIG. 8.

FIG. 8C is a sequence table that can be maintained by the packeting engine shown in FIG. 8.

FIG. 9 is a schematic diagram showing the flow of network traffic for an embodiment of the present invention including service port negotiation between an application server and client without changing the service IP address.

FIG. 9A is a table detailing the flow of packets between the nodes shown in FIG. 9.

FIG. 9B is a sequence table that can be maintained by the packeting engine shown in FIG. 9.

FIG. 9C is a schematic diagram showing the flow of network traffic for an embodiment of the present invention including service port and IP address negotiation between an application server and client without a need to change the service IP address.

FIG. 9D is a table detailing the flow of packets between the nodes shown in FIG. 9C.

FIG. 9E is a sequence table that can be maintained by the packeting engine shown in FIG. 9C.

FIG. 10 is a schematic diagram illustrating creation of customized services for multiple customers using a provisioning engine according to an embodiment of the present invention.

FIG. 11 is a schematic diagram showing the flow of network traffic for an embodiment of the present invention including real-time intrusion detection when intrusion detection systems are attached to an intermediate switch.

FIG. 11A is a schematic diagram showing the flow of network traffic for an embodiment of the present invention including real-time intrusion detection when intrusion detection systems are attached to separate interfaces of a packeting engine.

FIG. 12 is a schematic diagram showing the flow of network traffic for an embodiment of the present invention including incorporation of an external Internet server into a customized service according to the present invention.

FIG. 13 is a schematic diagram showing the flow of network traffic for an embodiment of the present invention including real-time updates to access control rules maintained on a packeting engine.

FIG. 14 is a schematic diagram showing the flow of network traffic for an embodiment of the present invention including use of database servers within a customized service according to the present invention.

FIG. 14A is a table detailing the flow of packets between the nodes for a service shown in FIG. 14.

FIG. 14B is a table detailing the flow of packets between the nodes for another service shown in FIG. 14.

FIG. 14C is a table detailing the flow of packets between the nodes for another service shown in FIG. 14.

FIG. 14D is a table detailing the flow of packets between the nodes for another service shown in FIG. 14.

FIG. 15 is a schematic diagram showing of an embodiment of the present invention including redundant packeting engines.

FIG. 15A is a schematic diagram showing of an embodiment of the present invention including a packeting engine load sharing configuration.

FIG. 15B is a schematic diagram showing of an embodiment of the present invention including pools of like devices for application redundancy.

FIG. 15C is a portion of a table that can be maintained by the packeting engine shown in FIG. 15B and shows how the packeting engine can implement automatic fail-over between devices.

FIG. 15D is a schematic diagram showing of an embodiment of the present invention including an external fail-over management system.

FIG. 16 is a schematic diagram showing of an embodiment of the present invention depicting a first scalability dimension of one client to one server.

FIG. 16A is a schematic diagram showing of an embodiment of the present invention depicting a second scalability dimension of port-based routing.

FIG. 16B is a schematic diagram showing of an embodiment of the present invention depicting a third scalability dimension of multiple service IP addresses.

FIG. 16C is a schematic diagram showing of an embodiment of the present invention depicting a fourth scalability dimension of multiple packeting engines.

FIG. 17 is a schematic diagram showing of an embodiment of the present invention including load balancing of network traffic for a service by assigning different service names and associated service IP addresses to different groups of users.

FIG. 17A is a table of DNS entries associated with the nodes shown in FIG. 17.

FIG. 17B is a schematic diagram showing of an embodiment of the present invention including load balancing of network traffic for a service by assigning different service IP addresses to the same service name used by different groups of users wherein the service IP addresses are all directed to the same packeting engine.

FIG. 17C is a table of DNS entries associated with the nodes shown in FIG. 17B.

FIG. 17D is a schematic diagram showing of an embodiment of the present invention including load balancing of network traffic for a service by assigning different service IP addresses to the same service name used by a group of users wherein the service IP addresses are all directed to different packeting engines.

FIG. 17E is a table of DNS entries associated with the nodes shown in FIG. 17D.

FIG. 17F is a schematic diagram showing of an embodiment of the present invention wherein network traffic from different groups of users is directed to the same service IP address and a load balancing system is incorporated after the traffic has passed through a packeting engine.

FIG. 17G is a schematic diagram showing of an embodiment of the present invention wherein network traffic from different groups of users is directed to a load balancing system where a service IP address is dynamically assigned to the traffic based on network and service loads before the traffic is sent on to a packeting engine for further distribution.

FIG. 17H is a table of DNS entries associated with the nodes shown in FIG. 17G.

FIG. 17I is a schematic diagram showing an embodiment of the present invention wherein network traffic from different groups of users is directed to a load balancing system where a service IP address is dynamically assigned to the traffic based on network and service loads before the traffic is sent on to different packeting engines for further distribution to common servers.

FIG. 17J is a schematic diagram showing an embodiment of the present invention wherein network traffic from different groups of users is directed to a load balancing system where a service IP address is dynamically assigned to the traffic based on network and service loads before the traffic is sent on to different packeting engines for further distribution to redundant sets of servers.

FIG. 18 is a schematic diagram of various features of embodiments of the present invention that may be incorporated to provide high performance.

FIG. 19 is a schematic diagram of accounting, billing, and monitoring components that may be included in an embodiment of the present invention.

FIG. 20 is a schematic diagram showing a process flow that can be used in an embodiment of the present invention to automatically regenerate services to accommodate replacements for failed applications.

FIG. 21 is a schematic diagram showing a process flow that can be used in an embodiment of the present invention for performing testing across a production network infrastructure.

FIG. 22 is a schematic diagram showing a process flow that can be used in an embodiment of the present invention for cutting-over and rolling-back new services.

FIG. 23 is a schematic diagram of an embodiment of the present invention that can be implemented by an Internet Service Provider.

FIG. 24 shows a schematic illustration of an embodiment of the present invention.

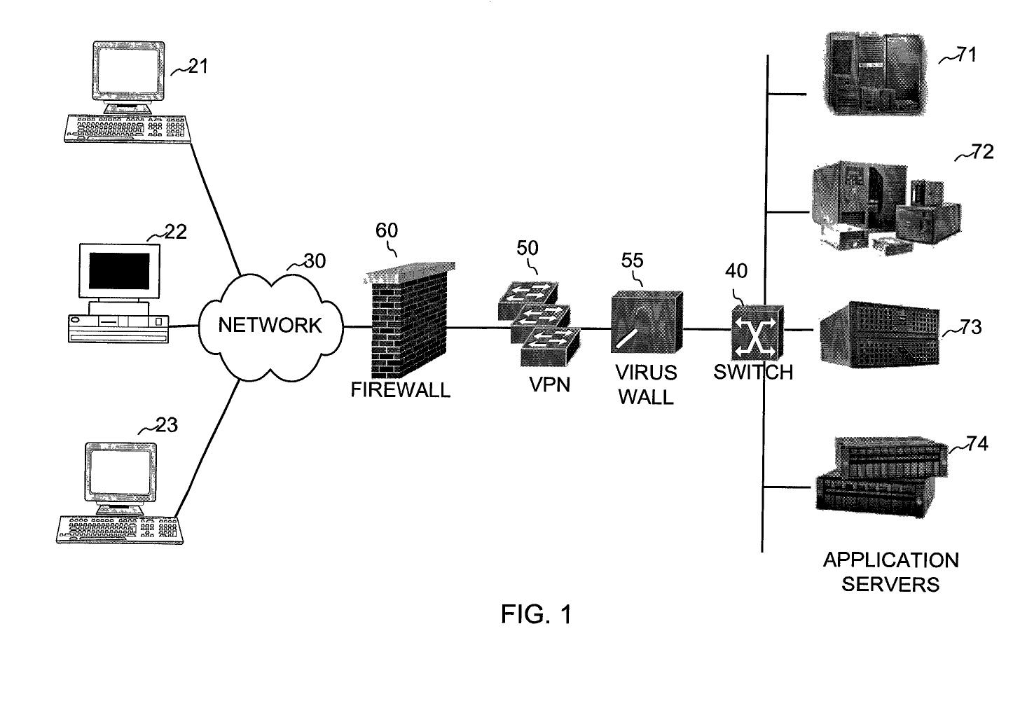

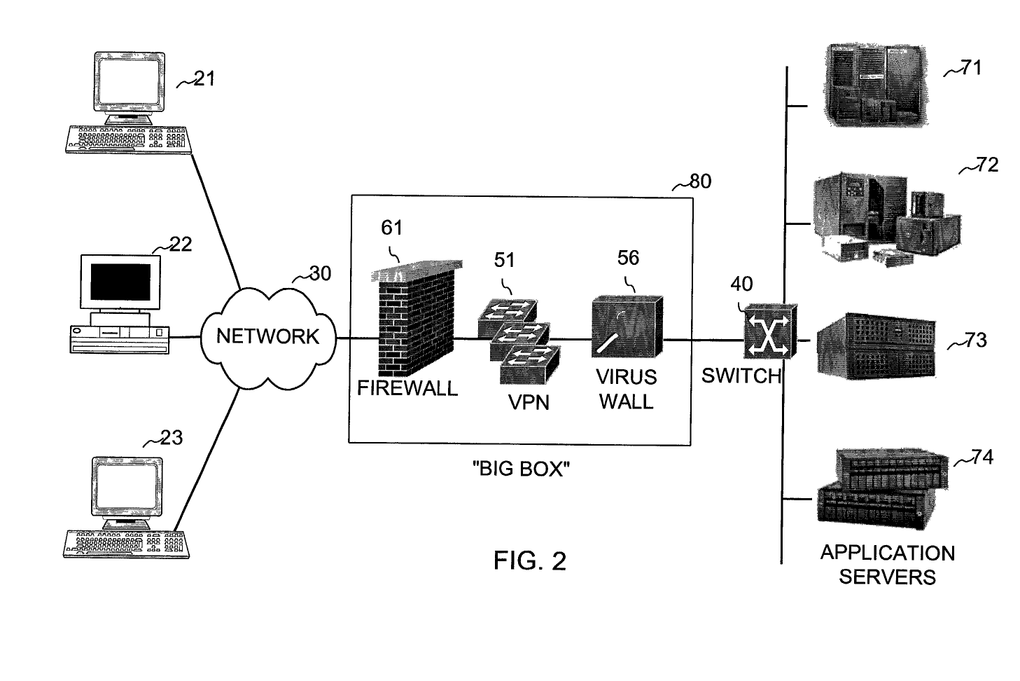

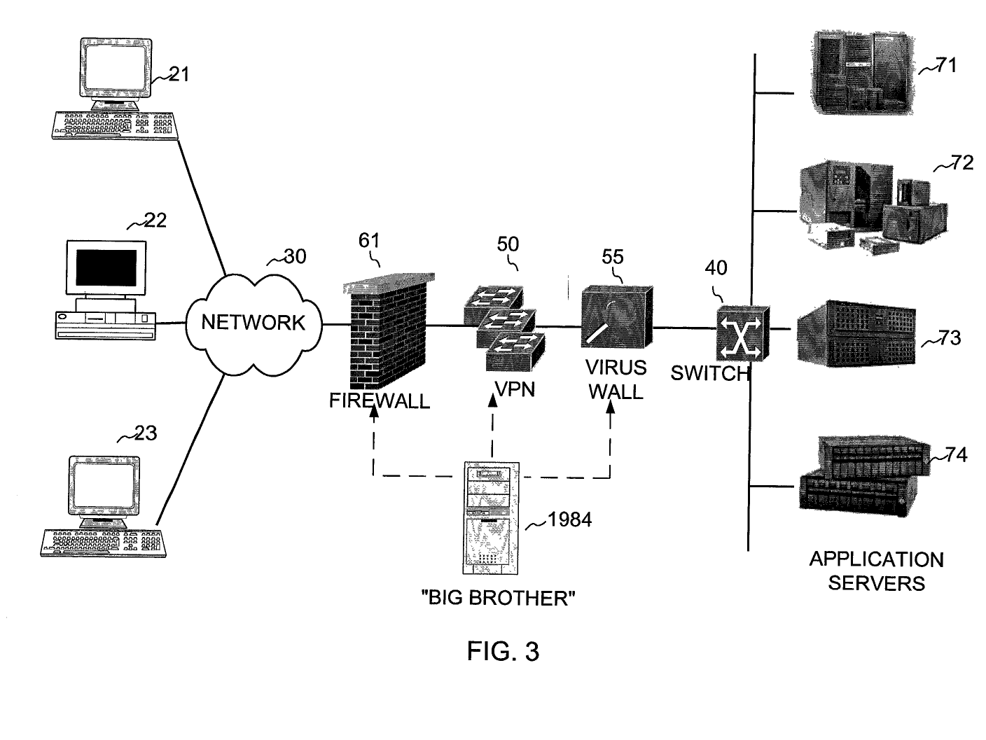

### DETAILED DESCRIPTION OF THE INVENTION

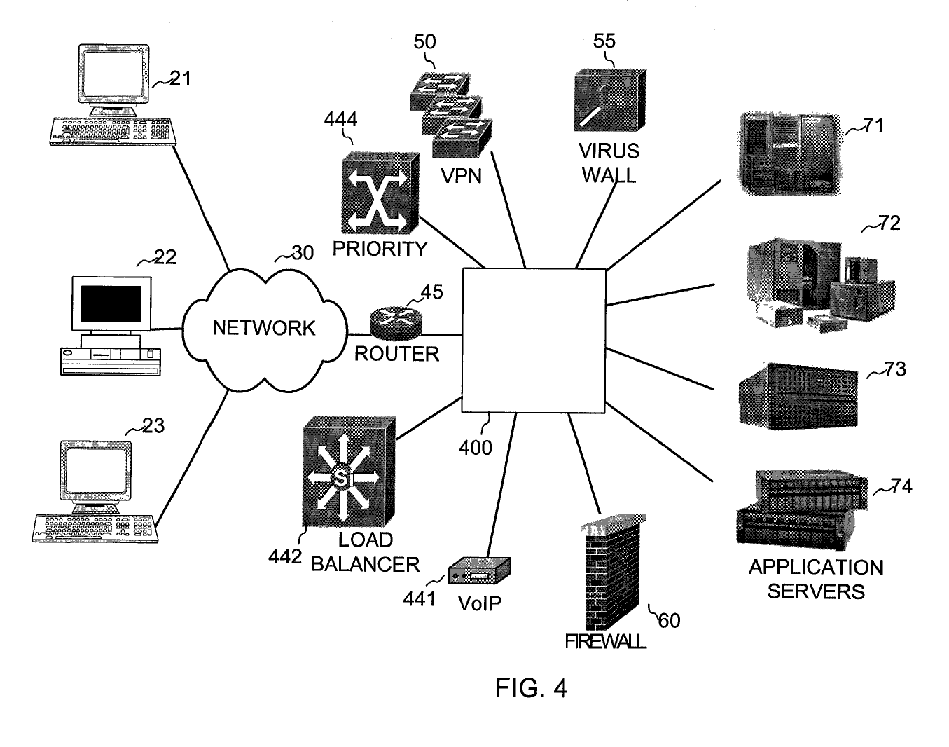

Embodiments of the present invention provide capabilities that are not and cannot be supported by the known art technologies. Those technologies rely upon network traffic passing through a rigid sequence of systems. Embodiments of the present invention eliminate that constraint. As shown in FIG. 4, disparate users 21-23 have access to numerous applications via network 30 and system 400. In addition to network applications such as firewall 60, VPN 50, and virus wall appliance 55, the clients can access application servers 71-74 and other applications such as voiceover-IP (VoIP) system 441 and load balancing server 442. Router 45 is a conventional IP router.

Embodiments of the present invention use packet direction, packet distribution, and an advanced packet sequencing feature to direct packets through a customized sequence of application systems that is defined, on demand, by the customer. Embodiments of the present invention can maintain each customized sequence as a series of MAC/IP addresses and communication interfaces. The customer can access the sequence via a service IP address and a subordinate service port. Embodiments of the present invention also remove access control responsibilities from the firewalls that they direct and enable dynamic access control management by the subscriber or end-user.

Embodiments of the present invention relate to an innovative technology for the delivery of advanced network applications. Although the present detailed description of the invention is provided in the context of networks based on the well-known Transmission Control Protocol/Internet Protocol (TCP/IP), it would be appreciated by those skilled in the art that embodiments of the present invention can be beneficially employed in other networks. For example, such a network can be a network where traffic is normally routed from system to system according to Layers 2 and 3 (data link and network layers) of the well-known 7-Layer OSI Reference Model and particular services are identified according to Layer 4 (transport layer) of that model. Such a network-is herein referred to as a “generic network.”

Embodiments of the present invention provide systems, methods, and architectures for managing network packets as distributive objects. An example of a network packet is a data packet, which typically includes a header and a payload. The header of a data packet can include address information, such as source address, destination address, service port, a combination thereof, and so on. In the context of a generic network service, these distributive objects are managed based upon a “pseudo network address” that resembles a conventional host address under the generic networking protocol. As used herein, the term “conventional host address” encompasses the network addressing scheme used to identify a specific host to which network packets are addressed. However, unlike a conventional host address, which identifies or corresponds to a single host on the generic network, a pseudo network address is associated with an entire set of network applications. Moreover, a subset or package of network applications can be identified according to an embodiment of the present invention by assigning a service identifier associated with the pseudo network address that corresponds to the subset or package of network applications. Further, the pseudo network address and service identifier can be associated with a specific sequence in which the network packets are presented to the set or subset of network applications.

In the context of a TCP/IP-based network, the distributive objects comprise a “service IP address” which corresponds not to a single host under conventional IP addressing, but to a set of hosts. In such a network, the service identifier comprises a a conventional TCP/UDP service port, which, when used in conjunction with the service IP address, corresponds not to a single application on a particular host, but to a package of TCP/IP applications provided on one or more hosts on the TCP/IP network. Accordingly, embodiments of the present invention allow more sophisticated packet processing than conventional TCP/IP packet processing without the need to fundamentally change the conventional network infrastructure. Moreover, embodiments of the present invention provide the ability to support the creation of a customized service infrastructure using conventional TCP/IP networking protocols, e.g., IP version 4 (IPv4) and/or IP version 6 (IPv6) protocols. While an embodiment of the present invention supports the use of TCP/IP, it may not track TCP state. The embodiment is, however, “service aware”, since it tracks the flow of TCP/IP packets through a sequence of application devices. Each packet proceeds through the application devices in the predefined order. The packet successfully passes an application device before it is directed to the next application device in the sequence.

Embodiments of the present invention enable an individual, a small or medium-sized business, or an enterprise to define its own virtual customized network (VCN) by selecting a set of appliances and applications, as well as the sequence in which those appliances and applications receive and process IP traffic. FIG. 4 shows many of the typical applications a customer may desire in its VCN. For example, the VCN may incorporate a full range of common transport protocols and may integrate numerous applications and features, such as e-mail, web access, domain name services (DNS), firewall 60, VPN 50, load-balancing system 442, intrusion detection, virus scanning 55, Internet access control, Quality of Service 444, multimedia streaming, VoIP 441, accounting, and other database and applications 7174.

As shown in FIG. 4, traffic coming from network 30 travels through router 45 and is controlled by system 400, which represents an embodiment of the present invention. Embodiments of the present invention relate to communications via one or more networks. A network can include communications links such as wired communication links (e.g., coaxial cables, copper wires, optical fibers, a combination thereof, and so on), wireless communication links (e.g., satellite communication links, terrestrial wireless communication links, satellite-to-terrestrial communication links, a combination thereof, and so on), or a combination thereof. A communications link can include one or more communications channels, where a communications channel carries communications. For example, a communications link can include multiplexed communications channels, such as time division multiplexing (“TDM”) channels, frequency division multiplexing (“FDM”) channels, code division multiplexing (“CDM”) channels, wave division multiplexing (“WDM”) channels, a combination thereof, and so on.

In an embodiment, communications are carried by a plurality of coupled networks. As used to describe embodiments of the present invention, the term “coupled” encompasses a direct connection, an indirect connection, or a combination thereof. Moreover, two devices that are coupled can engage in direct communications, in indirect communications, or a combination thereof.

Embodiments of the present invention comprise a packeting engine that performs the real-time network packeting used to implement each VCN by automatically directing the flow of IP traffic through a pre-determined sequence of appliances and applications according to a customer's requirements. There are several methods that the packeting engine can employ to track the sequence of packets associated with a given service IP address, such as the following:

First Method: Modify Layer2-Layer4 Headers. An embodiment of a packeting engine can modify one or more fields in the network packet such as, for example, the Type of Service (TOS) field or another IP header field to track a packet through a specific service IP address sequence. For example, just before a packet is sent out to an appliance or application over a particular interface, the packeting engine may modify the IP header field to identify the sequence step that directed the packet out the interface.

Second Method: Encapsulate Packet. Another embodiment of a packeting engine can encapsulate the original packet. The new header of the encapsulated packet includes sequence information that is used to track the packet through the service.

Third Method: Insert Header. An embodiment of a packeting engine can insert an additional header into the original packet. This approach is used in protocols such as MPLS. The new header includes sequence information that is used to track the packet through the service.

Fourth Method: Trace MAC Address. Another embodiment of a packeting engine can examine the source MAC address (“Media Access Controller” address, i.e., the hardware address of the network interface card) to determine where the packet is within a specific service IP address sequence.

Fifth Method: Track Service IP Address, Service Port and Interface. Instead of using Layer 2 through Layer 4 conventional routing, an embodiment of a packeting engine can route a packet based upon the packet's service IP address, the packet's service port, and the packeting engine interface on which the packet was received.

Embodiments of the present invention may also comprise a provisioning engine allowing an administrator to define the available appliances and applications, and allowing an individual, business, or enterprise to select, on demand, the appliances and applications to be integrated into its own VCN. The customer may also select the specific sequence through which packets will be presented to each application or appliance in the VCN. The provisioning engine then manages the provisioning of the customized applications over an existing IP network and provides a service IP address behind which sits the integrated environment for the customized service. The provisioning engine is preferably accessed via a simple web-style interface (HTML, XML, etc.) and can preferably be accessed across the network by both customer administrators and by a service provider's administrator.

The provisioning and packeting engines may be developed as software solutions or as embedded systems to meet low-end to high-end bandwidth networking requirements. When implemented as a software solution, a software application may preferably be run on conventional, off-the-shelf hardware, such as a Windows NT-based personal computer or a Unix-based server system. When implemented as an embedded system, an embodiment of the present invention is preferably configured as a special purpose system comprising a combination of hardware and software. The packeting engine is adapted to receive network packets addressed to a service address and to redirect or distribute the packets according to requirements of the associated VCN. While the provisioning and packeting engines create the flexibility to openly accommodate emerging applications and networking protocols, they are strictly designed to require little or no engineering, installation, or customization on either server or client systems.

In the sections below, numerous examples and exemplary embodiments of the present invention are described.

First Embodiment Of The Invention: A Single Application Accessible Via A Packeting Engine

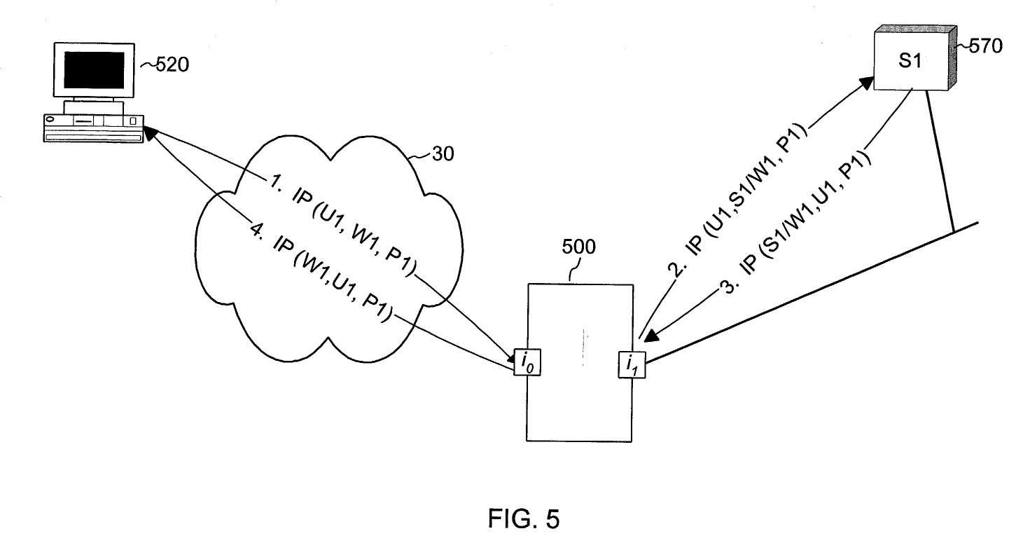

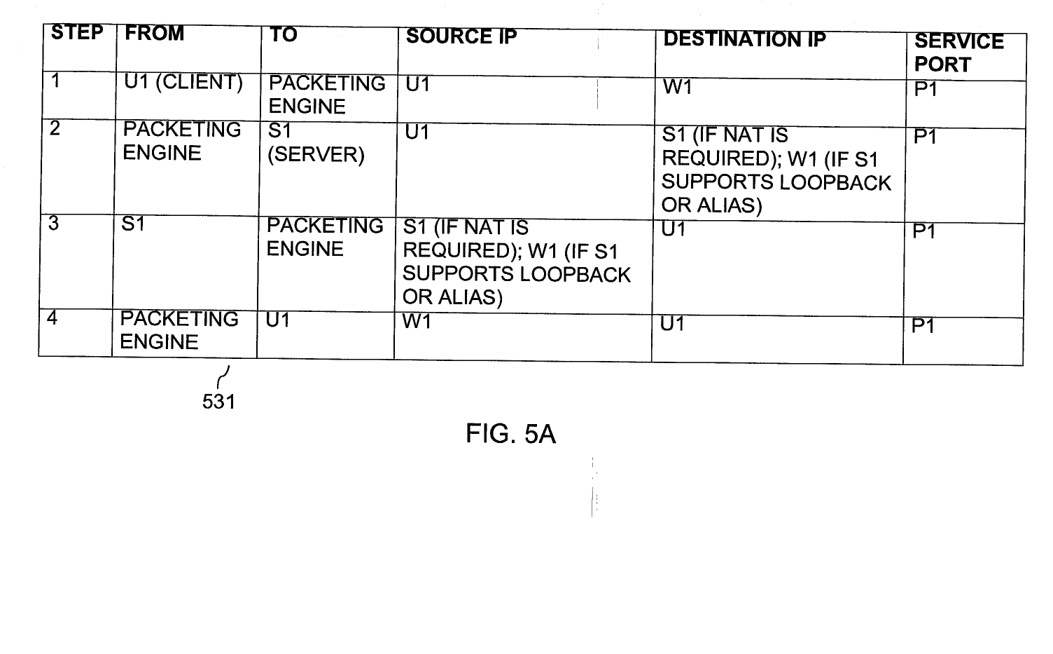

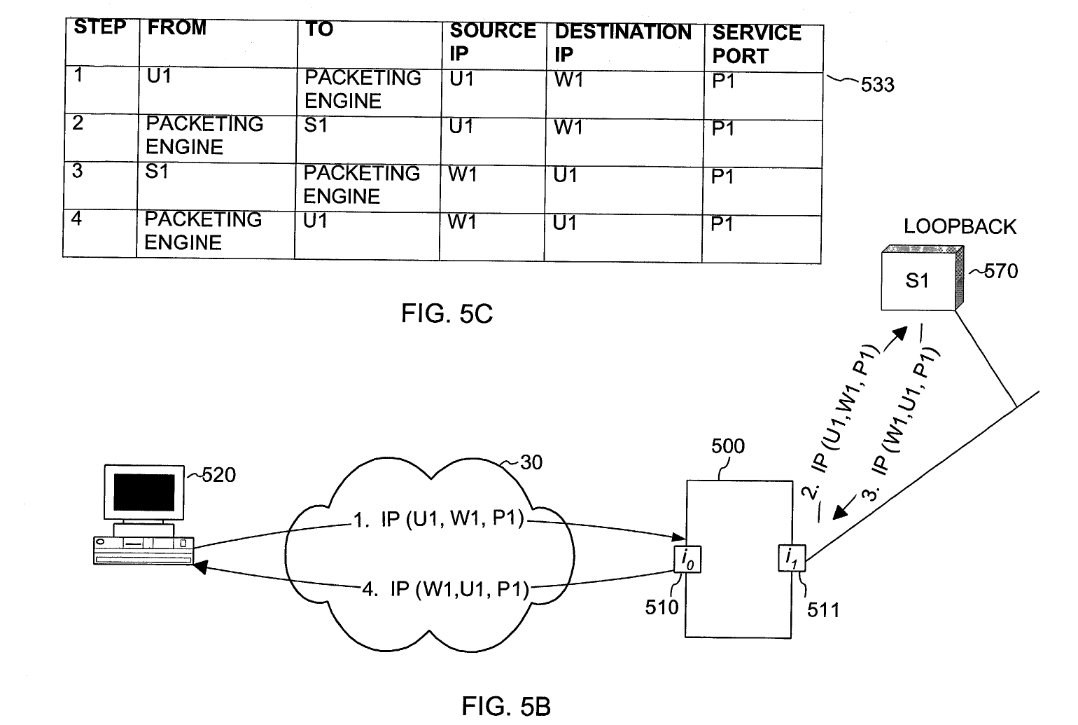

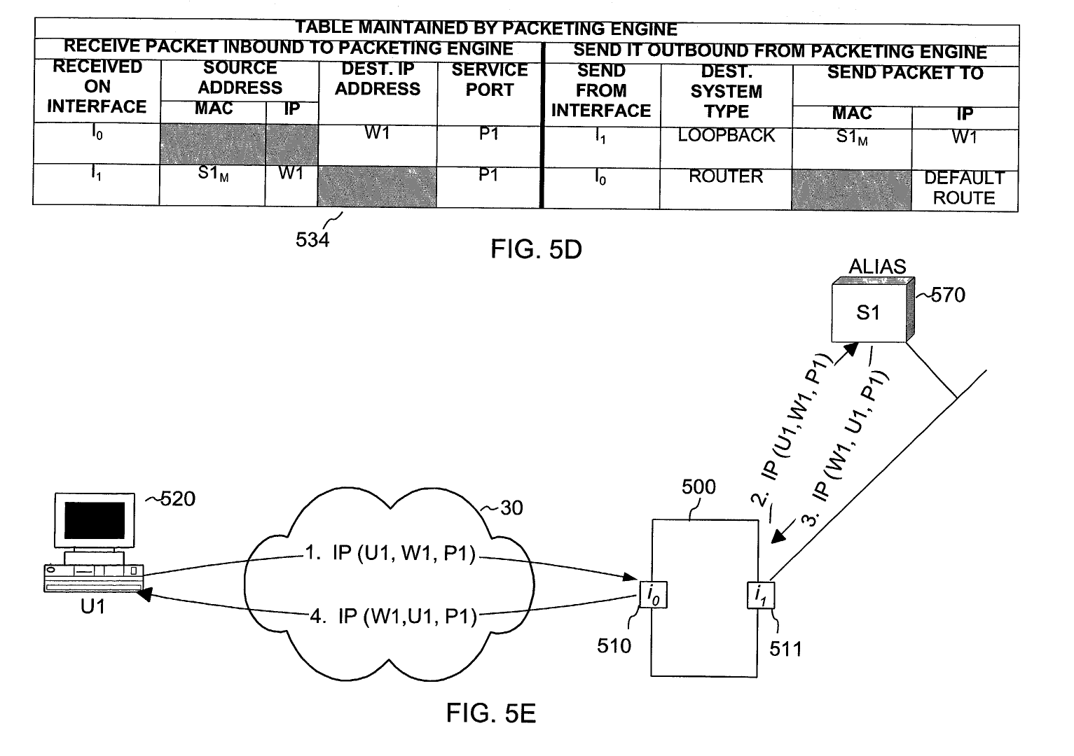

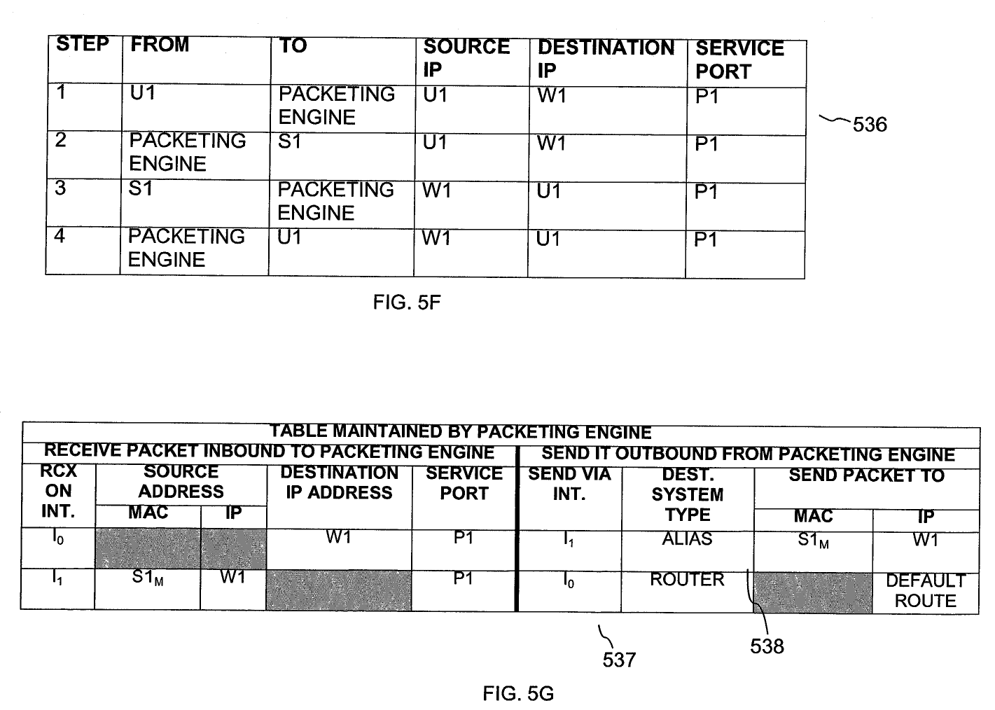

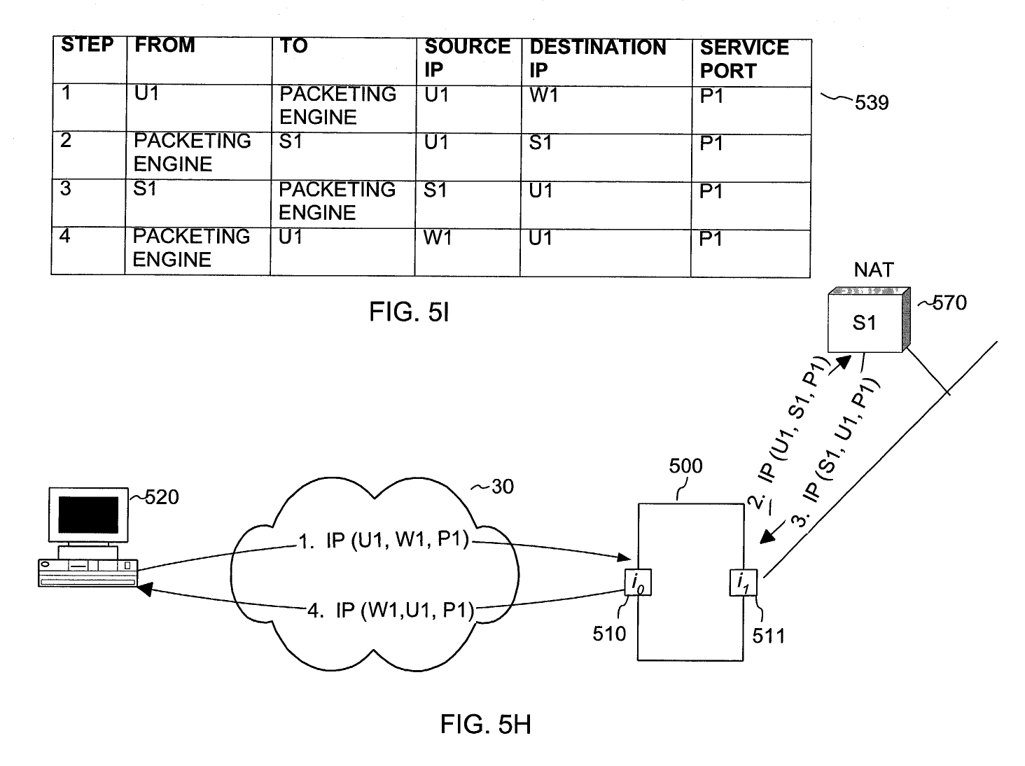

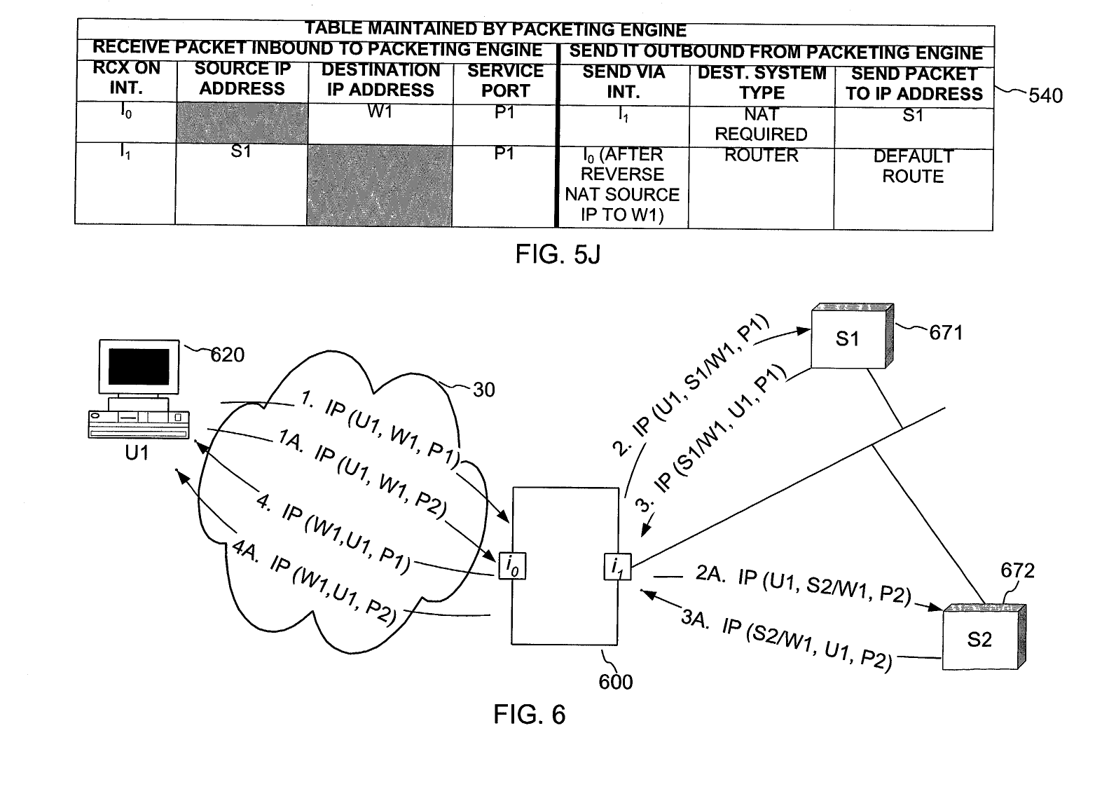

FIGS. 5-5J illustrate how IP traffic may be processed by an embodiment of the packeting engine. They also illustrate the packeting engine's packet director operations, which use a combination of IP routing and port-based routing. These figures show client system 520 in communication with server 570 via network 30 and packeting engine 500. In FIGS. 5, 5B, 5E and 5H, client 520 sends traffic addressed to a service IP name, which a domain name server (DNS) resolves to the service IP address W1. This service IP address is not the IP address of a physical system, rather it is a routable IP address assigned to a customized service. A router that is local to packeting engine 500 advertises that it is able to direct traffic from network 30 bound for service IP address W1. When it receives the traffic, it routes the traffic to packeting engine 500. Packeting engine 500 examines the packet, identifies the service IP address W1 and service port P1 that are being used (in an embodiment, it has no need to analyze or track the address U1 of the originating client 520), and then reviews the service definition that it received from the provisioning engine to determine where the traffic should be sent. In this example, the traffic will be directed to server 570. In these Figures, the packet routing is indicated in the form: IP(X,Y,Z), where X is the source IP address, Y is the destination IP address, and Z is the TCP port number. As described herein, in an embodiment, it is the combination of IP address and TCP service port that allows packeting engine 500 to determine the packet's complete service sequence.

Packeting engine 500 reviews server 570's service definition (previously received from the provisioning engine) to determine whether server 570 is operating in loopback mode (the destination IP address that was specified in the packet is automatically used as the source IP address for packets sent back), alias mode (the destination IP address matches an entry on a pre-defined list of IP addresses), or normal mode (the packeting engine 500 communicates with server 570 using network address translation, NAT). FIG. 5A shows table 531 generally illustrating how packets are addressed and transferred in the embodiment shown in FIG. 5. Similarly, FIGS. 5C, 5F and 5I show tables illustrating respectively how packets are addressed and transferred when server 570 is operating in loopback mode, in alias mode, or in normal mode, respectively. Tables 531, 533, 536 and 539 show packet transfer steps between client 520 and server 570.

Table 533 in FIG. 5C and table 536 in FIG. 5F are identical because the destination IP address need not be modified when a server such as server 570 operates in loopback or alias mode. Table 539 in FIG. 5I differs in that the destination IP address of step 2 and the source IP address of step 3, due to the use of NAT, reflect the server 570's actual IP address. FIGS. 5D, 5G, and 5J show sequence tables that can be maintained by packeting engine 500 for supporting loopback, alias, and NAT scenarios, respectively. Each of these scenarios is described in more detail below.

Loopback mode operations are illustrated in FIGS. 5B-5D. Table 534, in FIG. 5D, shows the type of information that can be maintained by packeting engine 500 to carry out an embodiment of the present invention when the destination server operates in loopback mode. In an embodiment, packeting engine packet processing information (e.g., packet distribution information, packet sequencing distribution information, a combination thereof, and so on) can be stored in a data record, a data table, a database, a combination thereof, and so on. For example, the packet processing information can include packet processing entries, where a packet processing entry includes one or more fields to store values (e.g., identifiers, addresses, and so on). As shown in table 534, packeting engine 500 need not maintain information related to the client 520. When a packet is received from network 30 (i.e., via interface 510) packeting engine 500 looks up the inbound interface, destination address, and service port in table 534 to determine the proper handling for the packet, including the outbound interface, and the correct packet addressing depending on the system type. When packeting engine 500 receives packets on interface i₀ 510 with a destination IP address of service IP address W1 and service port of P1, it directs those packets, unmodified, out interface i₁ 511 to server 570, using server 570's MAC address. Interfaces 510-511 are examples of network interfaces. Since server 570 supports loopback, and server 570 is on the same local network segment as packeting engine 500, the packeting engine 500 uses S1_{M}, server 570's MAC address, to send it traffic. When packets are received on packeting engine 500's interface i₁ 511 (e.g., in response to the traffic previously sent to server 570 via interface i₁ 511) with source IP address of service IP address W1 and service port of P1, it directs the traffic back out interface i₀ 510, using its default route to a router (not shown in FIG. 5B) that can forward traffic towards client 520. Note that although table 534 includes the source MAC address S1_{M} for traffic received via interface i₁ 511, this information is not needed to determine the proper routing in the present example, however, it is used to confirm the source of the traffic, to ensure that the traffic is valid for the service.

Alias mode operations are illustrated in FIGS. 5E-5G. As shown in table 537, when packeting engine 500 receives packets on interface I₀ 510 with a destination IP address of service IP address W1 and service port of PI, it directs those packets, unmodified, out interface i₁ 511 to server 570, using S1_{M}, the MAC address of server 570. Since server 570 is operating in alias mode, the service IP address of W1 has been defined as one of server 570's IP addresses, so server 570 will accept those packets. When packets are received on interface i₁ 511 with source IP address of service IP address W1 and service port of P1, the packeting engine 500 directs the traffic back out interface I₀ 510, using its default route to a router (not shown in FIG. 5E) that can forward traffic towards client 520. FIG. 5E and associated tables 536 and 537 are similar or identical to FIG. 5B and associated tables 533 and 534 because packeting engine 500 uses the same type of information for determining packet handling whether server 570 is operating in loopback or alias mode. Accordingly, box 538 in table 537 could read “loopback or alias” and the result would be the same.

NAT mode operations are shown in FIGS. 5H-5J. As shown in table 540, when packeting engine 500 receives packets on interface I₀ 510 with a destination IP address of service IP address W1 and service port of P1, it performs NAT on the destination IP address to change it to S1, server 570's actual IP address, and then directs the packets to server 570's IP address. Server 570 sends packets back to the packeting engine 500 by using its default route, which, in an embodiment, should be defined as packeting engine 500. When packets are received on interface i₁ 511 with source IP address of S1 and service port of P1, packeting engine 500 performs reverse NAT to change the source IP address back to the service IP address W1 and then directs the traffic back out interface i₀ 510, using its default route to a router that can forward traffic towards client 520. As shown in table 540, if the packeting engine 500 uses NAT to communicate with server 570, packeting engine 500 performs reverse NAT before sending a packet from server 570 to client 520.

Second Embodiment Of The Invention: Two Servers and Two Applications Accessible Via A Single Service IP Address

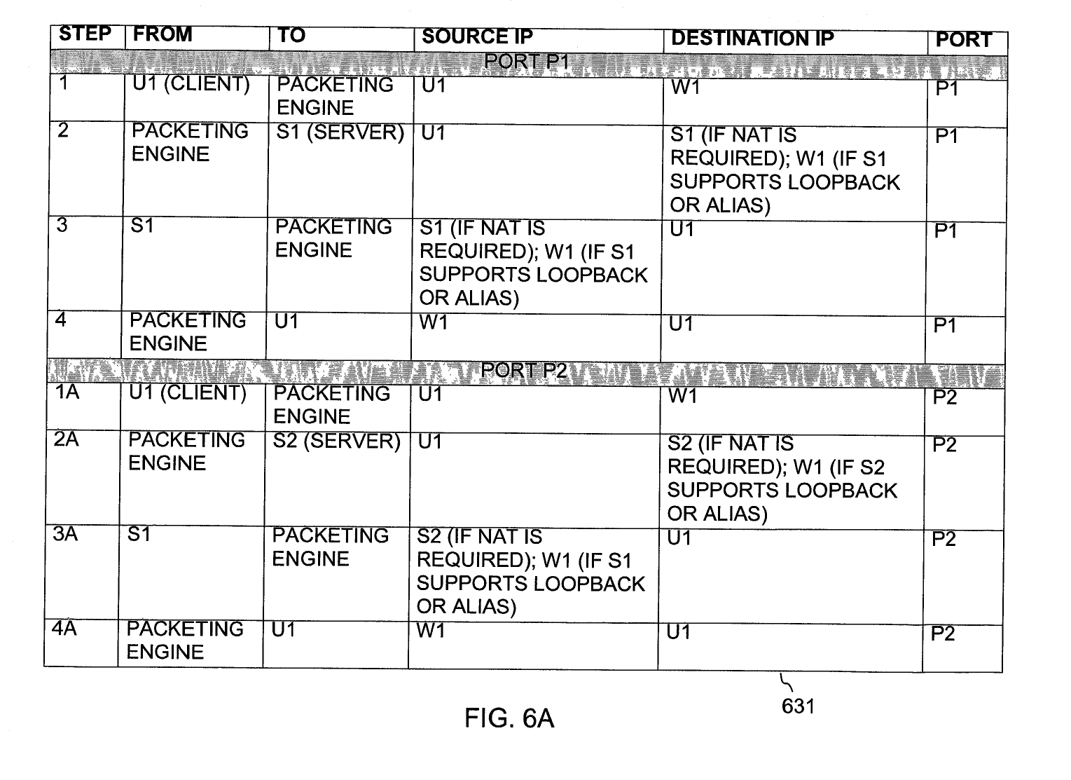

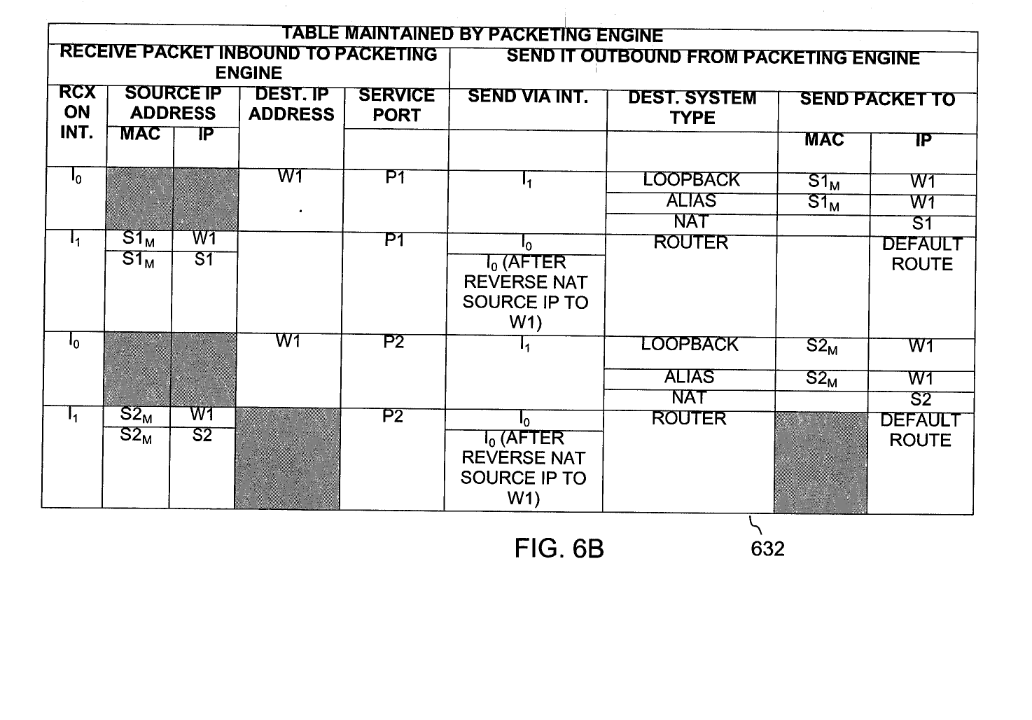

FIGS. 6-6B illustrate the use of port-based routing and depict the flow of network traffic when the client 620 accesses two different applications on two different servers, server 671 and server 672, both through the same service IP address W1. Client 620 uses network 30 to communicate with the servers. Network 30 can be the well-known Internet or can be another network for communicating within and/or between diverse systems of computers. In this example, when packeting engine 600 receives a packet, it examines the packet, identifies the service IP address and service port that are being used, and then reviews the service definition that it received from the provisioning engine (not shown in FIG. 6) to determine where the traffic should be sent.

The combination of the service IP address and the service port determines the set and sequence of appliances and applications through which the packets will be directed. In this embodiment, the service IP address can be associated with a pool of available appliances and applications (e.g., in FIG. 6, the pool associated with service IP address W1 includes servers 671 and 672). The service port defines the appliances and applications to be used from that pool. The provisioning engine then determines the optimal sequence for packet direction, based upon the set of appliances and applications to be used.

In this example, as shown in table 631, traffic is directed to server 671 when service port P1 is used, and traffic is directed to server 672 when service port P2 is used. Packeting engine 600 reviews server 671's server definition that it received from the provisioning engine to determine whether server 671 is operating in loopback, alias mode, or normal mode. As described earlier, packeting engine 600 directs the traffic to server 671 without modification if server 671 is operating in either loopback or alias mode, since those modes enable the server to accept traffic bound for service IP address W1. If server 671 does not use loopback or alias mode, then packeting engine 600 performs NAT on the packet to change the destination IP address to SI, server 671's actual IP address, before it sends the packet out towards server 671.

If packeting engine 600 performed NAT before sending the packet to server 671, then packeting engine 600 performs reverse NAT on packets received back from server 671 to change the source IP address from S1 back to the original service IP address W1. Packeting engine 600 then directs the packet back out its default route to a router (not shown in FIG. 6) that can forward traffic towards client 620. The packet arrives at client 620 with a source IP address of service IP address W1 and a service port of P1.

If client 620 sends a packet addressed to W1 with a service port of P2, packeting engine 600 examines the packet, identifies the service IP address and service port that are being used, and then reviews the service definition that it received from the provisioning engine to determine where the traffic should be sent. In this example, service port P2 is used, so traffic will be sent to server 672. The packeting engine reviews server 672's server definition that it also received from the provisioning engine to determine whether server 672 is operating in loopback, alias, or normal mode. Packeting engine 600 passes the traffic to server 672 without modification if server 672 is operating in either loopback or alias mode, since those modes enable it to accept traffic bound for service IP address W1. As can be appreciated by one skilled in the art, in this example servers 671 and 672 run in non-ARP (address resolution protocol) mode for alias addresses when both use an alias of the W1 service IP address while they are on the same network segment. If both run in ARP mode for the same alias address(es), they would issue conflicting advertisements that claim the W1 service IP address, and the other network systems would not be able to resolve the proper destination for the W1 service IP address. If server 672 does not use loopback or alias mode, the packeting engine 600 performs NAT on the packet to change the destination IP address to server 672's actual IP address before it directs the packet out towards server 672.

If packeting engine 600 performed NAT before directing the packet to server 672, then it performs reverse NAT on any packets received from server 672 to change the source IP address from S2 back to the original service IP address W1. Packeting engine 600 then directs the packet back out its default route to a router (not shown in FIG. 6) that can forward traffic towards client 620. The packet arrives at client 620 with a source IP address of service IP address W1 and a service port of P2.

FIG. 6B shows table 632 that can be maintained by packeting engine 600 for communicating with servers 671 or 672. When packeting engine 600 receives packets on interface io with a destination IP address of service IP address W1 and service port of P1, it directs the packet out interface i₁ to server 671. If server 671 is operating in loopback or alias mode, S1_{M} server 671's MAC address together with destination IP address of W1 is used to direct the packet to server 671. If server 671 runs in normal mode, server 671'S own IP address S1 is used as the destination IP address and there is no need for packeting engine to track server 671 's MAC address apart from normal ARP tables.

In an embodiment of the present invention, server 671 will be operating in one of the three modes—loopback, alias, or normal. Only one of the destination system type and destination address pairs need be in table 632. For example, table 632 can typically contain: (1) loopback, S1_{M}, server 671's MAC address, and the service IP address W1; (2) alias, S1_{M}, and W1; or (3) NAT and S1, server 671's IP address. When packeting engine 600 receives packets on interface i₁ for service port P1, it examines the source IP address. If the source IP address is service IP address W1, it simply directs the traffic out interface io, using its default route to a router (not shown in FIG. 6) that can forward traffic towards the client. If the source IP address is not the same as the service IP address, it performs reverse NAT to translate the source IP address back to the service IP address. Packeting engine 600 then directs the packet out interface io using its default route to a router (not shown in FIG. 6) that can forward traffic towards the client.

Similarly, when packeting engine 600 receives packets on interface i₀ with a destination IP address of service IP address W1 and service port of P2, it directs the packet out interface i₁ to server 672. If server 672 is operating in loopback or alias mode, S2_{M}, server 672's MAC address and service IP address W1 are used to direct packets on to server 672. If communication with server 672 requires NAT, then S2, server 672's IP address, is used to direct the packets. When packeting engine 600 receives packets on interface i₁ for service port P2, it examines the source IP address. As described earlier, if the source IP address is service IP address W1, packeting engine 600 directs the traffic out interface io using a default route to a router (not shown in FIG. 6) that can forward traffic towards the client 620. If the source IP address is not service IP address W1, packeting engine 600 performs reverse NAT to translate the source IP address from S2 back to service IP address W1. Packeting engine 600 then directs the packet out interface io using a default route to a router (not shown in FIG. 6) that can forward traffic towards the client 620.

Again, as described earlier, table 632 includes the MAC addresses of servers 671 and 672 in connection with packets received on interface i₁, so that the source of the packets can be verified.

Third Embodiment of the Invention: Multiple Applications and Packet Sequencing Provided Using A Single Service IP Address

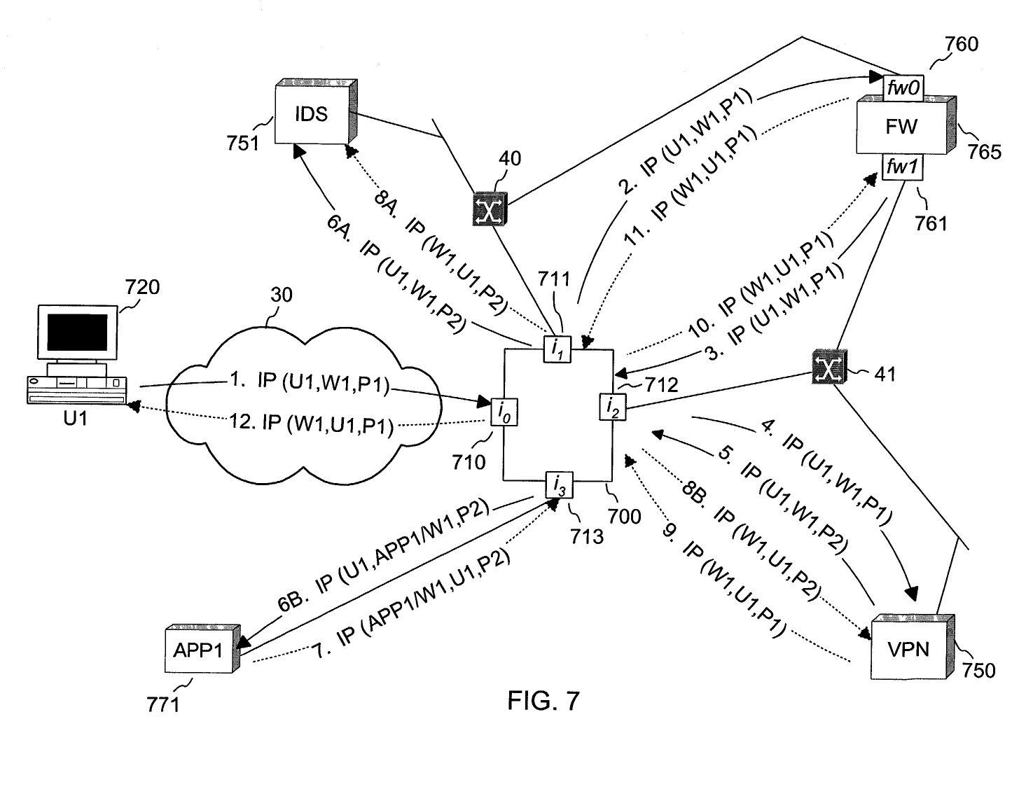

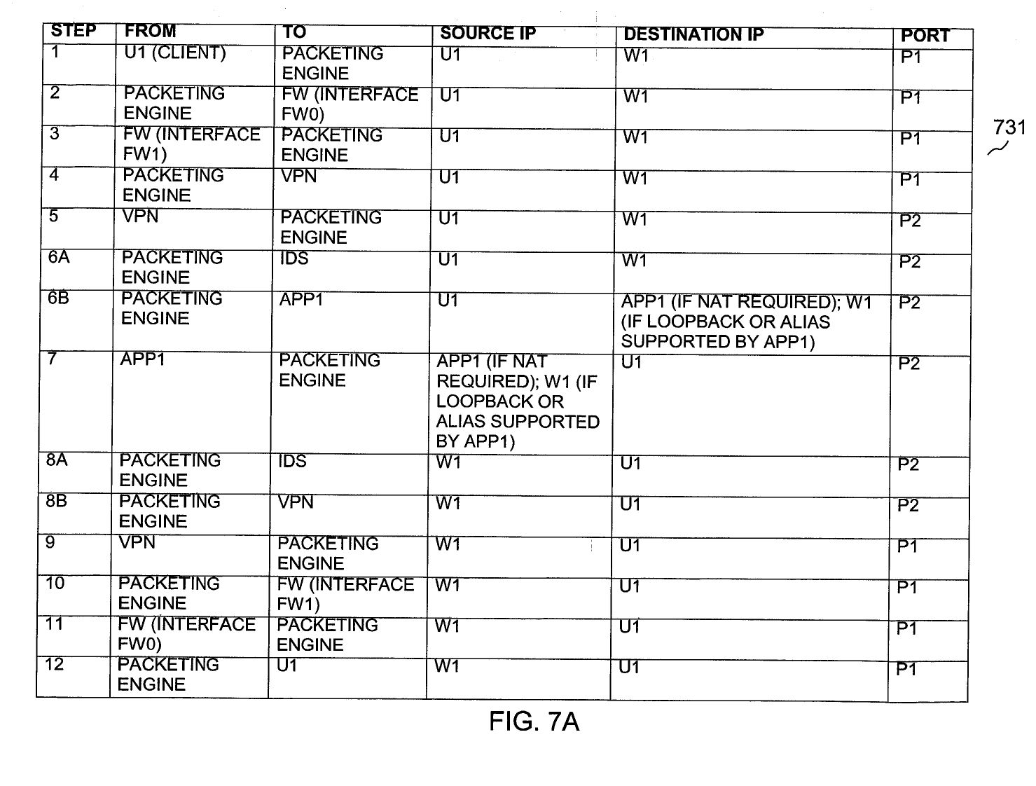

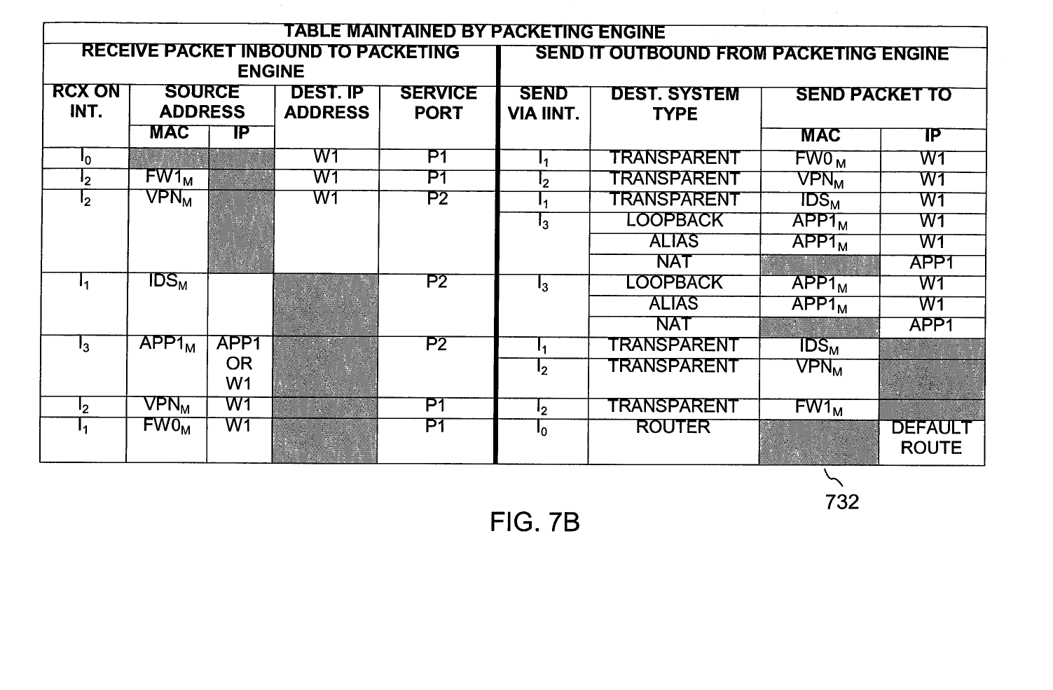

FIG. 7 shows another embodiment of the present invention directing a service that incorporates multiple appliances and application servers, and table 731 in FIG. 7A provides more details regarding the steps shown in FIG. 7. These Figures illustrate the operation of the packeting engine's packet distributor and packet sequencer features. The available interfaces i₀ 710, i₁ 711, i₂ 712, and i₃ 713 shown on packeting engine 700 are illustrated for the purpose of presenting this example. Packeting engine 700 directs a service that includes intrusion detection system 751, firewall 765, VPN appliance 750, as well as an application server 771. Packeting engine 700's packet sequencer feature allows the packeting engine 700 to control the sequence and flow of the packets through those different appliances and application servers, while the packeting engine 700's packet distributor allows it to resend a packet to as many systems as required to support the service.

With reference to tables 731 and 732 in FIGS. 7A and 7B, respectively, client 720 initiates the service by sending packets directed to service IP address W1 and service port P1. In this example, the service port for the actual end application (i.e., an application on server 771) is hidden by VPN software. Accordingly, client 720 runs VPN client software to encapsulate its packets before they are transmitted through network 30 towards packeting engine 700. Packeting engine 700 directs the packet out interface i₁ 711 to interface fw0 760 on firewall 765 (via switch 40). Intrusion detection system 751 and firewall 765 are physically isolated (i.e., not visible to each other) by switch 40 that connects the two devices. However, the switch allows packeting engine 700 to direct traffic to those devices by using their MAC addresses (IDSM and FWOM, respectively).

Firewall 765 reviews the packets that it receives on interface fw0 760 and allows them to pass out interface fw1 761 before the packets may be directed to another appliance or application server. If the traffic successfully meets firewall 765's criteria, it passes the traffic out interface fw1 761 (via switch 41) to interface i₂ 712 on packeting engine 700. Packeting engine 700 then directs the traffic back out interface i₂ 712 to VPN appliance 750 (again via switch 41). VPN appliance 750 de-encapsulates the packet that was originally encapsulated by VPN client software on client 720. When the de-encapsulation occurs, the original (pre-encapsulation) packet, which uses service port P2, is revealed. VPN appliance 750 then sends the de-encapsulated packet to interface i₂ 712 on packeting engine 700.

Packeting engine 700, using its packet distributor feature, sends the de-encapsulated packet to intrusion detection system 751 and also sends the packet to application server 771. The packet sent to intrusion detection system 751 has a destination IP address of W1, while the destination IP address used in the packet sent to server 771 depends on whether or not communications with server 771 are performed using NAT, as described above. The service port used for packets in either case is service port P2 as provided by VPN appliance 750.

Intrusion detection system 751 sends packets back to packeting engine 700 when it senses that an unauthorized attempt is being made to access the application.

In this case, packeting engine 700 sends such packets received from intrusion detection system 751 to application server 771. Application server 771 then handles the intrusion alert in accordance with the directive from the intrusion detection system.

Once application server 771 has processed the client's request, it sends back its response to packeting engine 700. As shown in table 732, packeting engine 700 uses its packet distributor feature again to send the packet to both intrusion detection system 751 and to VPN appliance 750. (Again, intrusion detection system 751 sends back packets when it senses an intrusion attempt.) VPN appliance 750 encapsulates the packet for transmission back to client 720. VPN appliance 750 sends the encapsulated packet to packeting engine 700 using a destination IP address of W1 and a service port of P1. Packeting engine 700 then directs the packet out interface i₂ 712 to firewall 765. Firewall 765 receives the packet on interface fw1 761 and examines it as described above. If firewall 765 approves of the traffic, it sends the packet back through interface fw0 760 (and switch 40) to interface i₁ 711 on packeting engine 700. Packeting engine 700 directs the packet back to client 720.

Fourth Embodiment of the Invention: Support For Port Translation

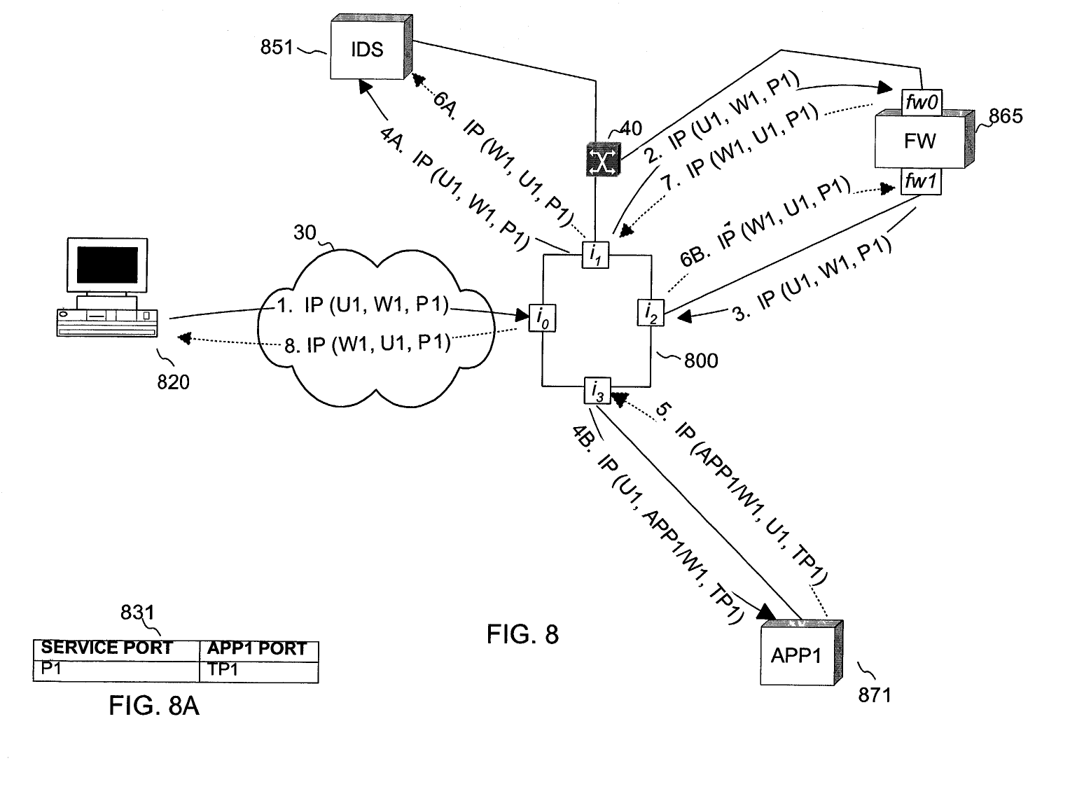

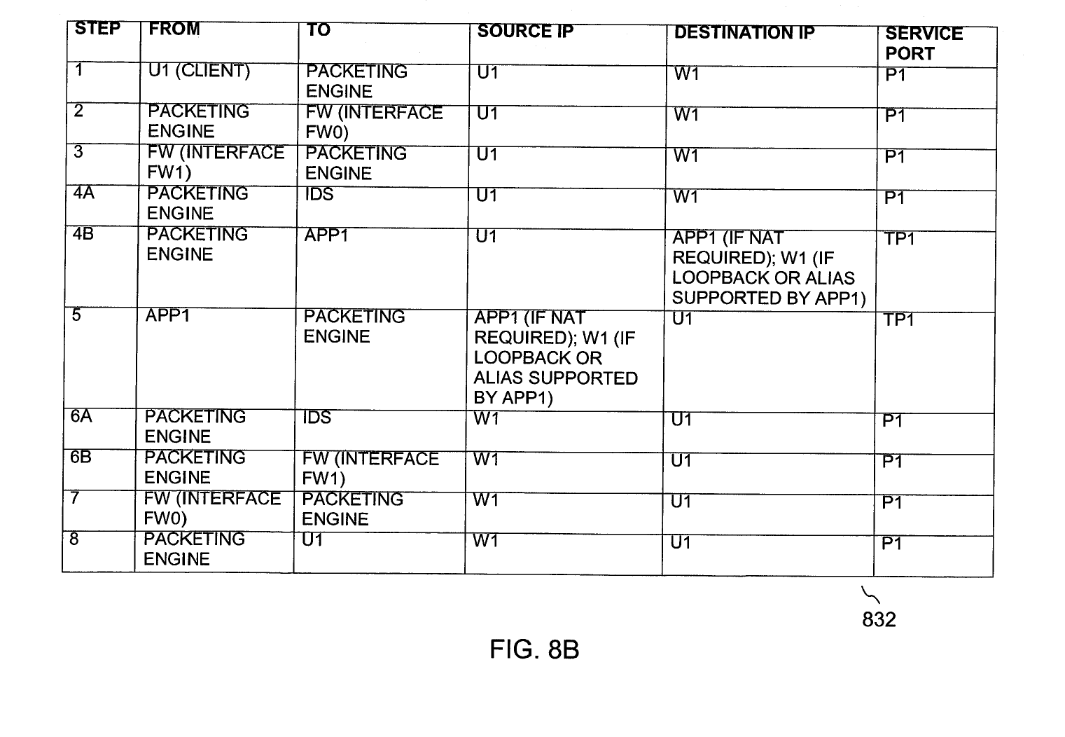

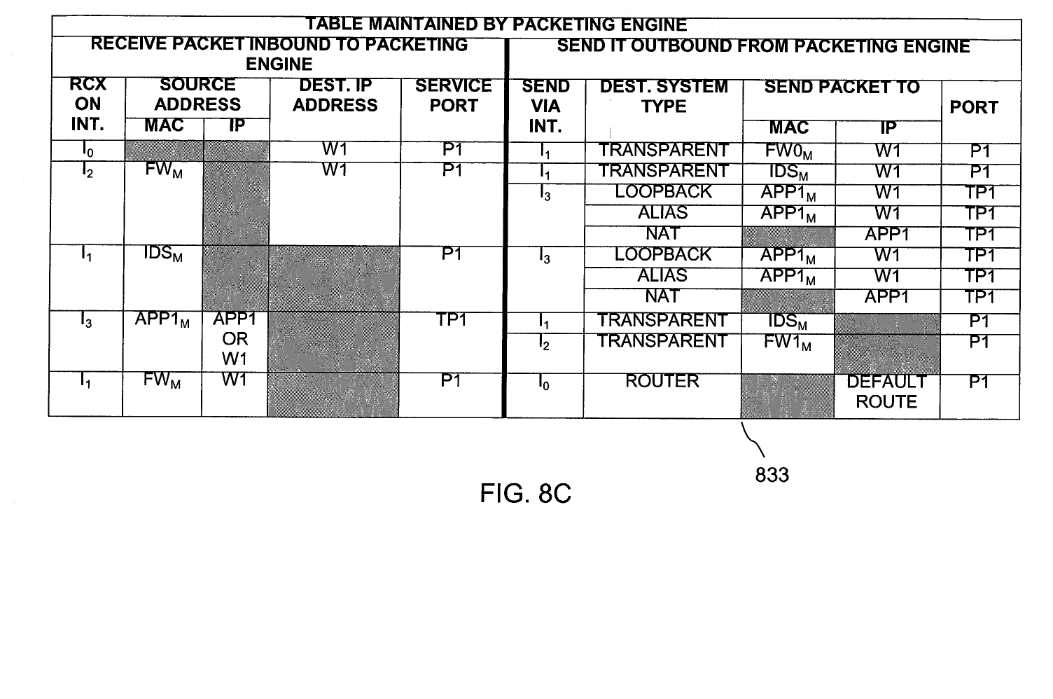

Embodiments of the invention can modify (e.g., translate) the service port before directing a packet to a device. FIGS. 8 through 8C depict such a system, where end application server 871 accepts requests on a different port than is typical for a specific function. For example, due to a limitation on the server itself, the server might accept FTP requests via a TCP port of 2020 instead of well-known TCP port of 20 normally used for such services. Packeting engine 800 is capable of translating a standard FTP request, i.e., one where the port equals 20, from client 820 such that the request presented to server 871 has a port equal to 2020.

More generically, when client 820 uses a service IP address WI with a service port P1 (step 1 in table 832 of FIG. 8B, also shown graphically in FIG. 8), packeting engine 800 directs the packet through the sequence for service W1 and service port P1, however, it changes the service port to TP1 before it directs the packet to server 871. When server 871 responds back, it sends packets directed to the service IP address W1 and service port of TP1. Packeting engine 800 then translates the service port from TP1 to P1 before it directs the packet back through the remainder of the sequence including IDS 851 and firewall 865 towards the client 820. In summary, the packeting engine 800 uses the port of TP1 when it communicates with the application server 871. Tables 831 and 833 in FIGS. 8A and 8C show the type of information that may be maintained by packeting engine 800 according to this embodiment of the present invention.

Fifth Embodiment of the Invention: Support for Dynamic Port and/or IP Address Negotiation Between Clients and Servers

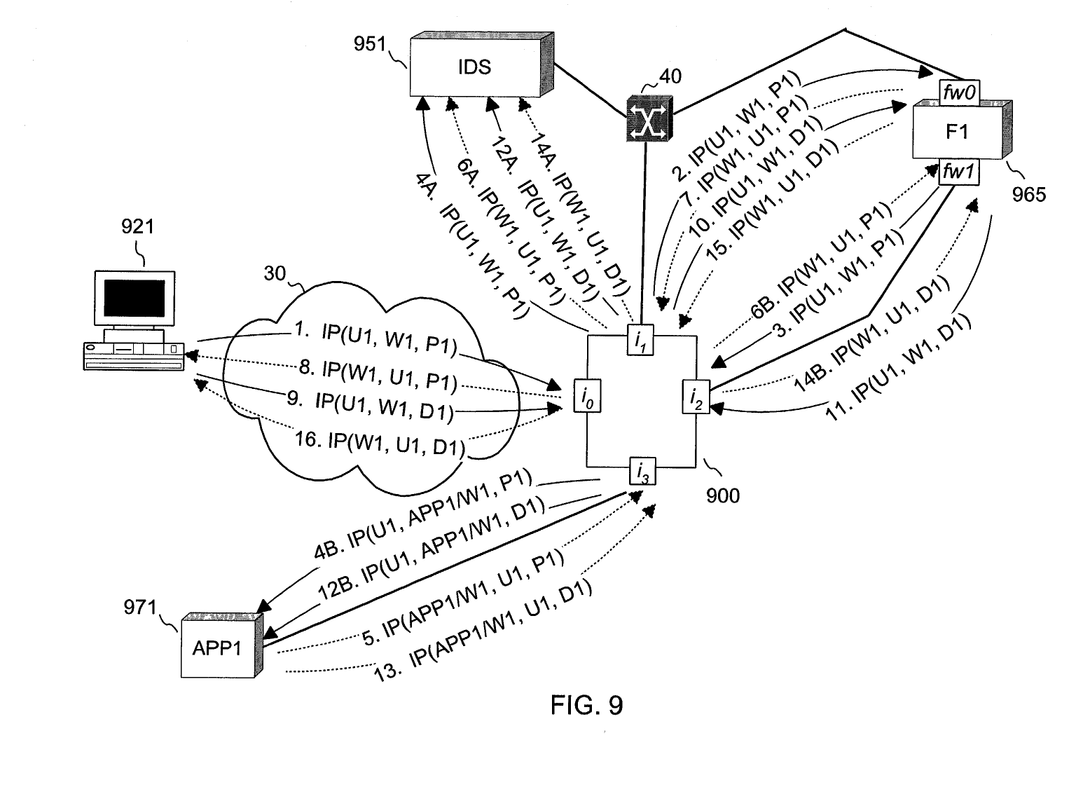

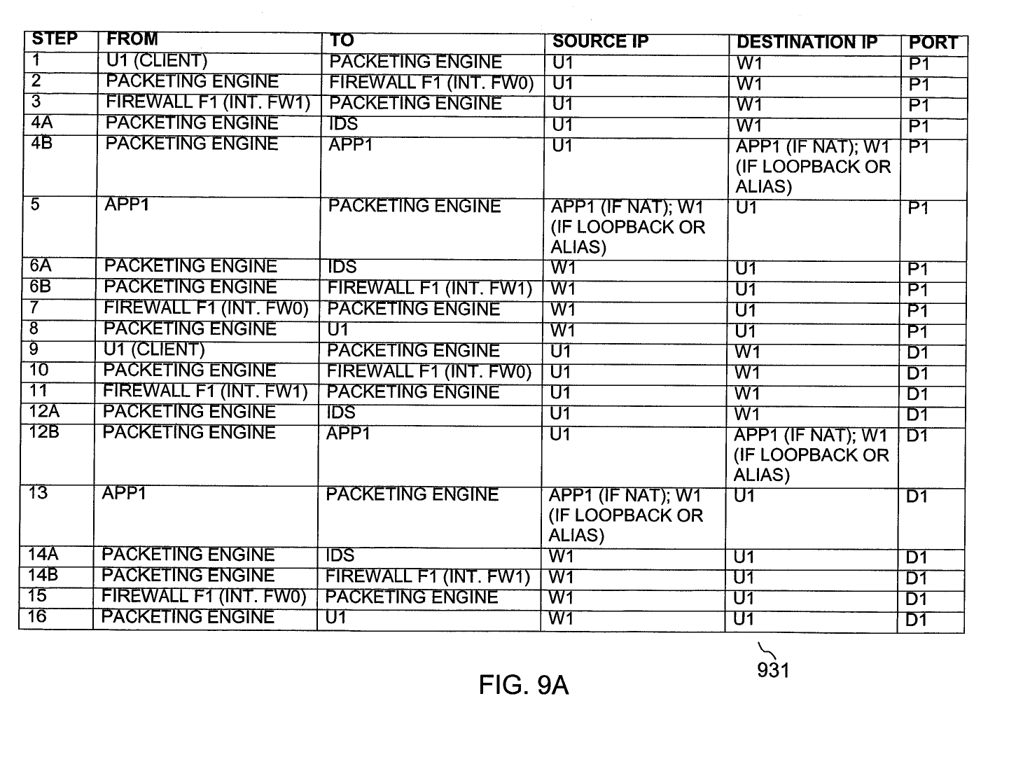

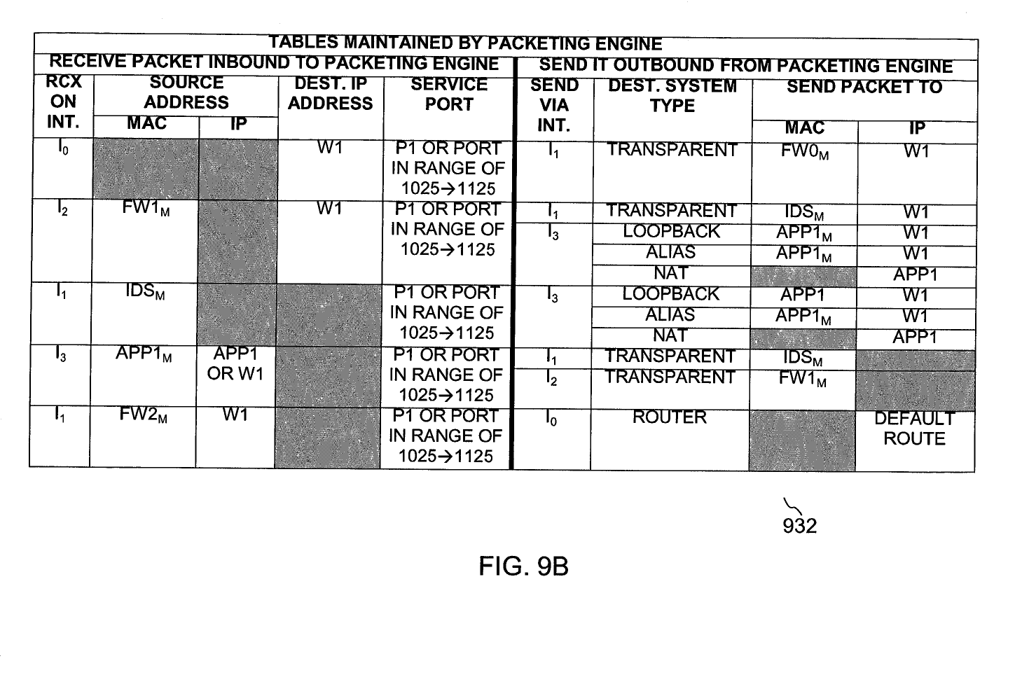

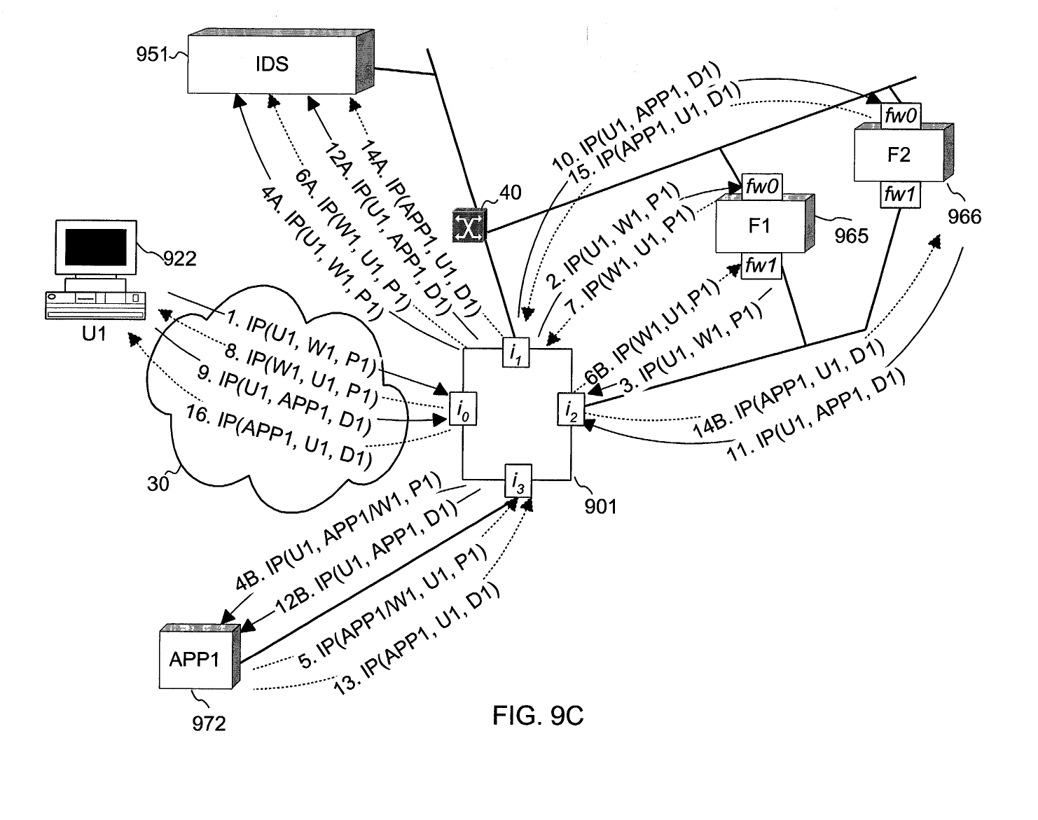

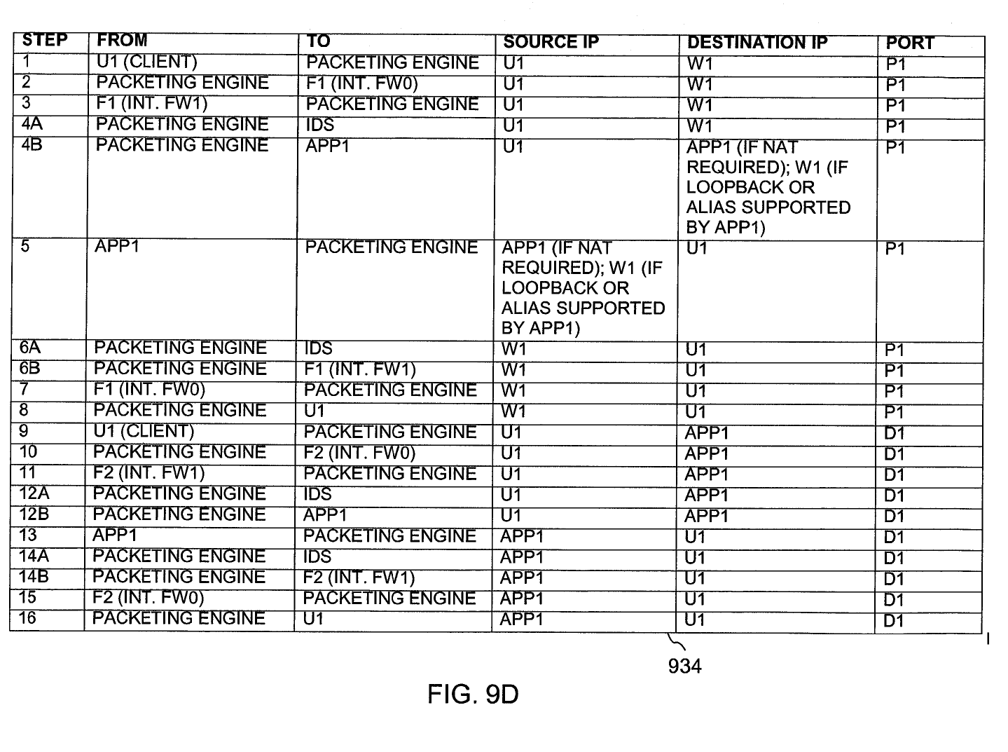

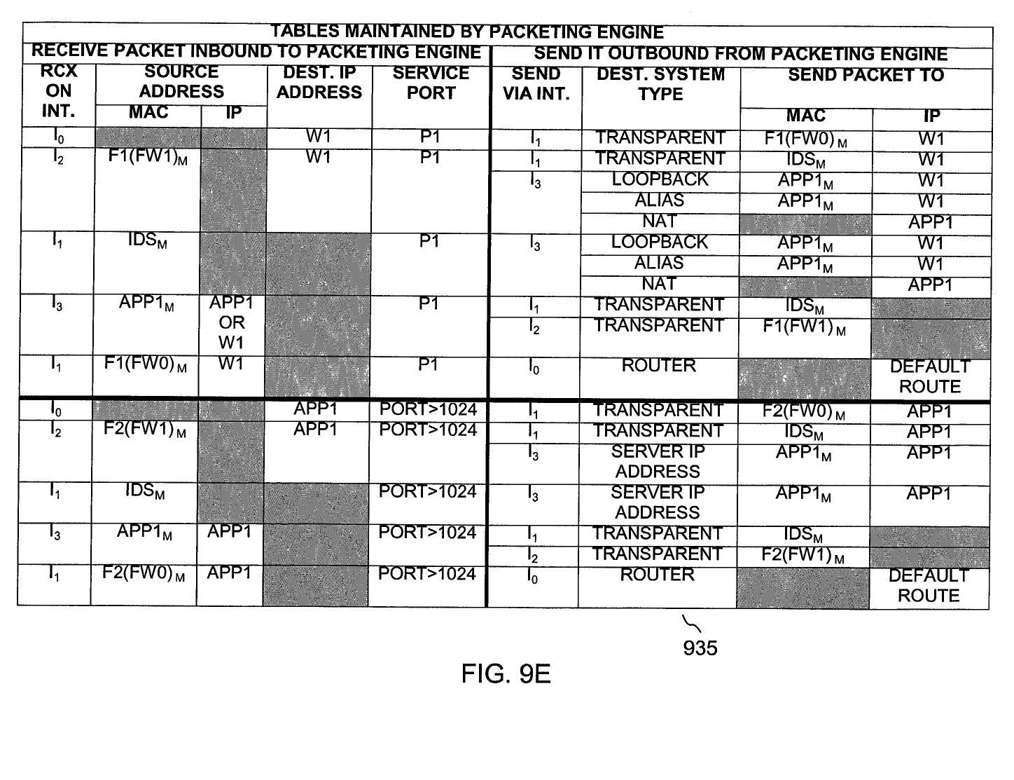

Embodiments of the present invention also support the use of application servers that dynamically negotiate the service port and, if required, the service IP address as well. Generally, an application running on a server will not change the service port, however, a small percentage of applications might. Moreover, in addition to changing the service port, some applications may also change the service IP address. To accommodate such applications, embodiments of the present invention can provide dynamic negotiation of a service port within a service IP address, as shown in FIGS. 9 through 9E.

In FIG. 9, application server 971 is an example of a server that dynamically negotiates a service port for use with service W1. Table 931 in FIG. 9A shows the steps for packet transfers depicted in FIG. 9. Each numbered step in table 931 corresponds to a numbered leg of message flow in FIG. 9. In this example, communications between client 921 and the application server 971 is initially performed with both systems using service IP address W1 and service port P1 (steps 1-8). Moreover, as shown in table 931, packeting engine 900, IDS 951, and firewall 965 use service IP address W1 and service port P1, during those steps.

However, during these initial communications the application server 971 negotiates use of a new service port with the client 921. Thereafter, client 921 communicates with the application server 971 (steps 9 through 16) using service IP address WI with service port D1, which was dynamically negotiated. Table 932 in FIG. 9B is a sequence table that may be maintained on packeting engine 900 allowing the application server 971 to use not only the original service port P1, but also any service port D1 dynamically negotiated between the server and clients, within the range 1025 to 1125. As known in the art, dynamically assigned service ports are usually assigned port numbers greater than 1024. Embodiments of the present invention allow the use of a dynamically assigned service port.

In an embodiment, each service port (for a given service IP address) that supports port negotiation is assigned a unique dynamic port range. In the present example, as shown in FIG. 9B, the initial client request is made with service IP address W1 and service port P1, and then the port may be negotiated to a number between 1025 and 1125. No other service port within the given service IP address can be negotiated to a number in that same range. However, another service port (e.g., P2 also for service IP address WI) may be assigned a port range, for example, from 1126 to 1300 (e.g., the size of the range is variable). In an embodiment, there are two distinct port ranges, 1025 through 1125 for P1 and 1126 through 1300 for P2, and there is no overlap between them.

FIGS. 9C through FIG. 9E depict application server 972 that dynamically negotiates both the service port and the service IP address. The first communication between client 922 and application server 972 (steps 1 through 8 in table 934) is performed using service IP address W1 and service port P1. During that initial communication, application server 972, which may operate in loopback mode, in alias mode, or in normal mode, negotiates a new service port D1 with client 922 and negotiates to use a new service IP address for further communications. In this example, the new service IP address is the IP address APP 1, assigned to server 972. During the client's remaining communication with application server 972 (steps 9 through 16 in table 934), client 922 uses the IP address APP 1 as the service IP address and uses the new service port Dl dynamically negotiated with application server 972.

If application server 972 supports only one application and client 922 initiates a session using the corresponding service port for that application, application server 972 will generally make its entire range of dynamic ports available for future communications with client 922. This is shown in sequence table 935 in FIG. 9E.

When client 922 accesses server 972 using service port P1, which corresponds to the single application supported on server 972, server 972 supports a dynamically negotiated port greater than 1024. If, however, application server 972 supports more than one application (service port), then application server 972 is configured to allow each service port to “own” a unique dynamic port range, as was described earlier.

Since the service IP address and port both change during negotiation with this type of application server, an entirely new service and sequence is being accessed. As shown in table 935, application server 972's sequence (after negotiation) is different from that of the original W1 service. The initial sequence followed includes firewall 965 when service IP address W1 is used. However, after changing the IP addresses, the sequence includes firewall 966, specifically chosen for use with the application.

This example further illustrates how packeting engine 901 can provide great flexibility for numerous network and security configurations.

Example Showing How The Present Invention May Be Implemented And Managed Using A Provisioning Engine And A Packeting Engine

Embodiments of the invention may be implemented by attaching the provisioning engine on a network segment from which it can reach the packeting engine. Once both systems are powered up, the provisioning engine then establishes secure communications with the packeting engine, using DES encryption and a dynamically changing key in an embodiment.

Next, the packeting engine administrator can use the provisioning engine to define, for each packeting engine interface, the IP addresses, netmasks, subnets, and the type of systems to be attached to the interface. The packeting engine administrator then defines the pool of service IP addresses that will be available to the packeting engine. Having completed those definitions, the packeting engine administrator installs the appliances and servers on the segments attached to the packeting engine. The devices can be installed directly on the interface's segment, as is the case for application server 871 in FIG. 8, or can be attached to a segment that is connected to an intermediate managed switch, as is the case for the IDS device 851 in FIG. 8. Such a switch can be used to isolate related systems onto virtual local area networks (VLANs) and prohibit communications between systems on different VLANs. The switch allows the packeting engine to send traffic to any MAC address for any system on the switch's VLANs. In an embodiment, it is best for management purposes to install related systems on the same segment, and it is best for security purposes to install the customer's end server on its own packeting engine interface or on its own VLAN.

As each device is installed and activated, the packeting engine, which runs dynamic host configuration protocol (DHCP), assigns an IP address to the device. The packeting engine also supports address resolution protocol (ARP) and will maintain a kernel-based table of IP addresses for systems that have announced their predefined IP addresses. The provisioning engine can automatically discover the new devices that are brought up on the packeting engine's segments. For each end server that is recognized, the packeting engine can simulate a connection to identify whether the server is running in loopback mode, in alias mode, or in normal mode.

Then, the customized services can be created. The packeting engine administrator can begin this process by creating a set of service packages that will be offered. Each service package defines a specific sequence of functions to be performed and offers several brands of components for each function (firewall, intrusion detection, VPN, etc.). Using a specific service package as a base, a customized service can be created by selecting specific options, including the functions to be performed, and, for each function, the brand of component that is required to meet a specific client's compatibility requirements. This customization can be performed by the packeting engine administrator or by a subscriber administrator. The provisioning engine pools like devices according to function and automatically assigns a physical device from the pool when the administrator specifies the brand. For redundancy reasons, devices should actually be assigned to a service in pairs. The provisioning engine can automatically pick the alternate device. Alternatively, the administrator can select the redundant device based upon the number of service IP addresses that already use each device in the pool, or based upon other load balancing criteria.

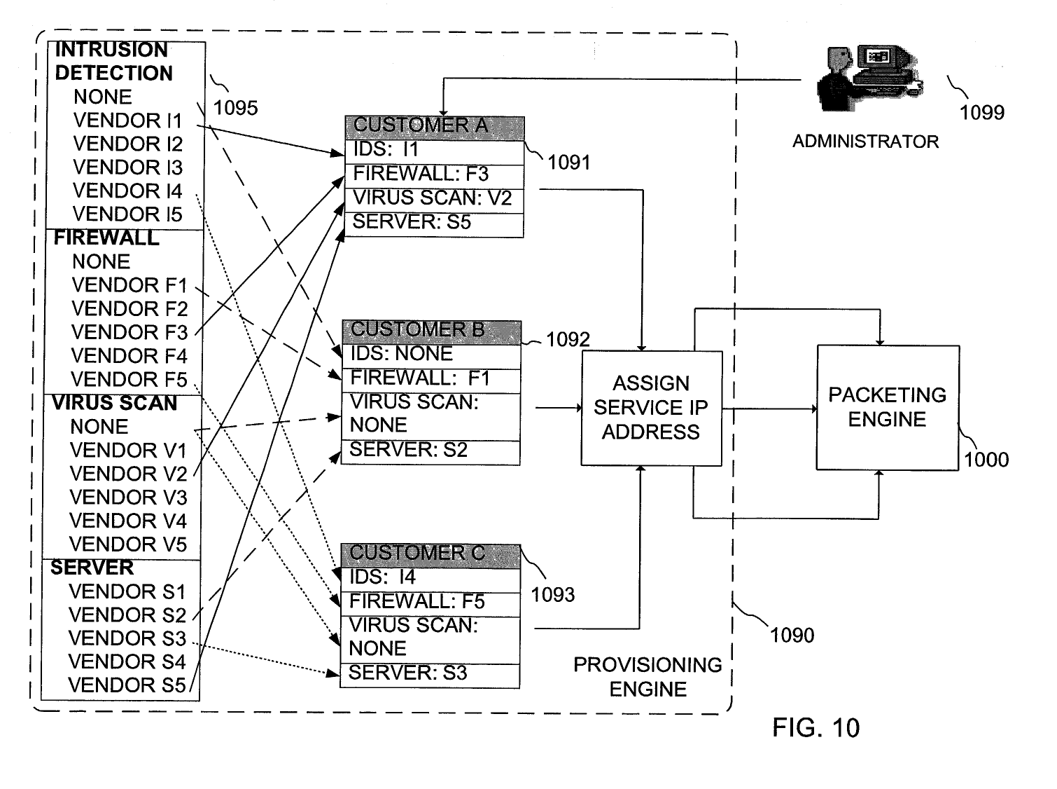

As shown in FIG. 10, provisioning engine 1090 manages a specific service package's appliances, servers, and sequence. Appliances and servers may be selected from a pool of available resources as indicated in table 1095. In this example, customer A requires Vendor I₁'s version of intrusion detection software, Vendor F₃'s version of firewall, Vendor V₂'s virus scanning capabilities, and a server from Vendor S5. This configuration is depicted as table 1091 on provisioning engine 1090. As shown in FIG. 10, the administrator 1099 may choose each of the required appliances and servers from a menu-driven or other user interface system. As shown in table 1092, customer B requires simply Vendor F₁'s firewall and a server from Vendor S₂—the customer does not want the intrusion detection and virus scan functions. Customer C requires an intrusion detection system from Vendor I₄, a firewall from Vendor F₅, no virus scanning, and a server from Vendor S₃, as shown in table 1093. In an embodiment, the default sequence is the one defined by the service package. Even if a function is not required (“None” is selected for that function), the packet can travel through the remaining functions (components) in the order specified by the service package. Additionally, a system administrator can override the default sequence, as required. For example, customer C may want packets to be presented to the firewall before being presented to the IDS.

Provisioning engine 1090 assigns a service IP address to each newly defined service. Service IP addresses may be selected from a pool of service IP addresses that has been assigned to the particular packeting engine, or one of the customer's existing IP addresses may be reused as the service IP address. Provisioning engine 1090 then passes the service definition to the packeting engine 1000, which performs the real-time packet processing. In an embodiment, the entire process of definition and implementation can be completed in minutes.

The customer is free to define access control list (ACL) controls for the new service using provisioning engine 1090, and those ACLs are transferred to packeting engine 1000 for real-time analysis of the customer's traffic. In preferred embodiments, the customer can modify ACLs (only for its own services), and to the customer, it appears as though there is a dedicated firewall for use with those services. Finally, the customer may upload any unique data, which can be used by the new service, to the end server.

Once the new service has been defined, domain name service (DNS) modifications are made to map a service name chosen by the customer to the service IP address. The service provider's router is updated to recognize the registered service IP address and to route that address to the appropriate packeting engine, which directs the service.

Embodiments of the invention allow a service provider and customer to incorporate many sophisticated capabilities into each service. The additional detailed description below describes how these capabilities may be implemented according to embodiments of the present invention.

### EXAMPLE

### Real-time Intrusion Detection

Promiscuous mode applications, such as intrusion detection and Hyper Text Transfer Protocol (HTTP) access control, can be designed to actively review all packets that pass by on the network. However, promiscuous mode applications are often unable to keep pace with the high network traffic bandwidths of production environments. Traffic passes by too quickly for the promiscuous application to review all of the packets.

An embodiment of the present invention implements the unique capability to selectively direct packets to multiple promiscuous mode application servers based upon service IP address and protocol (e.g., service port). By directing traffic for a specific service and port to a specific promiscuous application, the embodiment allows the promiscuous mode application to wait for, and then closely analyze, a designated subset of network packets. Each promiscuous mode application or device can also be isolated to ensure that it sees only those packets that the packeting engine specifically directs to it. The application is then able to analyze a larger portion, if not all of the traffic, that it receives. Intrusion detection and access control can, therefore, be performed in a more real-time fashion and unauthorized attempts to access the application can be more promptly terminated.

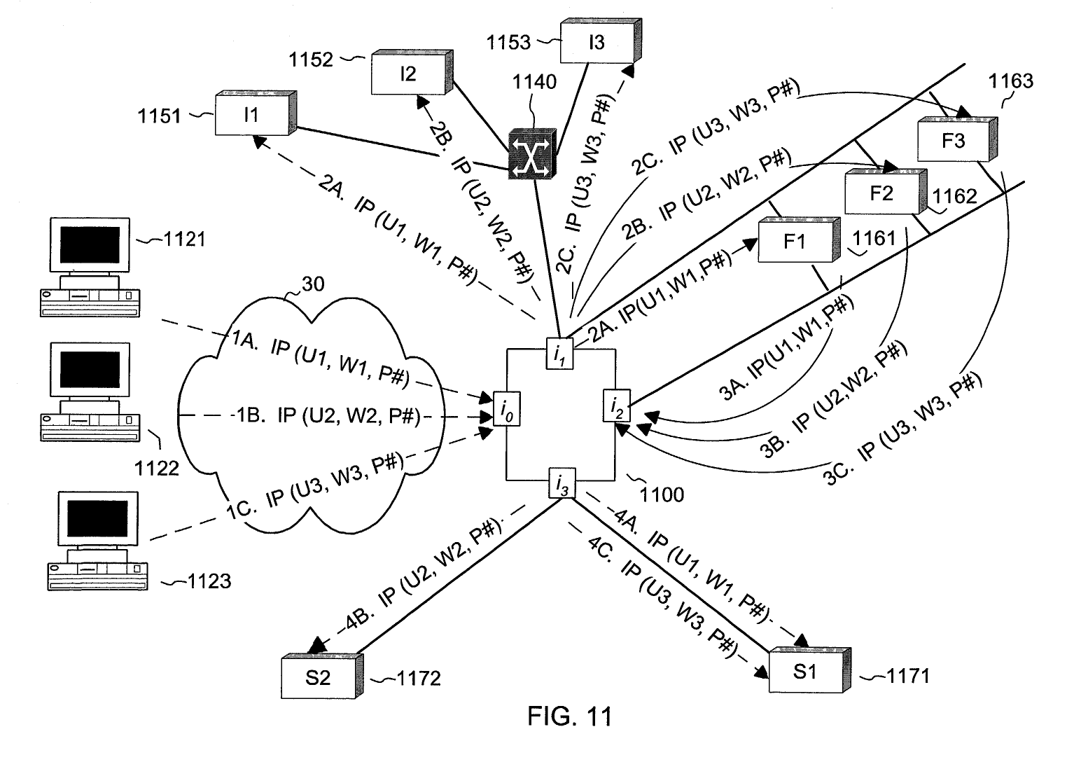

FIG. 11 illustrates an embodiment of the distribution of traffic to multiple intrusion detection systems 1151-1153. In this example, intrusion detection systems 1151-1153 are attached to switch 1140 that performs VLAN segmentation to segregate the traffic flow to each system. When user 1121 initiates a request to service IP address W1, packeting engine 1100 routes the packet to intrusion detection system 1151 and to firewall 1161. In this embodiment, intrusion detection system 1151 receives only packets for service IP address W1, so it is able to analyze the packets quickly and respond back to packeting engine 1100 if it detects an unauthorized attempt to use the application. In a similar manner, when user 1122 initiates a request to service IP address W2, the packeting engine 1100 routes the packet to intrusion detection system 1152 and to firewall 1162. Intrusion detection system 1152 receives only packets for service IP address W2, so it is able to analyze the packets quickly and respond back to the packeting engine 1100 if it detects an unauthorized attempt to use the application. The same approach is used to limit the traffic that is processed by intrusion detection system 1153 and it sees only the request for service IP address W3. Separate firewalls 1161-1163 are described as an example, and all three services could share the same firewall or no firewall.

Each of the intrusion detection systems 1151-1153, shown in FIG. 11, can be transparently shared by multiple services, and an embodiment of the invention directs each service packet to the appropriate intrusion detection system. When packeting engine 1100 receives notice from one of IDS systems 1151-1153 that an intrusion has been detected, it directs that response to either the associated firewall 1161-1163 or the associated end server 1171 or 1172. Any of those systems may terminate the TCP session and thereby halt the intrusion.

FIG. 11A is another example showing the distribution of traffic to multiple intrusion detection systems 1151-1153 serving multiple users 1121, 1122, and 1123 via a single packeting engine 1100. In this example, intrusion detection systems 1151-1153 are connected to separate network interfaces 1111-1113. By using separate interfaces, each intrusion detection system is isolated and can only see the traffic specifically directed to it by the packeting engine 1100. FIG. 11A shows more interfaces for packeting engine 1100 than FIG. 11 to illustrate that packeting engine 1100 may support a variable number of interfaces. The number of interfaces can be adjusted to suit service provider or customer requirements. For example, the number of interfaces may be fewer if a switch is used to segregate systems, while the number can be increased if separate packeting engine interfaces are required to isolate systems.

### EXAMPLE

### Support For Proxy Servers

The packeting engine allows a client to tunnel to a proxy that is connected to one of the packeting engine's segments. By tunneling into such a proxy, a client can access an end system that is not directly connected to one of the packeting engine's network segments, for example, an end system that is on the Internet. To tunnel into a proxy that is attached to a packeting engine segment, the client uses a service IP address as its proxy address when configuring its local client software. Since a service IP address is used as its proxy address, the client's packet reaches the packeting engine, which directs the packet through a service that incorporates a specific proxy.

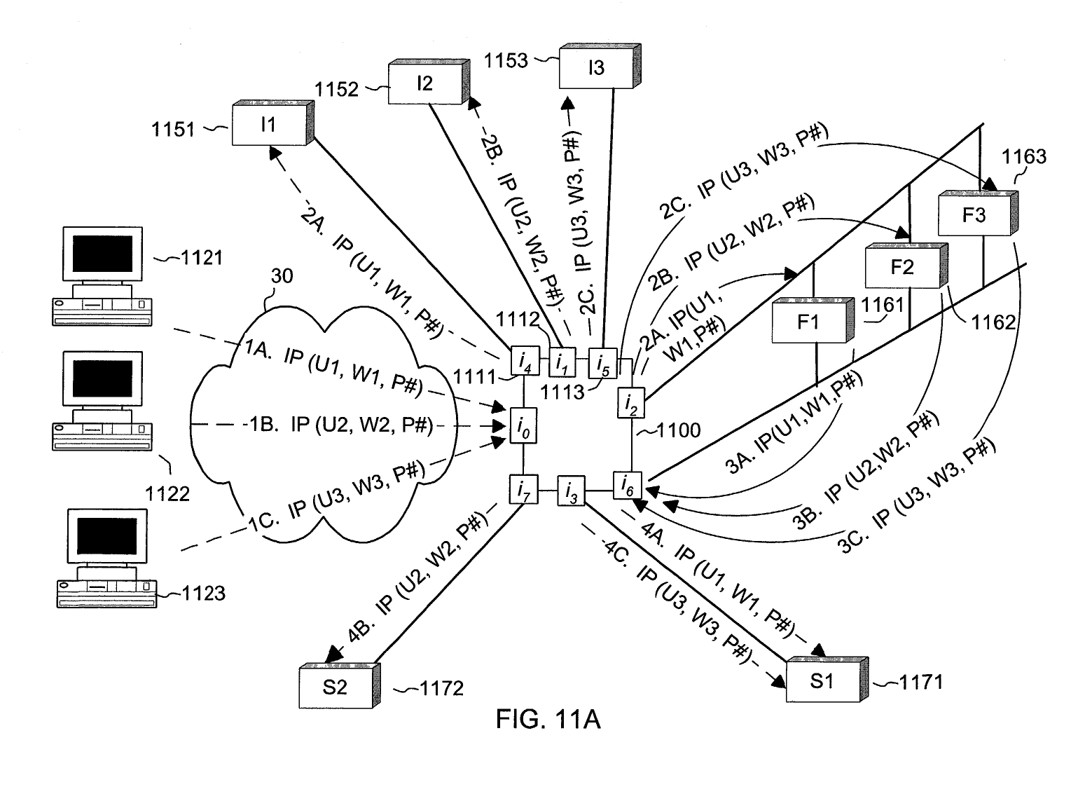

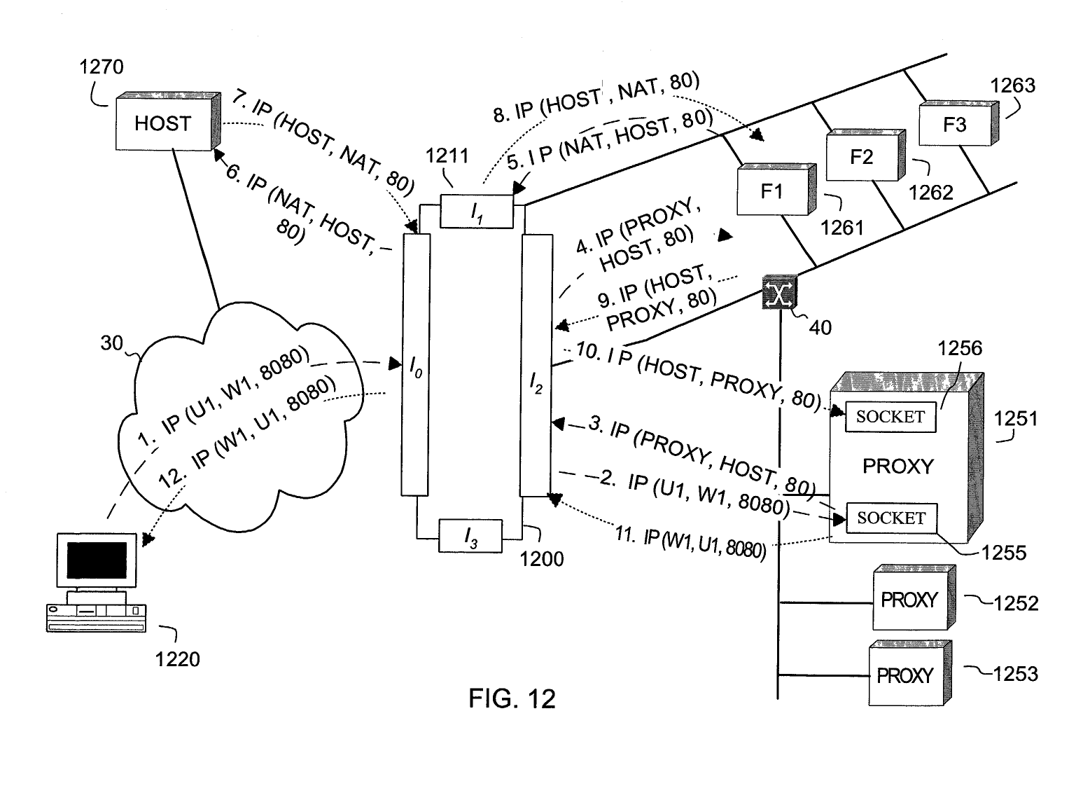

Depending on which service IP address the client specifies, the client's traffic may be sent to a specific proxy (e.g., one having specific ACLs for universal resource locator (URL) filtering) that is associated with one specific firewall behind the packeting engine. User 1220 in FIG. 12 sends traffic directed to service IP address W1 and service port 8080 (step 1). When packeting engine 1200 receives the packet, it directs the packet, based upon the sequence defined for WI and a service port of 8080, to proxy server 1251 (step 2). Proxy server 1251, which is considered the end device in the service W1, actually uses separate sockets for communications with the client and communications with the Internet host. In FIG. 12, socket 1255 is used to communicate with the end user and socket 1256 is used to communicate with Internet host 1270.

If the request is not halted by proxy server 1251's access control rules for URL filtering, then proxy server 1251 sends the packet out. Proxy server 1251 hides the client's source IP address by inserting its own address, PROXY, as the source IP address, changes the service port to 80, and directs the packet back to the packeting engine 1200 (step 3). This communication effectively requests a new service from packeting engine 1200 (i.e., service request from proxy server 1251 to Internet host 1270). Packeting engine 1200 treats the destination IP address PROXY as a service IP address and then directs the packet to firewall 1261 (step 4), which is the firewall designated for use with proxy server 1251. Firewall 1261 performs network address translation (and, optionally, other functions, such as stateful inspection of the packet, encryption, and intrusion detection). If the packet meets the criteria defined within firewall 1261, packeting engine 1200 receives the packet back from firewall 1261 (step 5) on interface I₁ 1211. Packeting engine 1200 then passes the packet on to Internet host 1270 via network 30 (step 6). Internet host 1270 responds to packeting engine 1200 (step 7) and packeting engine 1200 directs the packet back to firewall 1261 (step 8). Firewall 1261 performs the required packet analysis, as well as reverse NAT to reveal proxy server 1251's IP address, PROXY, and sends the packet back to packeting engine 1200 (step 9). Packeting engine 1200 sends the packet back to proxy server 1251 (step 10), which determines the associated socket 1255 for client-side communications. Proxy server 1251 then responds back to packeting engine 1200 using service IP address W1 as the source IP address and a destination IP address of U1 which is client 1220's IP address (step 11). Packeting engine 1200, in turn, sends the packet back to client 1220 (step 12).

Client 1220 can also specify a service IP address that directs traffic to proxy server 1252, and then proxy server 1252's access control criteria are satisfied before client 1220's traffic is allowed to proceed through the service to firewall 1262, which is associated with proxy server 1252, and on to network 30. Similarly, if client 1220 specifies a service IP address that directs traffic to proxy server 1253, then proxy server 1253's access control criteria are satisfied before the client 1220's traffic is allowed to proceed through the service to firewall 1263 associated with proxy server 1253, and on to network 30.

This embodiment of the present invention allows the sharing of proxy servers among multiple customers. Multiple services (each with a unique service IP address) can share a specific proxy, so that multiple clients can share the same proxy controls such as, for example, controls that prohibit access to inappropriate sites by minors.

### EXAMPLE

### Support for Firewall ACL Sharing

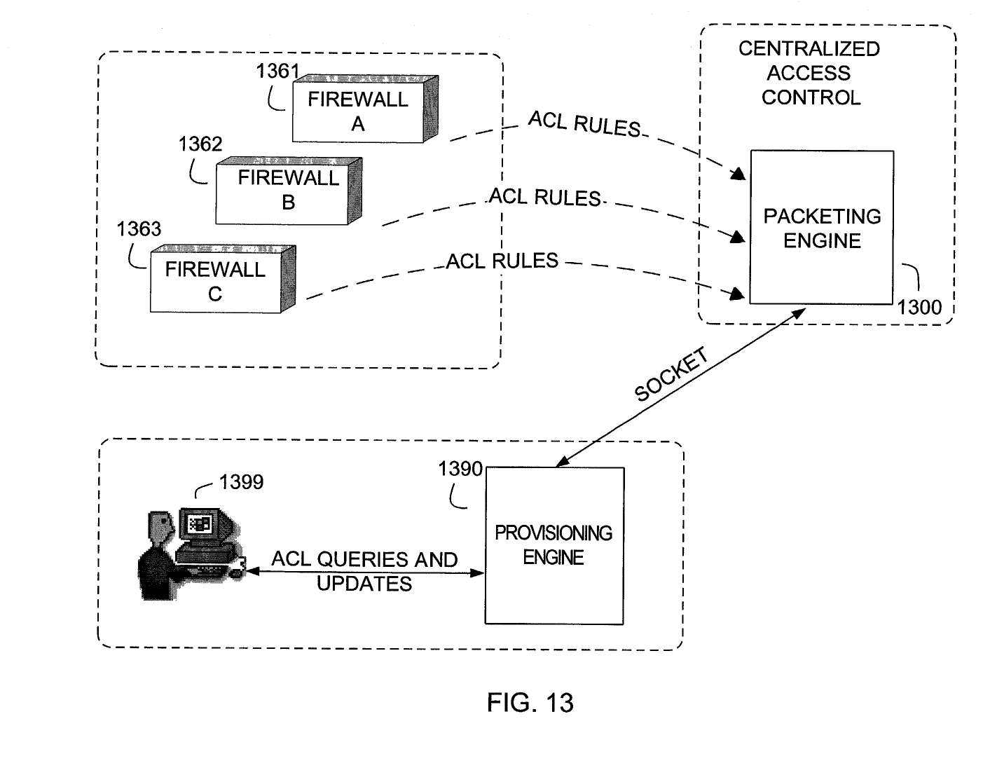

This example illustrates that an embodiment of the present invention supports sharing of firewall access control list (ACL) rules among multiple customers to reduce the number of firewalls required in a hosting environment. A lightweight firewall capability can be incorporated into the packeting engine, so that the packeting engine may serve as a central manager. As shown in FIG. 13, ACL rules are transferred from customer firewalls 1361-1363 to packeting engine 1300. Firewalls 1361-1363 retain their heavyweight functions such as stateful inspection of packets, intrusion detection, encryption, and network address translation. However, with the removal of access control rules, the firewalls need no longer contain customer-unique information, need no longer be dedicated to a single customer, need no longer be isolated by VLAN, and are available for use by multiple service IP addresses.

The ACLs of packeting engine 1300 define by service IP address which protocols are allowed to enter its various interfaces. Customer administrator(s) 1399 may access and manage these rules, in real-time, through provisioning engine 1390's administrator interface. Customer administrator(s) 1399 are no longer reliant upon service provider staff and are no longer restricted to third shift maintenance periods to effect changes to the access control rules. As a result, firewall operations staffing costs are significantly reduced. Furthermore, although firewall ACL rules are centralized on one system, packeting engine 1300, from the customer's point of view, the firewall appears as a dedicated resource because rule sets are distinct for each service IP address.

Packeting engine 1300 is designed to allow the incorporation of additional firewall capabilities, including, but not limited to, source-based routing, policy-based routing, and TCP stateful firewall capabilities such as firewall-based user authentication. Packet throughput requirements (from both the service provider and its clients) can be considered before these capabilities are activated because each of these capabilities places a demand on packeting engine 1300 and can, therefore, impact the total packet throughput. If an environment requires very high throughput, some of the firewall functions can be distributed to separate firewall devices as shown in FIG. 13.

The packeting engine can include any of several security mechanisms that may be built into the system. For example, the packeting engine can be configured to allow only the provisioning engine to log onto it. In an embodiment, to protect the packeting engine from intentional or accidental overload by a flood of packets, it can be configured to simply drop packets if it receives too many to process. In the event of a denial of service attack, it may be the responsibility of the firewall, within the customer's service, to identify the attack and drop the associated packets.

### EXAMPLE

### Support for Database Servers

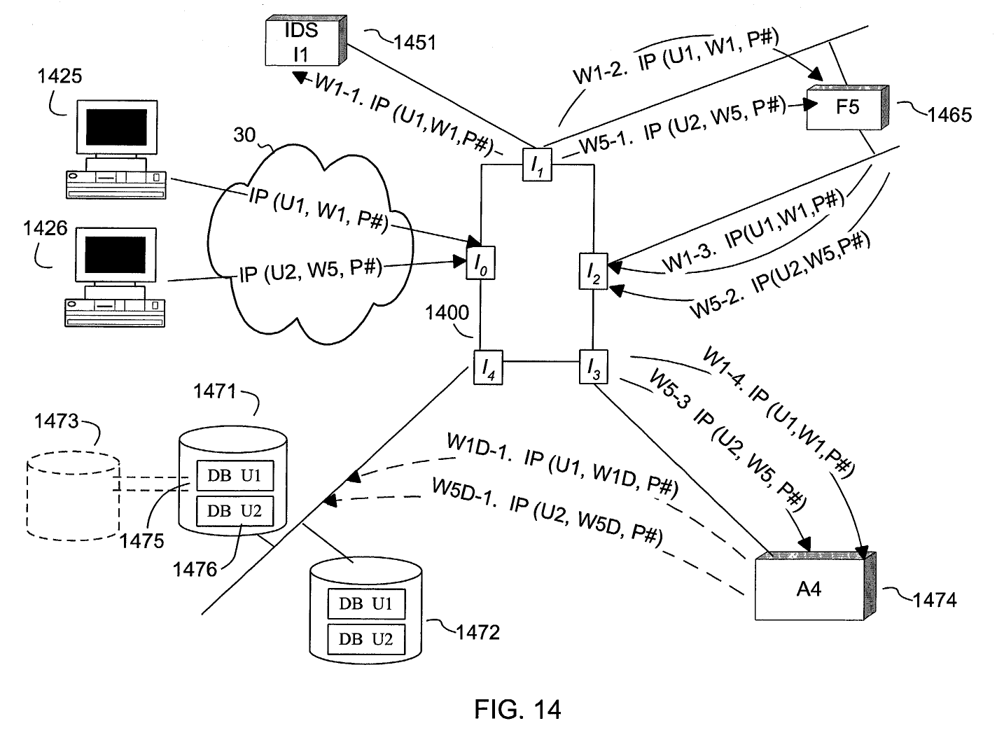

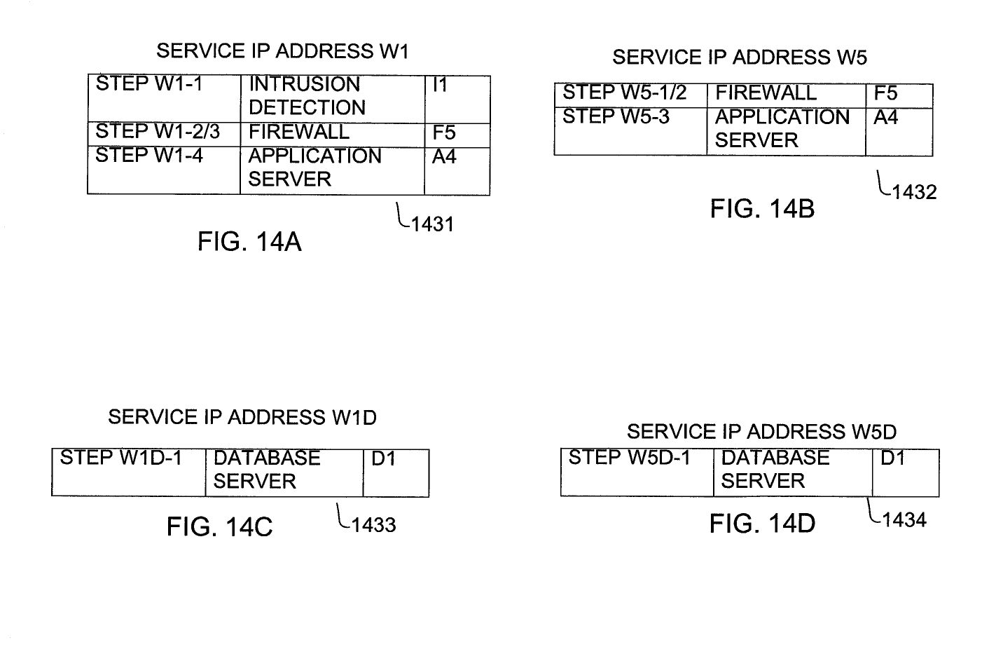

Embodiments of the present invention support the use of database servers in a variety of configurations. First, an embodiment of the invention allows customers to use different service subscriptions to share a database server. As shown in FIG. 14, the same database server, server 1471, houses the databases for two clients: DB U1 1475 serves client 1425 and DB U2 1476 serves client 1426, even though the clients use different service IP addresses to access their data. Client 1425 initiates a service request via service IP address W1. Service IP address W1 is associated with sequence table 1431 in FIG. 14A. As shown in sequence table 1431, when client 1425 uses service IP address W1, packeting engine 1400 sends the packets to intrusion detection system I₁ 1451, firewall F5 1465, and then to application server A4 1474. In contrast, when client 1426 initiates a service request via service IP address W5, the sequence includes only firewall F5 1465 and application server A4 1474, as shown in sequence table 1432 in FIG. 14B.

Application server A4 1474 is the last device to receive a packet from the clients in either case, i.e., when either service IP addresses W1 or W5 are used. Application server A4 1474 uses an open database connection (ODBC) or a network file system (NFS) mount request to initiate a separate service to access the data for each client 1425 or 1426. To transfer data to and from database server 1471 in support of client 1425 and service IP address W1, application server 1474 uses service IP address W1D, as shown in table 1433 in FIG. 14C. To transfer data to and from database server 1471 in support of client 1426 and service IP address W2, application server 1474 uses service IP address W5D as shown in table 1434 in FIG. 14D. For service IP addresses W1D or W5D, packeting engine 1400 maps the service IP address to the real IP address of the database server 1471, where the clients' databases are stored.

Second, an embodiment of the present invention also supports the use of database servers in a redundant configuration. Database server 1472 contains the same data as database server 1471 at all times, since the databases 1475 and 1476 on database server 1471 are mirrored on database server 1472. If database server 1471 were to fail, packeting engine 1400 would automatically modify its tables so that it could map the service IP addresses W1D and W5D used by application server 1474 to the real IP address of database server 1472. In this manner, the fail-over from one database server to the other is completely transparent to both the clients and the application server.

Finally, in another embodiment of the present invention, packeting engine 1400 can be used in a configuration where the databases are actually stored on a separate storage server 1473 that is directly attached to database server 1471. In this configuration, databases 1475 and 1476 do not reside on database server 1471 itself.

In this example packeting engine 1400 would direct the packet to database server 1471, which it understands to be the end database system, and database server 1471 would communicate with the storage server 1473 on its own.

### EXAMPLE

### Embodiments Supporting High Availability Services

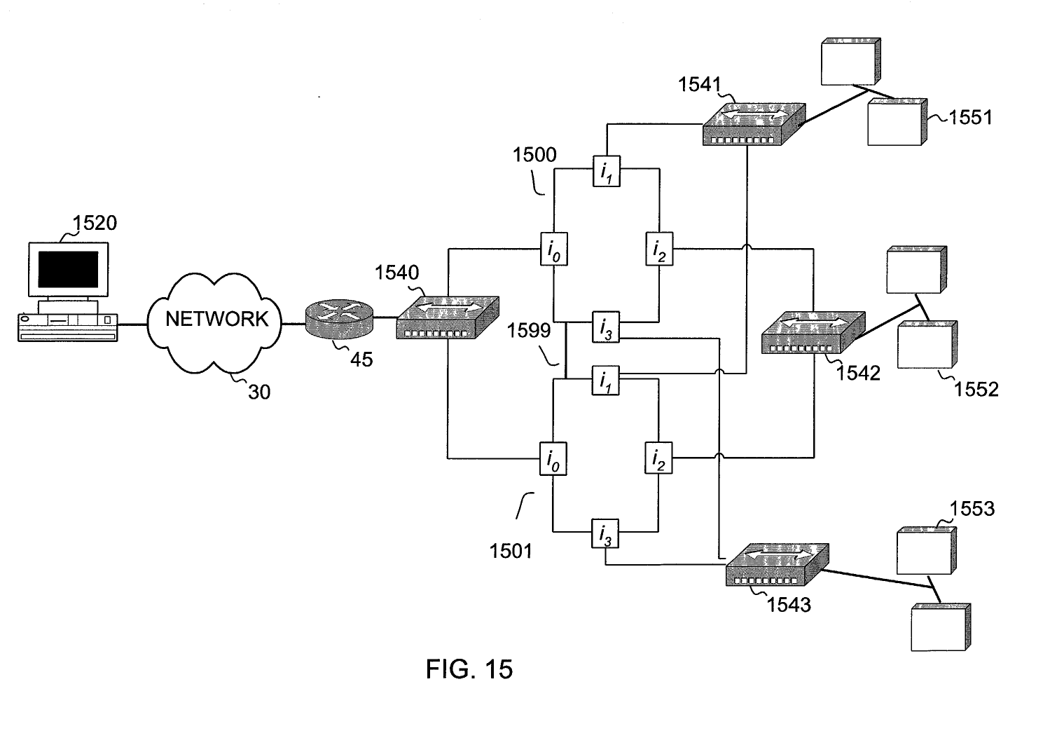

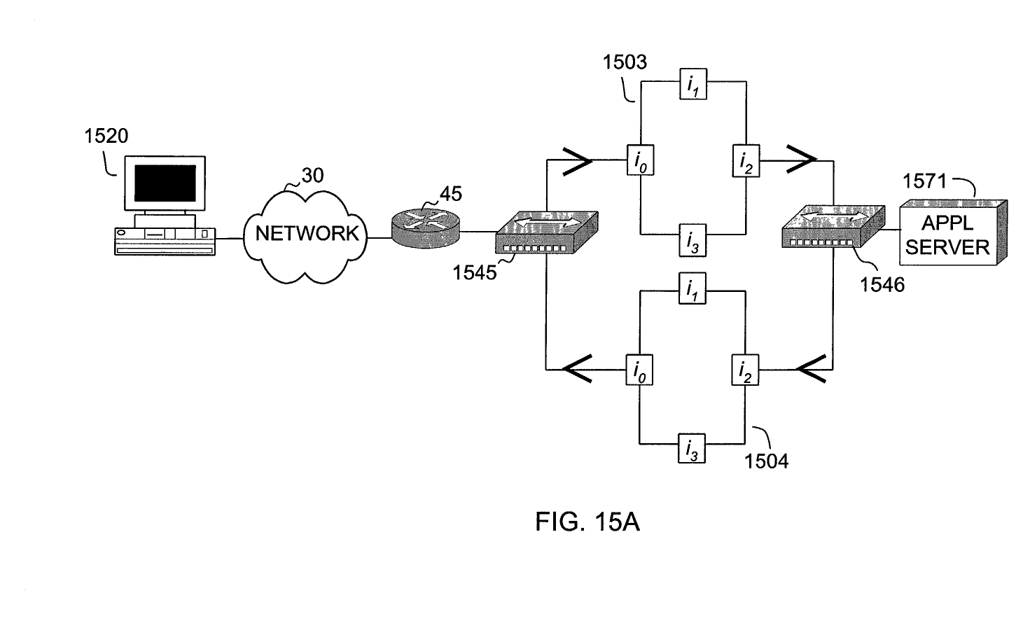

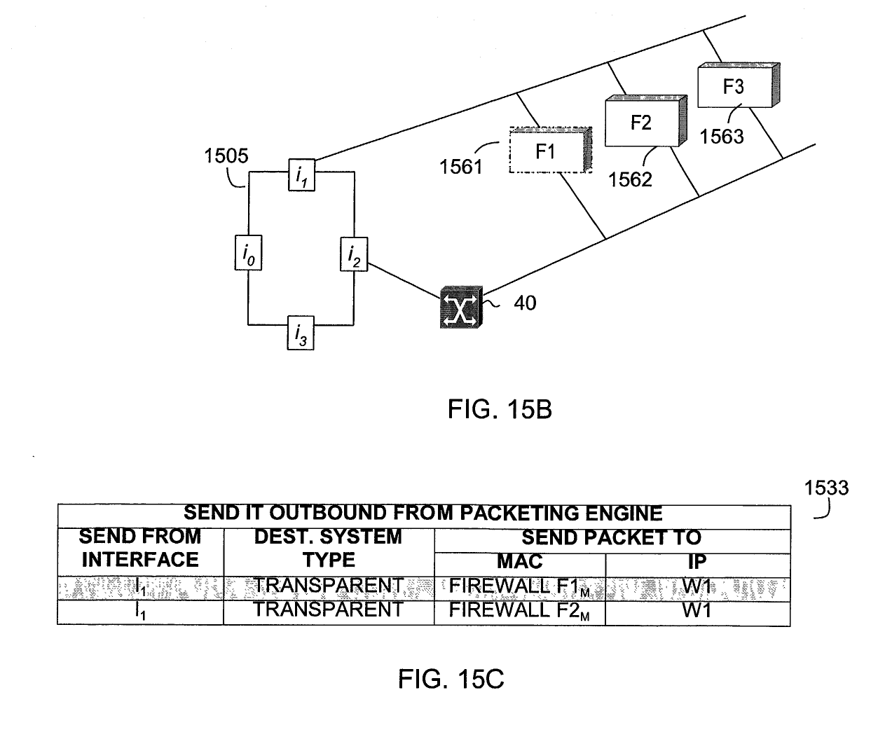

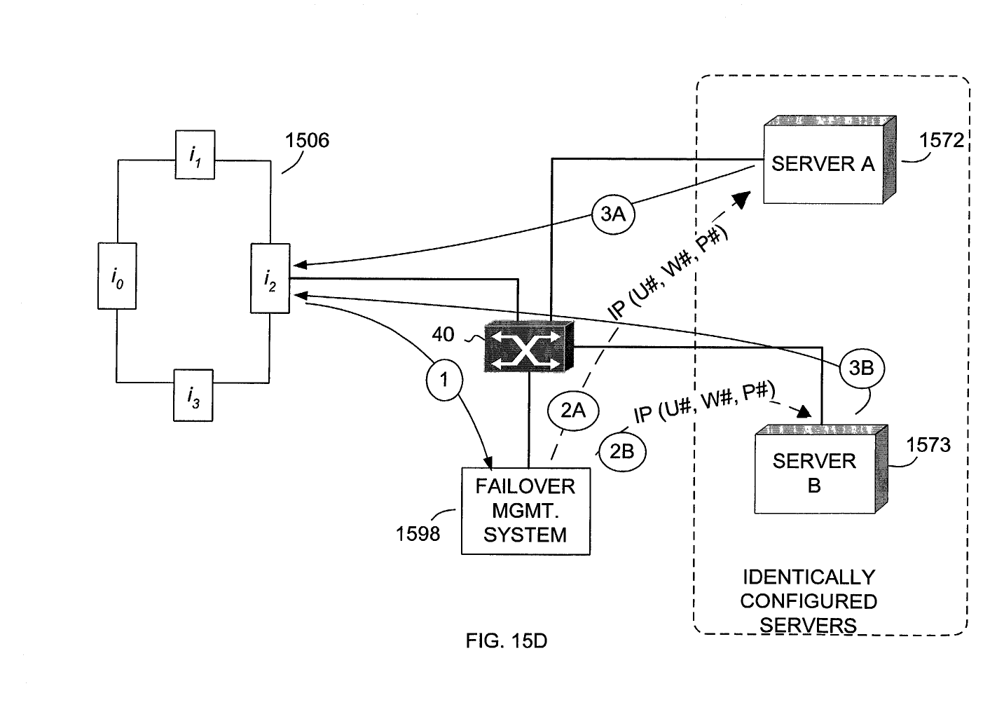

Embodiments of the present invention can incorporate several features to ensure high availability. First, as shown in FIG. 15, the invention can be implemented with redundant packeting engines 1500 and 1501 coupled to hub 1540, hubs 1541-43, and intermediate appliances 1551-1553. Examples of intermediate appliances, in an embodiment, include intrusion detection systems, firewalls, virus scanners, proxy servers, VPN, and so on. Redundancy is possible in an embodiment because packeting engines 1500 and 1501 are stateless and service table consistency is maintained. In normal operating mode, packeting engine 1500 is primary and it broadcasts ARP messages to associate the master IP address for the pair of packeting engines 1500-1501 with its own MAC address. Packeting engine 1500 then receives all packets for registered service IP addresses defined on packeting engines 1500 and 1501. If the primary packeting engine 1500 fails, packeting engine 1501, the secondary, recognizes the failure (because, for example, communications over communications link 1599 have ceased) and immediately issues an ARP notice to associate the master packeting engine IP address with its own MAC address. Packeting engine 1501 then receives all packets for registered service IP addresses defined on packeting engine 1500 and 1501.

Second, as shown in FIG. 15A, an embodiment of the invention supports load sharing between packeting engines to ensure that a single packeting engine does not become too heavily loaded and, therefore, become unavailable. An embodiment of the invention, which can be stateless, can be implemented in a configuration with one packeting engine supporting traffic sent by customers and another packeting engine supporting traffic received from application devices. In FIG. 15A, client 1520 uses a service IP address that is routed to packeting engine 1503 via hub 1545. Packeting engine 1503, in turn, directs the packet to an application server via hub 1546. When the application server 1571 issues a response, it is sent out on the server's default route to packeting engine 1504.

In the configuration depicted in FIG. 15A, packeting engine 1503 is responsible for recognizing when the application server 1571 has failed. When packeting engine 1503 receives several SYN (synchronize) requests in a row from client 1520 attempting to establish a TCP session with the application server 1571, then packeting engine 1503 can recognize that the application server 1571 has not been responding. At that point, packeting engine 1503 can update its internal tables to flag the device as unavailable and to flag the service as unavailable (since no alternate application server is available in this example). Packeting engine 1503 can also notify the provisioning engine (not shown in FIG. 15A) that both the device and service are unavailable. Packeting engine 1504 does not need to be updated with the device or service status because it is available to process packets from the application server 1571, if it receives any. In the configuration depicted in FIG. 15A, packeting engine 1504 is responsible for calculating service performance as the difference between the receive times for two consecutive packets from the application server 1571.

Third, as shown in FIG. 15B, the packeting engine 1505 can pool like devices, recognize the failure of any single device, and redirect packets to an alternate device (of the same type and configuration). When the provisioning engine (not shown in FIG. 15B) prepares the service tables for the packeting engine 1505, it identifies, or allows an administrator to identify, an alternate device for each device in a service, if one exists. The packeting engine 1505 is then prepared to redirect packets should a device in the service fail.

If a number of packets do not return from a specific device, the packeting engine 1505 can initiate stateful testing by sending a simulation packet to the device. This simulation packet is used to initiate a socket handshake only. It ensures that the packeting engine 1505 can communicate with the device from the IP layer through the application layer, but does not require actual data exchange. For example, the packeting engine 1505 may send a simulation packet to firewall 1561. If it does not receive the anticipated response, it records the device failure. The packeting engine 1505 then modifies its service tables to replace the device's address with the address of the alternate device, (e.g., firewall 1562, firewall 1563), as shown in table 1533 in FIG. 15C. The packeting engine 1505 notifies the provisioning engine that the device is down and incorporates the failed device back in its service tables only when directed to do so by the provisioning engine. If a device fails and does not have a defined backup (e.g., redundant device), an embodiment of the provisioning engine allows the administrator to add a new device and automatically regenerate all services (that previously used the failed device) to use the replacement device.

Fourth, as shown in FIG. 15D, the packeting engine 1506 may be configured to allow the customer/subscriber to use a separate system 1598 to manage fail-over between devices such as web servers. The packeting engine 1506 recognizes the separate fail-over management system 1598 as a device within the service and does not direct packets directly to server 1572 or server 1573. The fail-over management system 1598, in turn, manages the fail-over between the pair of servers as necessary. In normal operating mode, the fail-over management system 1598 may direct packets to server 1572, and the server responds back to the packeting engine 1506 using loopback mode. If server 1572 fails, the fail-over management system 1598 redirects the packets to server 1573. Again, server 1573 responds back to the packeting engine 1506.

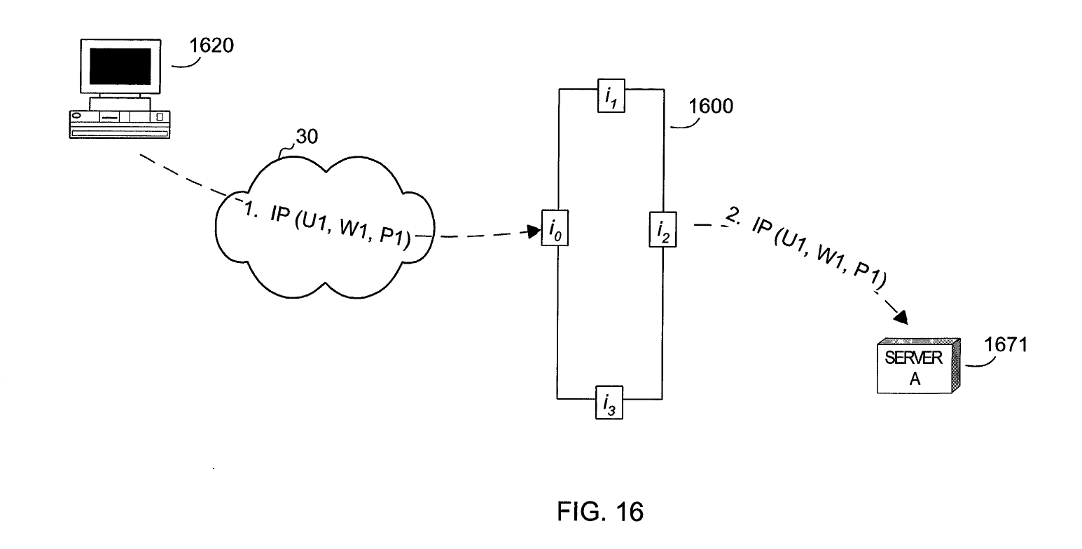

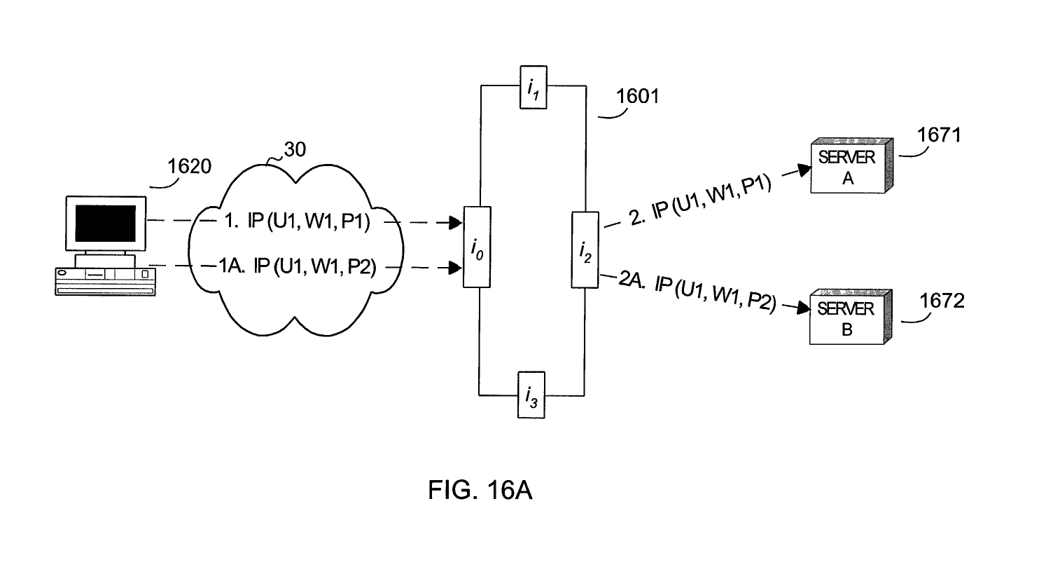

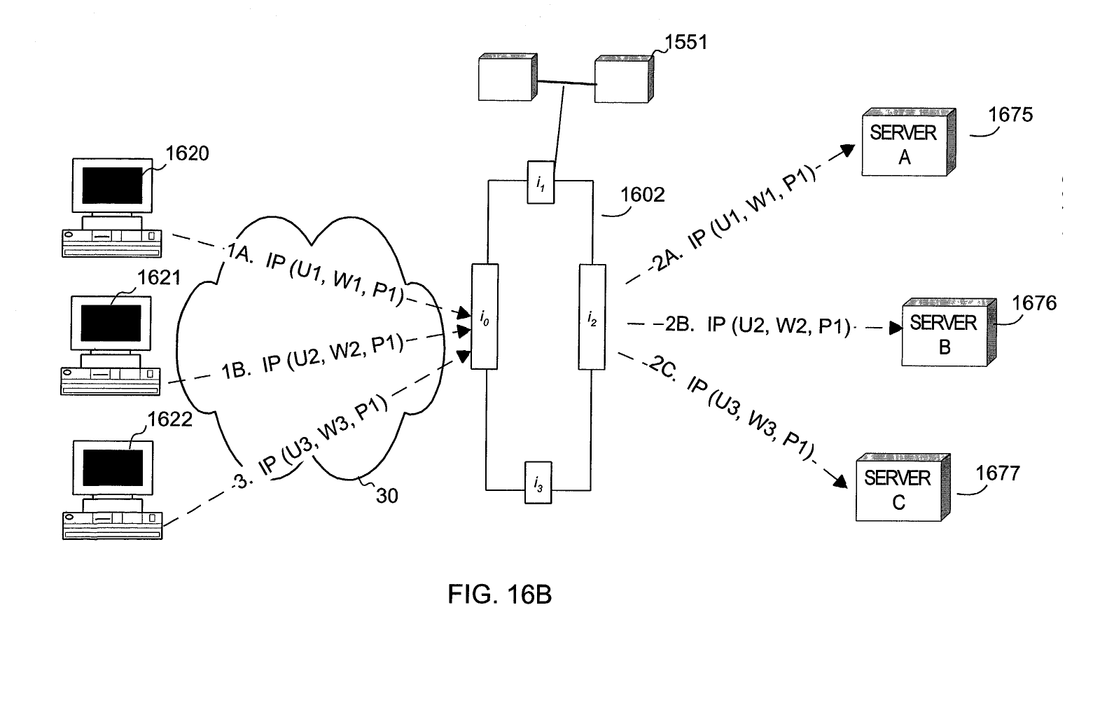

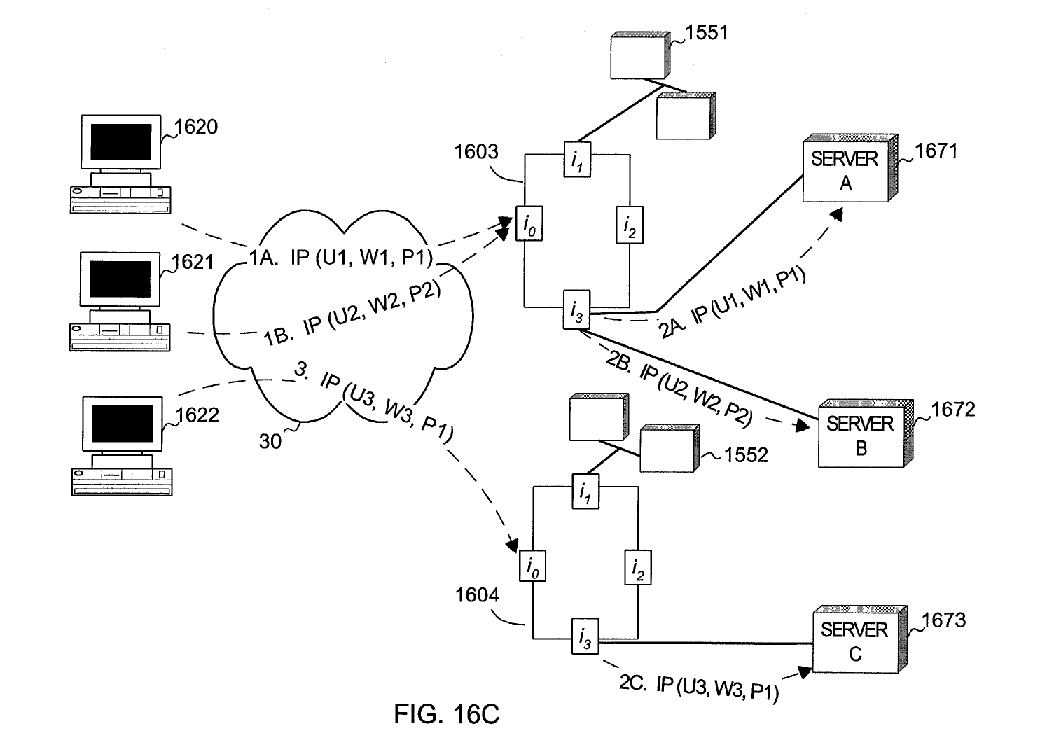

Embodiments of the present invention relate to scalable systems. A sample embodiment of the invention supports at least four dimensions of scalability. A first dimension, shown in FIG. 16, includes a single client 1620 accessing a single server 1671 by using a specific service port of a service IP address. Client 1620 sends packets addressed service IP address W1 that the packeting engine 1600 directs to server 1671.

A second dimension, depicted in FIG. 16A, includes the use of port-based routing. If the client 1620 initiates a request to service IP address W1 and service port P1, the packeting engine 1601 directs the packet to server 1671. However, if the client 1620 uses service port P2 with service IP address W1, the packeting engine 1601 directs the packet to server 1672. This capability allows a single service IP address to be associated with any number of servers or applications that might be accessed by the client 1620.

A third dimension of scalability, shown in FIG. 16B, includes a packeting engine distributing traffic across a series of identically configured servers 1675-1677, based at least in part upon multiple service IP addresses. The packeting engine 1602 directs the packet for service IP address W1 and service port P1 to server 1675. The packeting engine 1602 directs the packet for service IP address W2 and service port P1 to server 1676. Similarly, the packeting engine 1602 directs the packet for service IP address W3 and service port P1 to server 1677. This capability supports the introduction of additional servers, as required, to support the traffic load.

A fourth dimension is shown in FIG. 16C, which depicts the distribution of packets across multiple packeting engines 1603-1604. This capability enables the introduction of additional packeting engines, as required, to support the traffic load. Service IP addresses W1 and W2 are registered IP addresses that are routed to packeting engine 1603, while service IP address W3 is a registered IP address that is routed to packeting engine 1604.

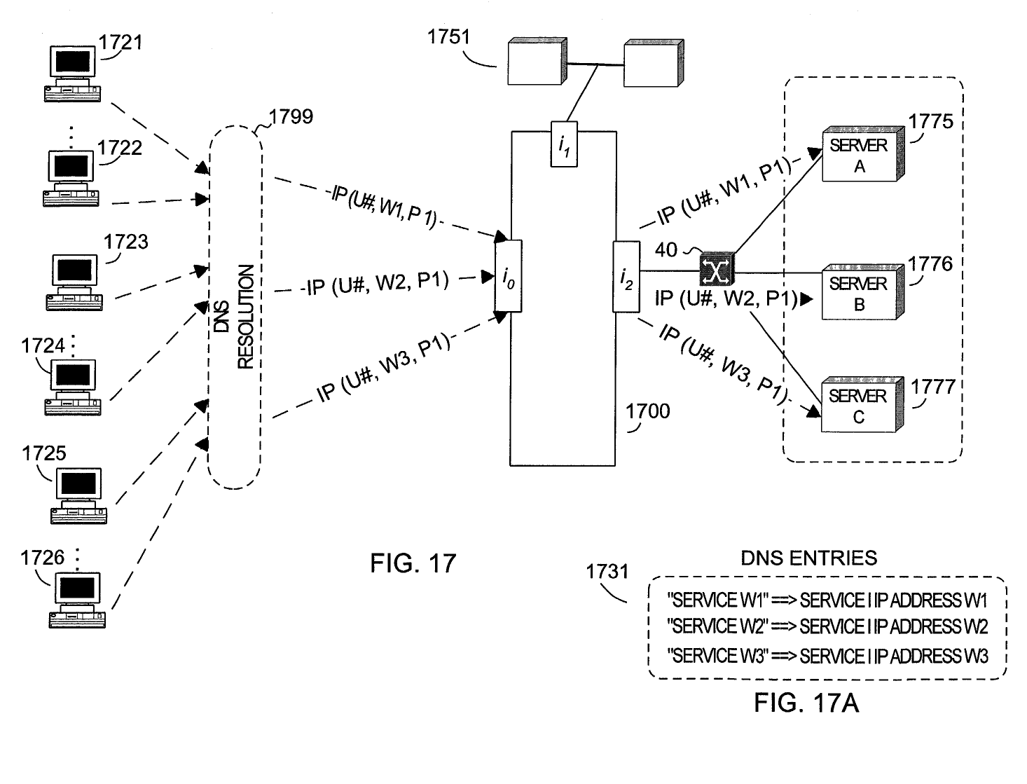

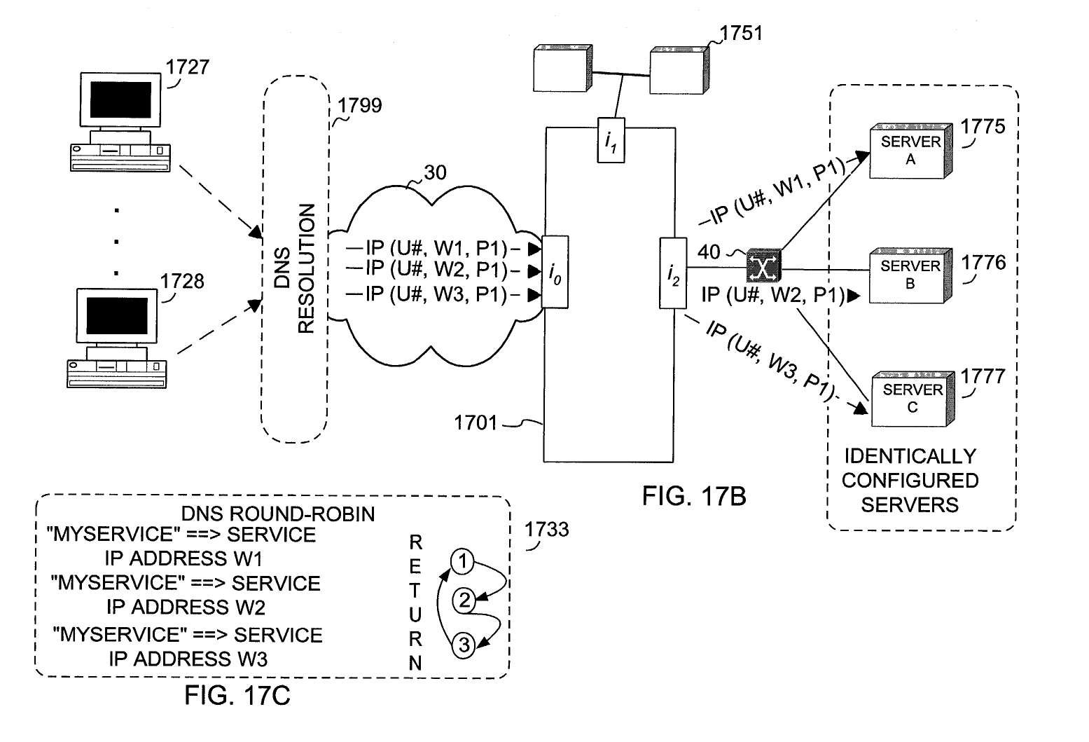

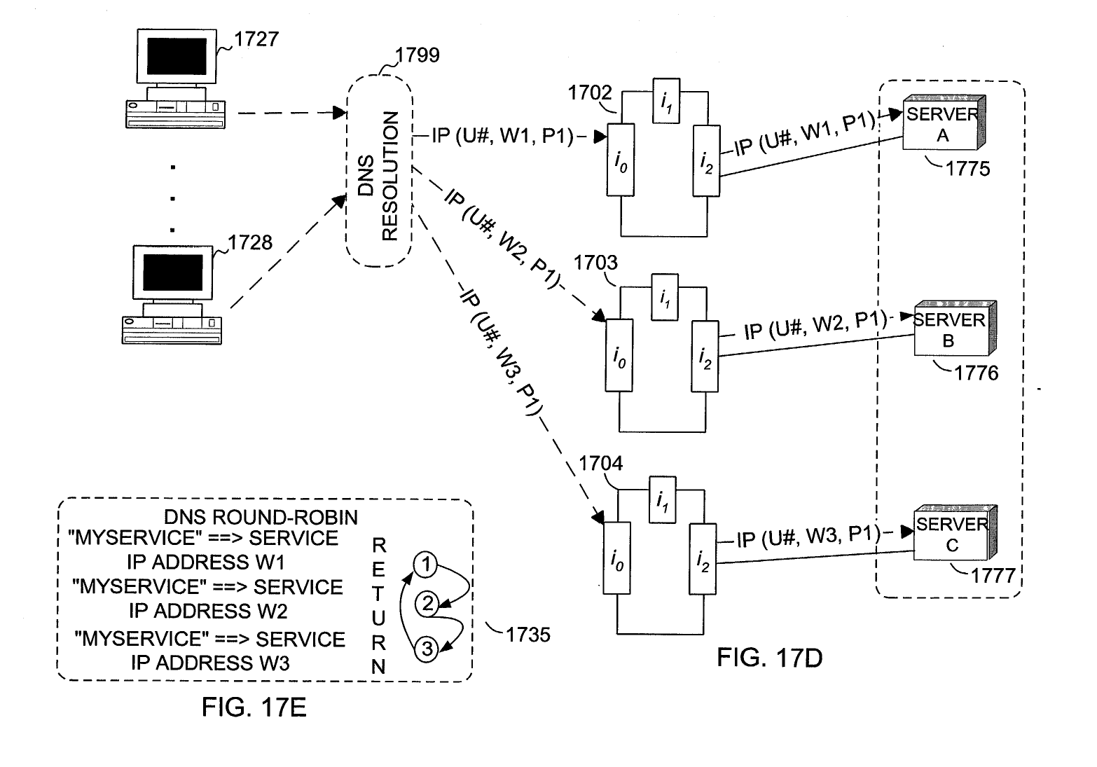

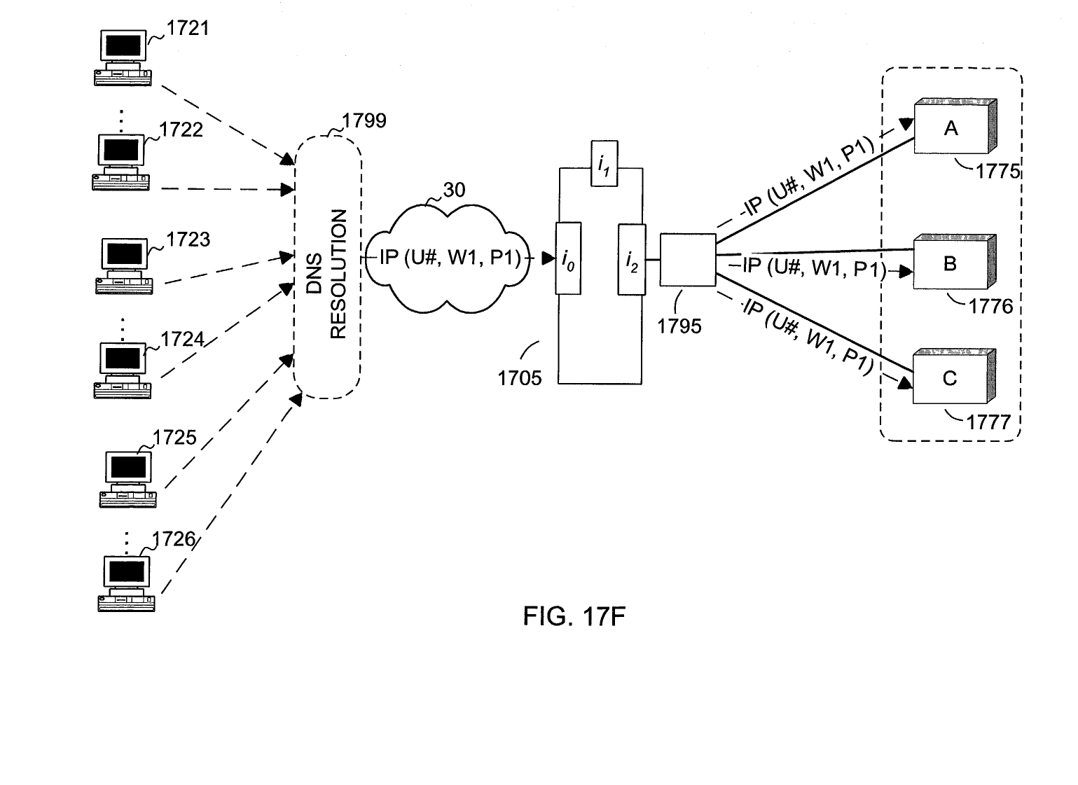

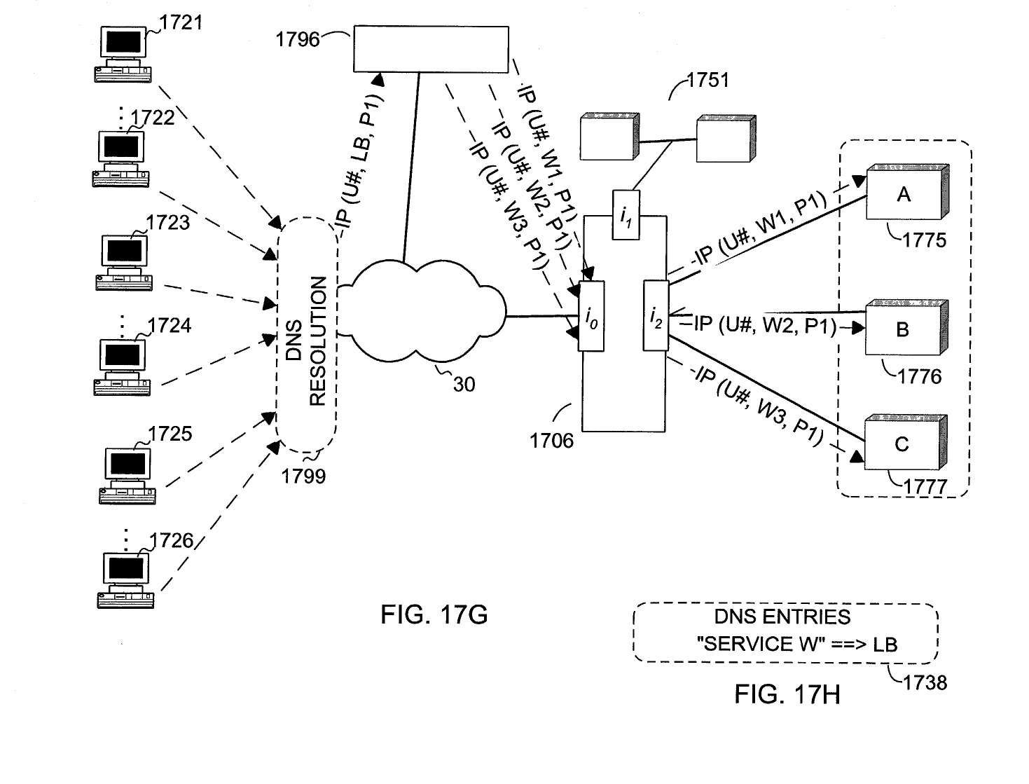

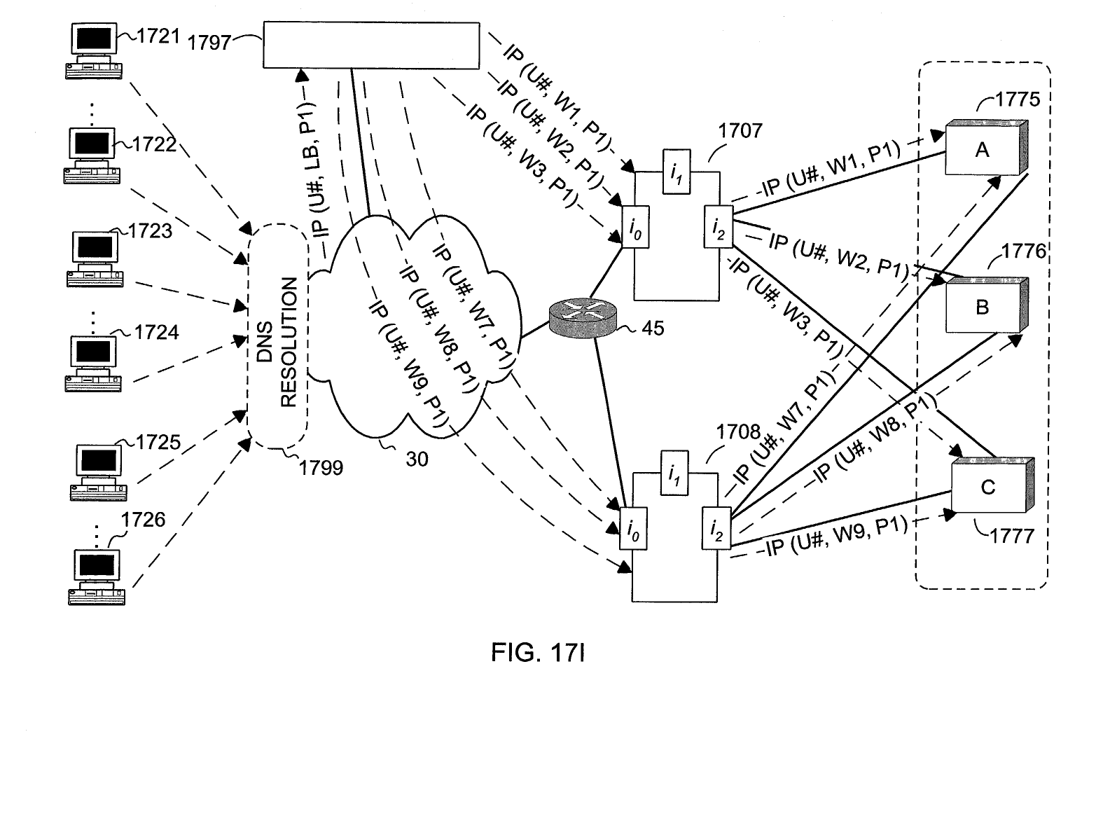

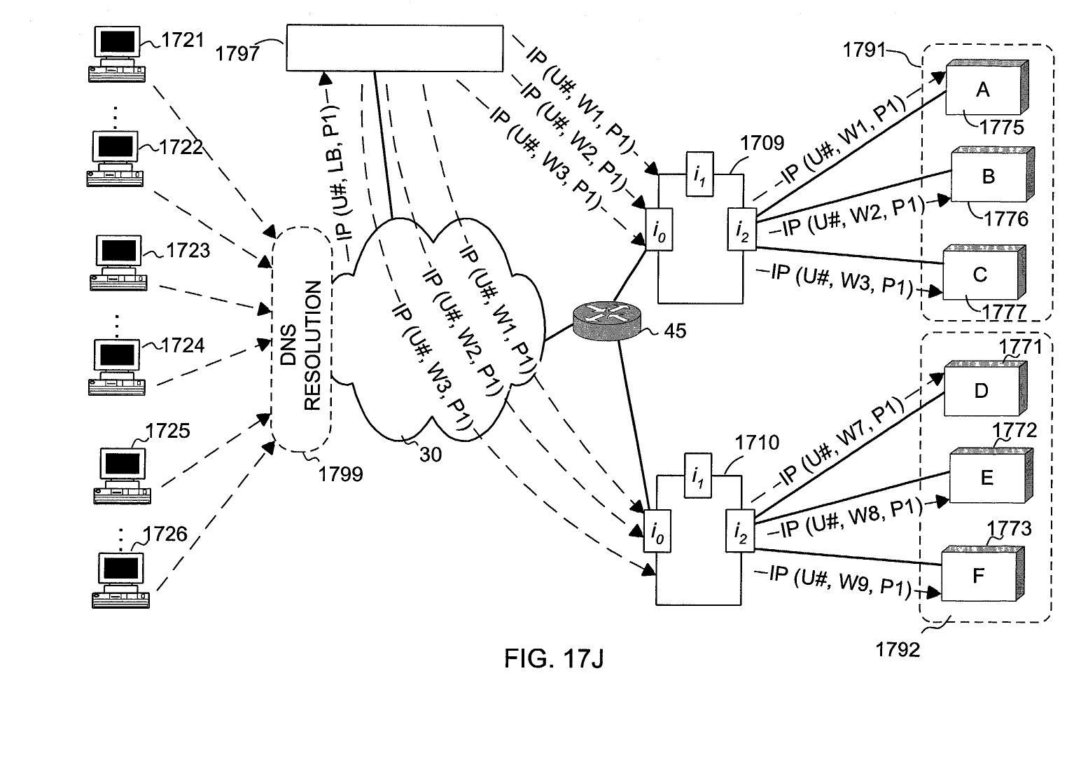

Embodiments of the present invention also relate to load balancing, and an embodiment of the invention can be used in conjunction with a variety of load balancing techniques. If one end server cannot support all of the users that require a specific application, users can be divided into groups, as shown in FIG. 17, and each group can be assigned a different service IP address. In this example, each of the W1, W2, and W3 service IP addresses represents the same service, except that each service IP address is directed to a different end server in a set of identically configured servers 1775-1777. The first group of users includes clients 1721 and 1722 among others and uses service IP address W1 (generally via a named service that can be resolved by a DNS server as shown in table 1731 in FIG. 17A). The packeting engine 1700 directs the W1 service to server 1775. The second group of users, including clients 1723 and 1724, use a named service that DNS resolves to the W2 service IP address. The packeting engine 1700 directs the W2 service to server 1776. The final group of users, including clients 1725 and 1726 use a named service that DNS resolves to the W3 service IP address. The packeting engine 1700 directs the W3 service to server 1777.

For service providers that already direct groups of users to distinct, yet similar, end servers to distribute existing workload, embodiments of the present invention provide a natural solution. A customer's end server IP address can be reused as the service IP address (the end server is then given a different IP address one that need not be registered). Intermediate appliances 1751 can be defined within the service to analyze the traffic between the customer and the end server, and yet the end users see no change. They merely use the same service name (or same IP address, if they actually enter an address) that they've always used, and the packets are analyzed by intermediate appliances (firewall, intrusion detection, etc.) and are distributed to the same end server that would have previously received them.

An alternative approach, shown in FIG. 17B, allows end users such as clients 1727 or 1728 to use the same service name. That service name is resolved by DNS system 1799 to a set of service IP addresses in a dynamic, round-robin fashion as shown in table 1733 in FIG. 17C. For example, the first time DNS system 1799 resolves the service name “MYSERVICE”, it resolves the name to the service IP address WI, which the packeting engine 1701 directs to server 1775. The second time DNS system 1799 resolves the service name “MYSERVICE,” it resolves the name to the service IP address W2, which the packeting engine 1701 directs to server 1776. The third time DNS system 1799 resolves the service name “MYSERVICE,” it resolves the name to the service IP address W3, which the packeting engine 1701 directs to server 1777. The next time that DNS system 1799 resolves the service name “MYSERVICE”, it starts back at the WI service IP address, as shown in Table 1733.

This round-robin approach can be used to incorporate a new server to share an existing server's workload. The new server can, at any time, be attached to a segment connected to the packeting engine. The packeting engine's DHCP process automatically provides the server an IP address as soon as the server boots. Then, in real-time, an administrator can create an additional service IP address, using the same intermediate devices that were used in the original service IP address. Whenever DNS system 1799 resolves the service name to the new service IP address, an embodiment of the invention is ready to direct traffic through the complete service, including the new server.

The round-robin approach can also be used to load balance requests across packeting engines 1702-1704 as shown in FIG. 17D. The first time DNS system 1799 resolves the service name “MYSERVICE”, it resolves the name to the service IP address W1 (as shown in table 1735 in FIG. 17E), which is routed to packeting engine 1702 and ultimately to Server 1775. The second time DNS system 1799 resolves the service name “MYSERVICE”, it resolves the name to the service IP address W2, which is routed to packeting engine 1703 and, ultimately, to server 1776. The third time DNS system 1799 resolves the service name “MYSERVICE”, it resolves the name to the service IP address W3, which is routed to packeting engine 1704 and, ultimately, to server 1777. The next time DNS system 1799 resolves the service name “MYSERVICE”, it starts back at the WI service IP address. This round-robin approach can be used to incorporate a new packeting engine to share an existing packeting engine's workload.

Finally, if a customer uses a hardware load balancer to distribute traffic, that load balancer may be used in conjunction with the packeting engine. As shown in FIG. 17F, a load balancer 1795 may be moved to a segment attached to packeting engine 1705, which has a service IP address of W1. The existing connections between the load balancer 1795 and the end servers 1775-1777 remain. The hardware load balancer 1795 is defined as the end server within the service definition, and the packeting engine 1705 directs traffic from end users such as clients 1721-1726 (using service IP address W1) to the hardware load balancer 1795. The hardware load balancer 1795 then performs the required load distribution to the end servers 1775-1777.

A different load balancing configuration, shown in FIG. 17G, routes all customer traffic through load balancer 1796 before it is sent to the packeting engine 1706. In this configuration, the clients send packets addressed to “service W”, which DNS resolves to IP address LB as shown in table 1738 in FIG. 17H. IP address LB is the address of load balancer 1796, and when load balancer 1796 receives packets, it uses an algorithm to determine to which service IP address the packet should be addressed. Each service IP address is defined within the packeting engine 1706 to use a different end server 1775-1777. For example, when the load balancer 1796 opts to direct the packet to service IP address W1, the packeting engine 1706 sends the packet to server 1775. One or more intermediate appliances 1751, if any, may also be included in the sequence for service IP address W1. Similarly, when the load balancer 1796 opts to direct the packet to service IP address W2, the packeting engine 1706 sends the packet to server 1776 including, if any, one or more intermediate appliances 1751. Similarly, when the load balancer 1796 opts to direct the packet to service IP address W3, the packeting engine 1706 sends the packet to server 1777 and one or more, if any, intermediate appliances 1751.

The load balancer 1796, in this example, can also serve as a fail-over management device. Since it is equipped to recognize that traffic is not returning for a specific service IP address (usually an indication that the end server is unavailable), it fails over to another service IP address. By doing so, the fail-over management device causes the packeting engine 1706 to direct the packet through to an available server.

The incorporation of redundant packeting engines, as shown in FIG. 171, enhances fail-over even more. A fail-over management device 1797 recognizes when packeting engine 1707 fails and is able to send packets to packeting engine 1708 instead. The definitions for service IP addresses W1 through W3 on packeting engine 1707 are the same as the definitions for service IP addresses W7 through W9 on packeting engine 1708. W1 and W7 both use server 1775, W2 and W8 both use server 176, and W3 and W9 both use server 1777.

FIG. 17J depicts yet another enhancement to the fail-over approach, incorporating redundant sets of end servers 1791, 1792. Server set 1791 comprises servers 1775, 1776 and 1777. Server set 1792 comprises servers 1771, 1772 and 1773. Servers 1775 and 1771 are identically configured, as are servers 1776 and 1772 and servers 1777 and 1773. In this example, the packeting engines 1709 and 1710 use different end servers for the same service IP address. When the fail-over management device 1797 recognizes that traffic is not being returned for a specific service IP address, it directs those packets to the redundant packeting engine. So, for example, if through packeting engine 1709, service IP address W1 (which uses server 1775) is unavailable, the fail-over management device 1797 routes the request for service IP address W1 to packeting engine 1710, which uses server 1771 for that service IP address.

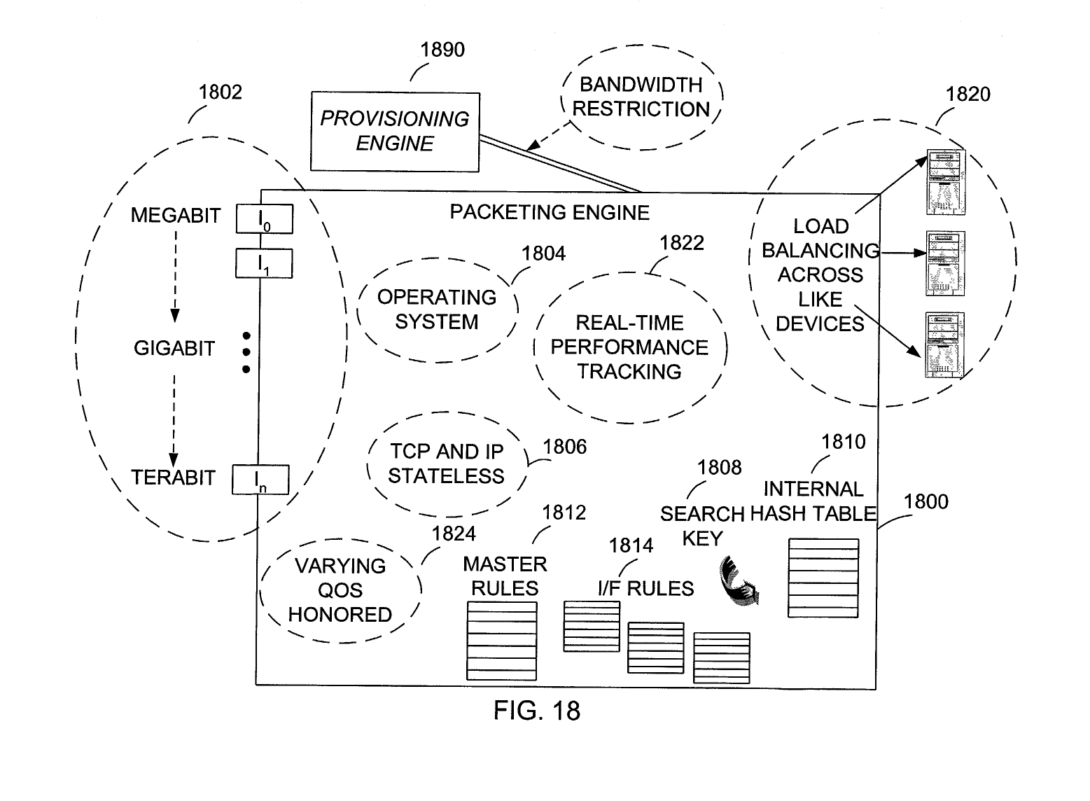

Embodiments of the present invention incorporate several additional features to ensure high-speed performance, each of which is depicted in FIG. 18.

High-Speed Interfaces:

An embodiment of a packeting engine 1800 can have one or more IP-based interfaces 1802, such as Ethernet, FDDI (Fiber Distributed Data Interface), or another interface. As indicated in FIG. 18, these interfaces support varying data transfer rates such as megabit, gigabit, or terabit speeds.

Operating System Performance:

Packeting engine 1800 can be configured for one or more different operating environments 1804, such as a 32-bit, 64-bit, 96-bit, and/or 128-bit operating systems. Embodiments of the present invention can operate with one or more of a variety of bus speeds. Accordingly, packeting engine 1800 can take advantage of available high performance capabilities provided by the operating system.

TCP and IP Stateless:

Unlike other network devices, such as web switches, embodiments of the present invention need not terminate the incoming TCP session, create a new TCP session to the end system, or track the TCP sequence. Accordingly, packeting engine 1800 can operate in a TCP and IP stateless mode, which can be much faster than devices that track one or two TCP sessions in a stateful manner. An embodiment of the present invention can support all sessions in a stateless manner.

Search Keys:

Another feature of an embodiment of packeting engine 1800 is the use of search keys 1808 that incorporate the service IP address to quickly access entries in internal hash tables 1810 for MAC, IP, and port routing processing, as well as ACL and Quality of Service (QoS) processing. As described earlier, packeting engine 1800 allows the service provider to centralize virtual firewall rules. Existing firewall rule sets can be transferred from customer firewalls to the packeting engine, which assumes responsibility for validating incoming packets against the firewall rules. As the number of customers increases, the number of transferred rules increases, and the centralized rule set can become very large. A current industry approach to rule processing is to validate a packet against a linear list (queue) of rules that are ordered by a numeric priority value until the packet is either allowed or denied. Since an embodiment of packeting engine 1800 must maintain significant throughput levels, the packeting engine requires efficiency in rule processing. Because packeting engine 1800 can incorporate service IP address operations, it can implement highly efficient rule-processing approaches such as the following.

ACL Search Keys Based Upon Interface and service IP address:

As packets arrive on one of the packeting engine interfaces 1802, they can be processed through a specific set of access control rules. The rules applicable to packets received on one interface may not be the same as those applicable to a different interface. Accordingly, the packeting engine 1800 supports the creation of a separate set of access control rules for each interface. The access control rule sets for the packeting engine interfaces 1802 can be combined into a master rule table 1812 that is separately indexed, or they can be stored in individually indexed interface-specific rule tables 1814.

For example, when a packet arrives, the packeting engine 1800 processes the packet against the appropriate set of rules for the interface. However, it does not process the packet against all rules in the interface's rule set. The packeting engine instead uses an additional key, the service IP address, to perform its ACL lookup. This ensures that the packet is processed against those rules of the interface's rule set that are applicable to the particular service IP address. Once the packeting engine validates the packet against the applicable rules, it includes the service IP address sequence table as part of the Forward Information Base (FIB). That FIB can be used to determine the next hop towards the destination specified in the sequence table.

Policy-Based Routing:

Policy-based routing allows an embodiment of a packeting engine to make routing decisions based upon a variety of information such as destination or source address, interface used, application selected, protocol selected, and packet size. Furthermore, by using policy-based routing and separate tables for each interface, the packeting engine 1800 can efficiently combine and process rules for destination routing, source routing, port-based routing, virtual firewall access control, Quality of Service (QoS), and packet distribution. During its processing, the packeting engine 1800 can extend the FIB search using the service IP address and an identifier for the interface on which the packet arrived.

Overhead Traffic Bandwidth Restricted:

To further enhance performance in an embodiment, the amount of bandwidth that can be used for updates between the provisioning engine 1890 and the packeting engine 1800 can be restricted.

Load Balancing:

As described earlier, embodiments of the present invention provide many alternatives to incorporate load balancing across like devices 1820.

Real-time Performance Tracking:

Packeting engine 1800, in an embodiment, can also track the responsiveness of one or more devices to which it directs packets and can notify the service provider administrator if a specific device is responding poorly. This real-time tracking feature 1822 enhances the administrator's ability to proactively manage the applications and resources available to customers.

Quality of Service Honored:

In an embodiment, packeting engine 1800 may include a Quality of Service feature 1824 so it can honor Quality Service requests that are specified in the Type of Service field of the IP header. Furthermore, the packeting engine 1800 is able to define the Quality of Service by modifying the Type of Service field of the IP header.

Accounting, Billing, and SNMP-based Monitoring:

Embodiments of the present invention not only support the definition and implementation of customized services, but also allow service providers to effectively account for each specific use of a service.

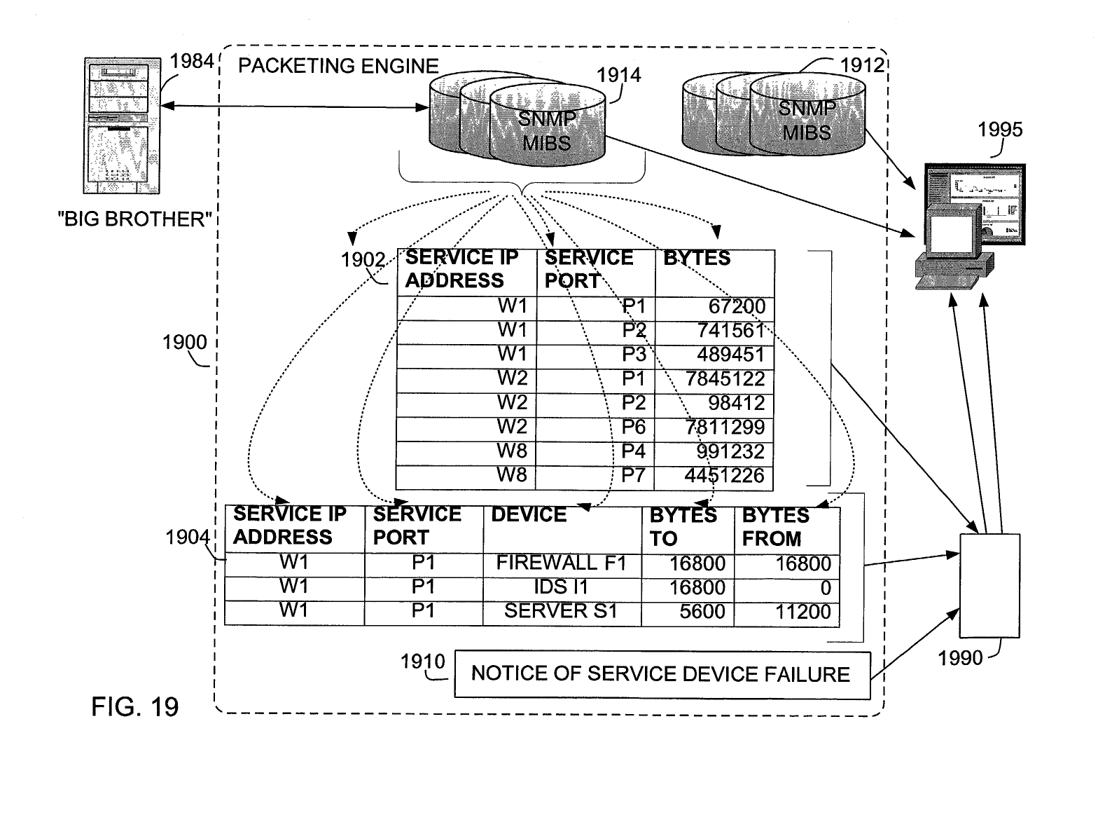

As shown in FIG. 19, an embodiment of a packeting engine 1900 can record statistics 1902 of packet transfers, which can be used for accounting and billing. The packeting engine 1900 can summarize the number of bytes processed for each service IP address and service port pair, as well as statistics 1904 of packet transfers associated with each device within the service. The provisioning engine 1990 can poll the packeting engine 1900 for these statistics on a regular basis and provides the summarized statistics to external accounting and billing systems 1995.

Although statistics can be recorded for each service IP address and service port pair, and for each device within a service, packeting engine 1900 can also record statistics based upon a client's IP address, when an access control rule is applied to that specific address.

Embodiments of the present invention also support SNMP-based monitoring as shown in FIG. 19. First, an embodiment of a packeting engine 1900 uses a socket 1910 to notify the provisioning engine 1990 when a device on one of its attached segments has failed. The provisioning engine 1990 then issues an SNMP trap defined by the service provider's or customer's monitoring facility. Second, the packeting engine 1900 can have an SNMP MIB 1912 to record information about its own health, so that it can notify monitoring systems directly if it is experiencing difficulties. The packeting engine 1900 can have a set of SNMP MIBs 1914 that provide indirect access to the packeting engine 1900's internal tables 1902 and 1904.

Accounting and monitoring systems 1995 can poll the MIBs 1914 for packet transfer statistics, device failures, and configuration details.

An embodiment of the present invention can be used in conjunction with an existing Big Brother system, which translates centralized, high-level policies into configuration changes on network devices. The Big Brother solution has a number of limitations, such as those described above. A Big Brother system can, however, perform some of the configuration functions of the provisioning engine. FIG. 19 depicts such a scenario—a Big Brother system 1984 can use the SNMP MIBs 1914 to upload and download configurations to and from the packeting engine 1900 internal tables 1902 and 1904.

Infrastructure and Service Maintenance:

Embodiments of the present invention may also include other features enabling a service provider to maintain a highly available and technically current environment as described below.

Configuration changes:

Because embodiments of the invention use a service IP address associated with a sequence of appliances and application servers, configuration changes are transparent to users. Accordingly, service providers have great flexibility to change devices, introduce new devices, or to remove devices from service without impacting its customers.

Device Pooling:

As previously described, embodiments of the present invention support the pooling of like devices, maintain records of those pools, and allow the service provider to dynamically redefine which device in a pool is used for a specific service IP address. Since the invention tracks pools of devices, the process of selecting and implementing a substitute device to temporarily assume workload is greatly simplified. Once a substitute device has been chosen, upgrades, remedial maintenance, or preventative maintenance can be performed on the original device, since it has been removed from service. Device failures, unplanned outages, and maintenance costs can be reduced because maintenance can be performed on a regular basis during normal business hours without disrupting service to the end user. Using the provisioning engine, the administrator merely switches to an alternate device while the original device undergoes maintenance.

Automated Service Regeneration:

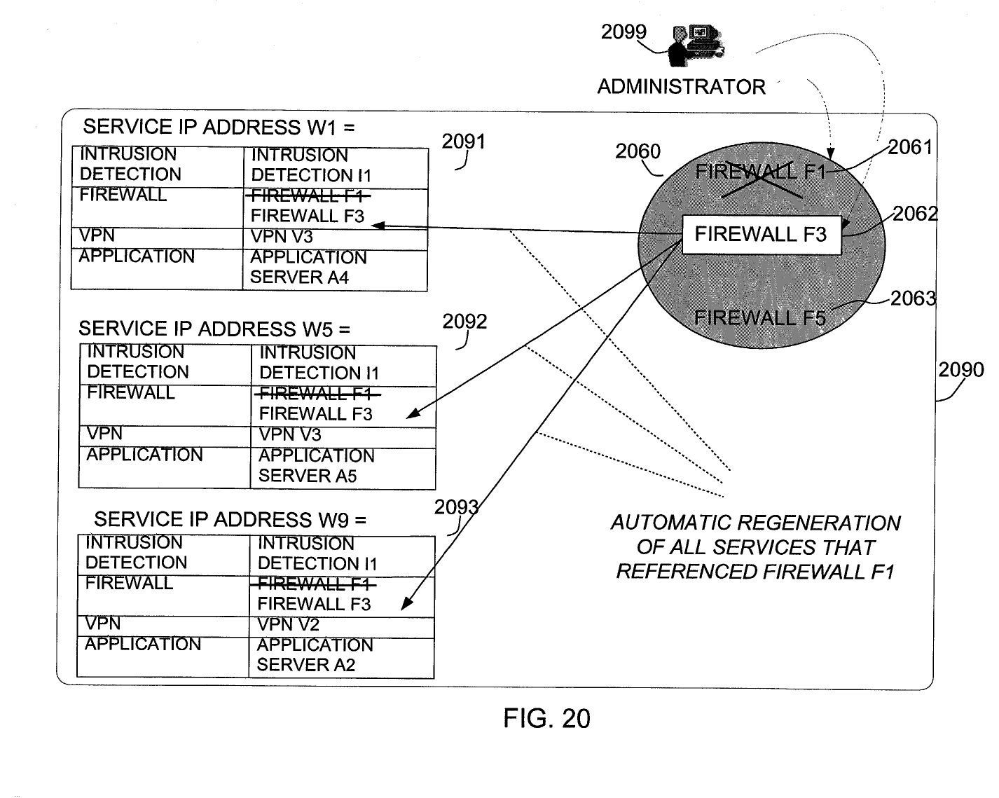

If a device does fail or if a device must be taken out of production for maintenance or upgrades, several service IP addresses may be affected. To simplify the processes for updating all affected services, the provisioning engine allows an administrator to specify the device that should assume the workload. In an embodiment, the provisioning engine automatically updates all services that previously used the original device. FIG. 20 depicts an administrator 2099 who wishes to remove firewall 2061 for maintenance. From the pool of like devices 2060 that includes firewalls 2061-2063, the administrator 2099 selects firewall 2062 to assume the workload. The provisioning engine 2090 automatically recognizes that service IP addresses W1, W5, and W9 had been using firewall 2061, and it automatically regenerates all of those services to use firewall 2062. Tables 2091, 2092, and 2093 show examples of internal data maintained by provisioning engine 2090 both before and after the services are regenerated.

Service Replication:

Embodiments of the present invention support the introduction of new devices by allowing the replication of an existing service IP address. The replica, which has a new service IP address and all of the original appliance and server definitions, can then be modified to incorporate the new device.

Access to the Production Infrastructure:

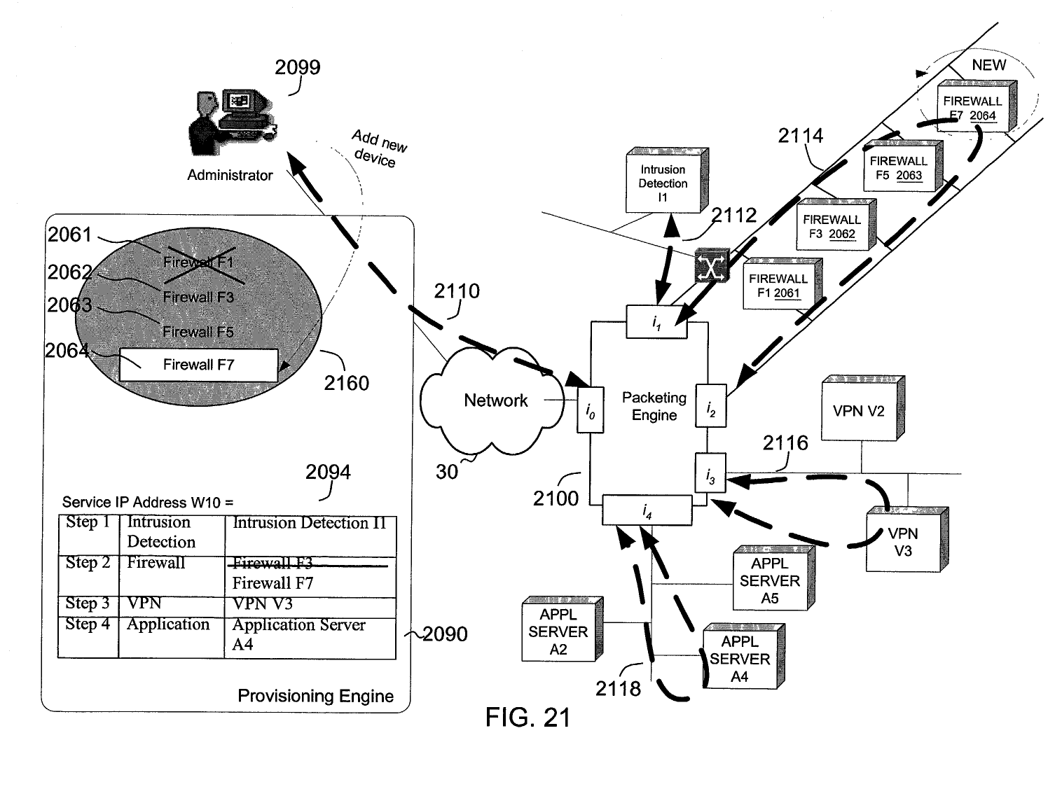

When a device is upgraded or a new device is introduced the invention allows the service provider to test the associated service using the real, production network infrastructure. This makes testing much more accurate, since it eliminates the use of lab environments, which do not reflect, or reflect only a portion of, the true network infrastructure. As shown in FIG. 21, the administrator 2099 has defined a new service, which is accessed by service IP address W10 as shown in table 2094. The new service is a replica of the service accessed with service IP address W1 (as shown in table 2091 in FIG. 20), except that it includes a new firewall F7 2064 that has just been attached to a segment connected to the packeting engine 2100.

Service Validation:

The administrator 2099 is able to perform simulation testing on the new service as shown in FIG. 21. This simulation testing performs a TCP handshake (links 2110, 2112, 2114, 2116 and 2118) with each device throughout the service to ensure that packets can be directed through the entire sequence of devices. After simulation testing is complete, the customer is able to test the new service IP address to ensure that the end application can be accessed as expected. The invention enables the service provider to trace this testing using both the client's IP address and the service IP address, and enables the generation of a report of the testing that was performed.

Cut-over:

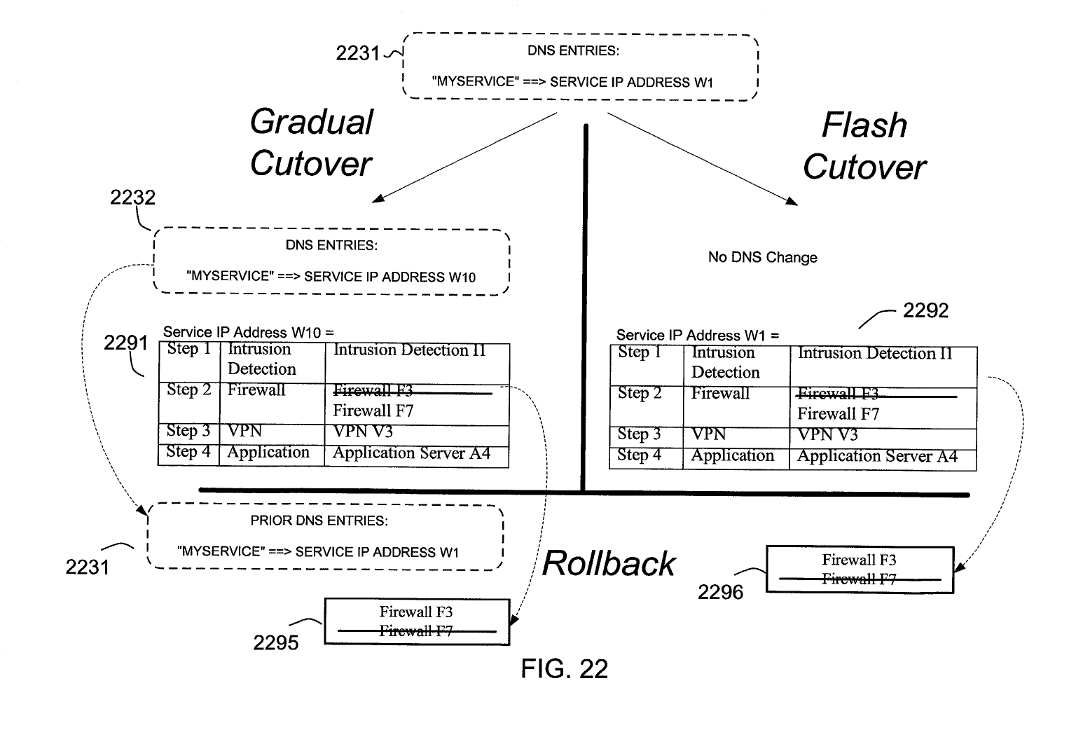

Once a device has been fully tested, it can be introduced to the new or modified service. This can be accomplished in a variety of ways. For example, the customer's DNS entry can be modified to remap the service name to the new service IP address. Customers that are already using the old service IP address continue to do so until their next request for DNS resolution, which will direct them to the new service IP address. This approach provides a gradual cut-over of the service IP address. As shown in FIG. 22, the administrator can perform a gradual cut-over by changing the prior DNS mapping 2231 to the new DNS mapping 2232 so that customer requests for the service name are resolved to the new service IP address W10. Customers that are currently using service IP address W1 can continue to do so.

However, the next time that each customer makes a request to the DNS server to resolve the service name, the service name will be resolved to the new service IP address of W10.

Another method for introducing the new device or service IP address includes changing an IP address in the service definition, to point to the new or upgraded system. This causes a “flash” (immediate) cut-over to the new/upgraded system. As shown in FIG. 22, the administrator can perform a flash cut-over by changing the entry for a firewall in the service IP address W1 definition table 2292. Customers already accessing service IP address W1 will therefore begin using firewall F7 2064 immediately.

Rollback:

If unanticipated problems do result, the new or modified device can be removed from production. As shown in FIG. 22, if the administrator used a gradual cut-over (i.e., modified the DNS entry for the service named MYSERVICE to resolve to service IP address W10), the administrator would perform the reverse action (i.e., modify the DNS table 2232 entry to again resolve to service IP address W1). This ensures that future DNS requests are resolved to service IP address W1 that is known to work. The administrator would also use the provisioning engine to modify the service IP address W10 definition table 2291 to use the original W1 service sequence as shown in box 2295. This ensures that users who are already accessing W10 return to a service sequence that is known to work.

If the administrator used a flash cut-over (modified the service IP address W1 definition 2292 to incorporate firewall F7 2064), the administrator can use the provisioning engine to immediately back out the update. The administrator would simply modify the service IP address W1 definition table 2292 to remove firewall F7 2064 and again include firewall F3 2062 as shown in box 2296.

ISP Solution:

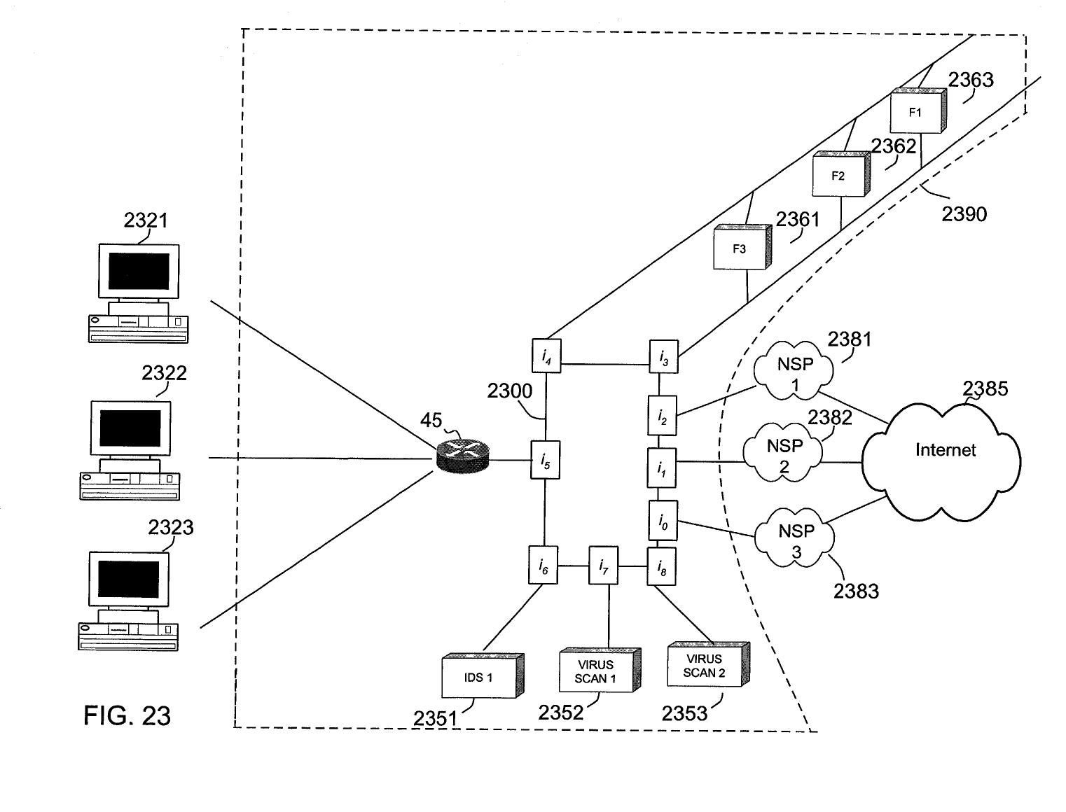

As described earlier, embodiments of the present invention can be useful to application service providers and their customers. The previous examples are not intended in any way, however, to restrict use of embodiments of the invention. Embodiments of the invention can provide benefits in many other environments, and FIG. 23 depicts an Internet Service Provider (ISP) using an embodiment of the present invention.

In FIG. 23, the ISP network 2390 includes a packeting engine 2300 between clients 2321-2323 and the network service providers 2381-2383 coupled to the Internet 2385. The packeting engine 2300 directs the client packets through a series of appliances, including an intrusion detection system 2351 one or more virus scanning devices 2352-2353, and one or more of firewalls 2361-2363. Since companies that create virus scanning software differ in their capabilities to detect viruses and to issue timely virus signature updates, multiple virus scanning devices may be used as a “safety net” to improve the chances of detecting a virus. In previous examples of the invention, embodiments of a packeting engine used a service IP address to direct packets and disregarded the client's address. To perform its role in the ISP solution, an embodiment of a packeting engine 2300 can be configured to do just the opposite, i.e., use the client's IP address as the service IP address. Therefore, the sequence of appliances is determined from the service IP address, which is actually the client address that was assigned by the ISP 2390.

Once the traffic of clients 2321-23 has successfully passed through the intermediate appliances, the packeting engine 2300 directs the client's traffic to one of network service providers 2381-83. To determine the appropriate network service provider, the packeting engine 2300 uses the client address that was assigned by the ISP 2390.

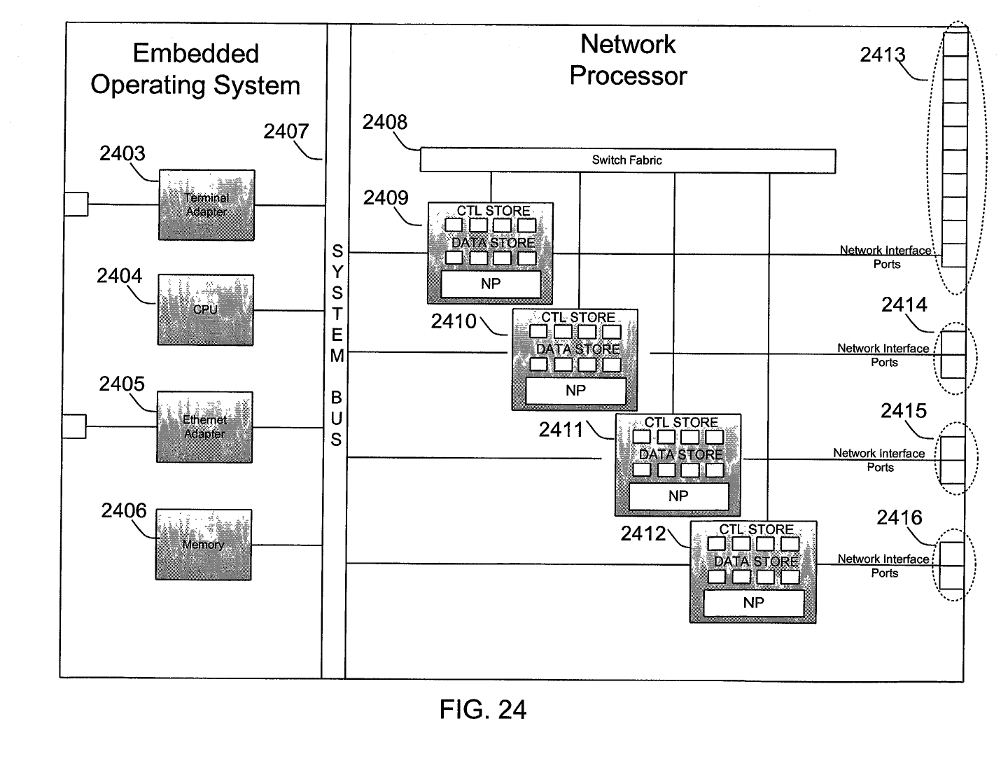

FIG. 24 shows a schematic illustration of components of an embodiment of the present invention. The embodiment includes an embedded operating system, which controls a terminal adapter 2403 to accept command line input from a directly-attached device such as a laptop, a CPU 2404 for command processing, an Ethernet adapter 2405 for network communications with systems such as a provisioning engine, and memory 2406, where instructions and data can be stored. The embodiment also includes one or more network processors 2409-2412, each with an associated control (“CTL”) store, where picocode program instructions are kept, and a data store (memory). The network processors 2409-2412 can support the wire-speed processing of packets received on network interface ports 2413-2416. Ports 2413-2416, which can support one or more network technologies such as Ethernet, Synchronous Optical Network (“SONET”), or Asynchronous Transfer Mode (“ATM”), enable inbound and outbound communications with the appliances and application servers (not shown in FIG. 24) that support customer services. Switch fabric 2408 supports the transmission of data between network processors. Finally, the system bus 2407 supports communications between the embedded operating system, which receives requests from the provisioning engine, and the network processor(s), which are configured for the real-time processing of service packets.

Systems and methods in accordance with embodiments of the present invention, disclosed herein, remove the constraints that have limited service provider offerings and profitability. Using an embodiment of the invention, a service provider is able to differentiate its services from those of other service providers and thereby attract new subscribers. The benefits to the service provider and its subscribers can be significant.

Embodiments can allow a service provider to offer the exact service that the customer requires. An embodiment of the invention supports the use of any IP-based appliance or application server. Those IP-based systems can then be used in various combinations and various orders required to meet the subscriber's needs. The embodiment manages the flow of traffic through a service, which is a sequence of appliances and application servers that is defined by the service provider. The service may be dynamically redefined as required to meet the customer needs, and IP-based systems that are attached to the packeting engine need not be moved or reconfigured to support modifications to a service sequence.

According to an embodiment of the invention, a packeting engine supports many or all of the major brands or types of a device with the compatible version selected for each customer (e.g., at the click of a button). This capability allows the Service Provider to create a best of breed solution, meet the compatibility requirements of any customer, and charge for what the customer actually uses. Using an embodiment of the invention, the service provider can offer the subscriber the same sort of customized IP environment that it would have built for itself if it could afford it. Moreover, by enabling a customer to pay for only what is valued, it is able to achieve higher market penetration. Embodiments of the invention also allow the service provider to offer end users and subscribers different combinations of network elements that constitute unique service packages.

A service may incorporate Internet hosts and other devices that are not attached to a packeting engine. A service provider can quickly tie network elements together, on an “any-to-any” basis, regardless of where they physically reside.

Small or medium businesses typically must use outsourcing approaches to keep costs low. Small businesses, in particular, have a keen interest in flexible, customizable, and affordable solutions to IP networking services. They are often precluded from using the “hard-wired” technology because the cost to establish the environment is prohibitively expensive. Using an embodiment of the invention, the service provider can offer tailored services to the small and medium markets.

An embodiment of the invention reduces the time required to provision a subscriber's service because all customization of service sequencing is performed through a simple web interface. Service providers can respond to changing market needs and emerging new opportunities rapidly, and bring new services online (e.g., at the click of a button). The service provider's labor costs can drop substantially and compatible services can be delivered to the customer in minutes, not days or weeks.

According to an embodiment, the invention directs IP traffic through the same sequence of applications as would have been “hard-wired” before and it avoids application-level interaction with the network components. Since a customized sequencing of applications can be performed at the IP level, a service provider is able to share network infrastructure between customers and is able to provide each customer with compatible, customized services without duplicating infrastructure components. Then, using its algorithms for workload distribution, an embodiment can ensure that each shared component is utilized at an optimum level. This shared and optimized infrastructure can be less costly for the service provider, so the service provider can increase profits or decrease the cost to the consumer.

In an embodiment, a service provider can remove network components from “hard-wired” configurations and redeploy them in support of the entire customer base.

This allows service providers to reduce redundant components from, for example, hundreds to a handful. Each remaining system can then support multiple customers and multiple services. This frees up rack space for additional services and subscribers and it greatly reduces maintenance and operation costs. It also allows the service provider to achieve a higher return on investment (ROI) on its infrastructure.

According-to an embodiment, the invention is capable of automatically selecting the devices that will support a service and is capable of determining the optimum sequence for each service, the invention allows the subscriber administrator to make those decisions, where necessary, based upon specific business requirements or other factors. Similarly, an embodiment of the invention allows customers to control their own access control rules.

A typical service provider environment includes dedicated firewall operations personnel that manage access control rules for subscribers. This is a costly proposition, in labor, customer satisfaction (delays of up to a day may occur), and in liability (the service provider may be liable for mistakes made in managing access rules on behalf of a subscriber). An embodiment of the invention allows the service provider to move access control rules from existing firewalls and to centralize those rules on the packeting engine. Subscribers can then view and modify the access control rules from the provisioning engine. Subscribers can get “instant gratification” for access control changes, while service providers can reduce or eliminate firewall operations staff, remote firewall management infrastructure, and liability associated with making changes to access control rules. Furthermore, service providers can redeploy the firewalls as shared devices because subscriber-specific settings have been removed.

An embodiment can provide real-time intrusion detection. Promiscuous mode applications, such as intrusion detection and HTTP access control devices with pass by technology, have traditionally been unable to keep pace with the high network traffic bandwidths of production environments. An embodiment of the invention implements the unique capability to selectively direct traffic, based upon virtual service IP address and protocol, onto multiple promiscuous mode application servers so that intrusion detection systems can perform real-time analysis of customer traffic. Those intrusion detection systems can be identical, as in the same model from the same manufacturer, or can be different models from different manufacturers.

An embodiment of the present invention bands together multiple appliances and end servers into a unique service and provides customized and relevant security for that service. The cost and inconvenience of applying comprehensive security measures are greatly mitigated, since tailored security infrastructures can be so easily designed and implemented. It is known that comprehensive security architectures can include multiple vendors' products to reduce the risk of a security breach. One or more embodiments of the present invention embrace all network devices and enable a completely open, multi-vendor, best-of-breed solution to security. Customers are not locked into a single vendor. They may fully leverage their existing investment in security applications and appliances, and can be assured that as new products enter the market, they can exploit them.

A service provider, in an embodiment, can rapidly incorporate new technologies, since the packeting engine directs the flow of IP packets within the customized service. Furthermore, service providers no longer have to wait until all users are ready for a new device before deploying it in the network. Users who are not ready for the new version (because they lack the new client software, adequate hardware resources, etc.) can be directed to a back-leveled device, while users with the proper client configuration can begin to take advantage of the new technology. This capability makes valued upgrades available sooner to customers who are ready for them, while continuing to support customers who are not.

The service provider, in an embodiment, can account for all functions used in service. In addition, the infrastructure supports powerful “back-office” functions for reporting network activity or system utilization. With an XML-based, open architecture, a reporting engine readily integrates with most popular third-party billing and analysis systems on the market. The reporting engine will provide the information necessary to charge subscribers for what they actually use and will allow users to use, and be billed for, just those applications that they need.

High levels of availability can be maintained. An embodiment of the invention ensures high availability for packeting engines and for the managed service elements. Downtime required for maintenance purposes can also be reduced.

According to an embodiment of the present invention, a pair of packeting engines support redundancy and load sharing. This ensures that packet processing can occur at a real-time pace and without disruption. Several forms of load balancing that equitably distribute traffic to a set of like devices can minimize the risk of one device failing because it is used excessively.

Managed service elements can be provided in an embodiment of the present invention. The service provider can define pools of like devices (e.g., by manufacturer and model, by function, and so on) and then redirect traffic to an alternate device if the standard application device fails. This capability frees the service provider from implementing OEM-specific fail-over mechanisms and supports the ability to perform fail-over between devices from different manufacturers. Furthermore, in an embodiment, the invention automatically regenerates all affected services to use the alternate instead of the failed device. This eliminates the potential for service disruption.

A customer's service may be dynamically redefined, for example, as often as required, to accommodate maintenance activities. The service provider can define a pair of identically configured systems to serve as a primary and secondary. An embodiment of the invention can redirect traffic on demand to the secondary system so that the primary may be taken offline for maintenance. This allows maintenance to be performed during normal business hours and the resulting benefits are considerable. Planned downtimes for maintenance (maintenance windows) can be virtually eliminated, the morale and efficiency of service provider staff can be improved because off-hours work is not required, third shift differential pay can be reduced, and services can remain available during periods of maintenance.

Embodiments of the invention can provide automated facilities to manage services and the associated changes to those services. These automated facilities support “push button” creation, testing, implementation, and rollback (if required) of new or modified services.

There can be an inherent disparity between lab and production network environments, and it is often extremely labor-intensive to configure, integrate, and migrate new elements into the network. Using an embodiment of the invention, service providers can eliminate costly, redundant lab environments. The service provider can create a test version of a service to include the existing production service components and the new element. Elements can then be extensively tested and, when testing is successfully completed, the test version of the service can be migrated to production (e.g., through the click of a mouse). This procedure can significantly reduce the incidence of unforeseen problems when new devices or configurations are cut over into production mode. Testing upgraded elements can be fast, easy, and accurate. There can be fewer surprises and rollbacks, and fewer service interruptions.

A service provider can either gradually or immediately implement (cut-over) new services or service modifications. Service changes related to transparent appliances, such as firewalls, can be implemented virtually instantaneously. Administrators can easily define and implement a schedule of rolling cut-overs to the new infrastructure because cut-overs can be achieved, in an embodiment, at the click of a button. This approach minimizes the chances of a critical failure during the transition.

A service provider can also roll back configuration changes that cause unanticipated problems on the network. For example, a new device can be removed from production rapidly, for example, at the click of a button. An ability to perform push-button rollback can result in shorter service interruptions.

In an embodiment, instructions adapted to be executed by a processor to perform a method are executed by a computing device (e.g., a computer, a workstation, a network server, a network access device, and so on) that includes a processor and a memory. A processor can be, for example, an Intel Pentium® IV processor, manufactured by Intel Corporation of Santa Clara, Calif. As other examples, the processor can be an Application Specific Integrated Circuit (ASIC), or a network processor with Content Addressable Memory (CAM). A server can be, for example, a UNIX server from Sun Microsystems, Inc. of Palo Alto, Calif. The memory may be a random access memory (RAM), a dynamic RAM (DRAM), a static RAM (SRAM), a volatile memory, a non-volatile memory, a flash RAM, polymer ferroelectric RAM, Ovonics Unified Memory, magnetic RAM, a cache memory, a hard disk drive, a magnetic storage device, an optical storage device, a magneto-optical storage device, a combination thereof, and so on. The memory of the computing device can store a plurality of instructions adapted to be executed by the processor.

In accordance with an embodiment of the present invention, instructions adapted to be executed by a processor to perform a method are stored on a computer-readable medium. The computer-readable medium can be a device that stores digital information. For example, a computer-readable medium includes a compact disc read-only memory (CD-ROM) as is known in the art for storing software. In another embodiment, a computer-readable medium includes a ROM as in known in the art for storing firmware. The computer-readable medium is accessed by a processor suitable for executing instructions adapted to be executed. The terms “instructions adapted to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Embodiments of the invention can provide continuous, high-speed packet processing. Embodiments of the invention can be designed to take advantage of operating system and hardware performance features. It is highly scalable in design, so that additional services, devices, and packeting engines may be added to address future customer requirements.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

The foregoing disclosure of the preferred embodiments of the present invention has been presented for purpose of illustration and description. It is not intended to be exhaustive or to limit the invention to the precise forms disclosed. Many variations and modifications of the embodiments described herein will be appreciated by one of ordinary skill in the art in light of the above disclosure. The scope of the invention is to be defined only by the claims appended hereto, and by their equivalents.

What is claimed is:

1. A method of managing delivery of a network service, the method comprising:
receiving a data packet, the data packet including a service address and a payload;
identifying a plurality of network applications associated with the service address of the data packet, the plurality of network applications associated with the service address including a first network application and a second network application, the first network application being different than the second network application;
sending at least the payload of the data packet to the first network application;
receiving a first network application response packet from the first network application; and
sending a second network application packet to the second network application, the second network application packet based at least in part on the first network application response packet.

2. The method of claim 1, further comprising:
receiving a second network application response packet from the second network application; and
sending a service response packet to a source address of the data packet, the service response packet based at least in part on the second network application response packet.

3. The method of claim 2, wherein sending a service response packet to a source address of the data packet includes generating the service response packet as a data product.

4. The method of claim 1, wherein:
the first network application has a first network application address; and
sending at least the payload of the data packet to the first network application includes identifying the first network application address based at least in part on the service address.

5. The method of claim 4, wherein:
the first network application response packet includes a first network application response source address;
the second network application has a second network application address; and
sending a second network application packet to the second network application includes identifying the second network application address based at least in part on the first network application response source address.

6. The method of claim 5, wherein the first network application address is different from the first network application response source address.

7. The method of claim 5, wherein the first network application address is the same as the first network application response source address.

8. The method of claim 4, wherein:
the data packet includes a service port identifier; and
sending at least the payload of the data packet to the first network application includes identifying the first network application address based at least in part on the service port identifier.

9. The method of claim 4, wherein:
the data packet is received on a first network interface; and
sending at least the payload of the data packet to the first network application includes identifying the first network application address based at least in part on the data packet being received on the first network interface.

10. The method of claim 1, wherein:
receiving a data packet includes receiving a data packet via a first network interface;
sending at least the payload of the data packet to the first network application includes sending at least the payload of the data packet to the first network application via a second network interface, the second network interface being different from the first network interface; and
receiving a first network application response packet from the first network application includes receiving the first network application response packet from a third network interface, the third network interface being different from the second network interface and the first network interface; and
sending a second network application packet to the second network application includes sending the second network application packet to the second network application via a fourth network interface, the fourth network interface being different from the third network interface, the second network interface, and the first network interface.

11. The method of claim 10, further comprising:
receiving a second network application response packet from the second network application via the fourth network interface;
sending a first network application return packet to the first network application via the third network interface, the first network application return packet based at least in part on the second network application response packet;
receiving a first network application return response packet from the first network application via the second network interface; and
sending a service response packet via the first network interface, the service response packet based at least in part on the first network application return response packet.

12. The method of claim 1, wherein:
receiving a data packet includes receiving a data packet via a first network interface;
the first network application having a first network application address; and
sending at least the payload of the data packet to the first network application includes
identifying the first network application address based at least in part on the service address of the data packet and the first network interface, and
sending at least the payload of the data packet to the first network application via a second network interface, the second network interface being different than the first network interface.

13. The method of claim 12, wherein
the data packet includes a service port identifier;
identifying the first network application address is based at least in part on the service port identifier.

14. The method of claim 1, wherein:
sending at least the payload of the data packet to the first network application is based at least in part on a stateless identification of the first network application; and
sending a second network application packet to the second network application is based at least in part on a stateless identification of the second network application.

15. The method of claim 1, wherein:
sending at least the payload of the data packet to the first network application is based at least in part on a stateful identification of the first network application; and
sending a second network application packet to the second network application is based at least in part on a stateful identification of the second network application.

16. The method of claim 1, wherein the first network application is a first version of a network application and the second network application is a second version of the network application.

17. The method of claim 16, wherein the first version of the network application is from a first vendor, the second version of the network application is from a second vendor, and the first vendor is different from the second vendor.

18. The method of claim 16, wherein the network application is selected from the group consisting of an intrusion detection application, a virus detection application, a virtual private network application, a firewall application, a web switch, a network security application, a load balancing application, a proxy application, and a database application.

19. The method of claim 1, wherein:
the first network application is selected from the group consisting of an intrusion detection application, a virus detection application, a virtual private network application, a firewall application, a web switch, a network security application, a load balancing application, a proxy application, and a database application; and
the second network is a different network application selected from the group consisting of an intrusion detection application, a virus detection application, a virtual private network application, a firewall application, a web switch, a network security application, a load balancing application, a proxy application, and a database application.

20. A method of processing units of data, the method comprising:
receiving a first data unit at a first network interface, the first data unit including a service address;
identifying a plurality of application systems based at least in part on the service address, the plurality of application systems including a first application system and a second application system;
sending a second data unit to the first application system via a second network interface, the second data unit based at least in part on the first data unit, the second network interface being different from the first network interface;
receiving a third data unit from the first application system via a third network interface, the third network interface being different from the second network interface and the first network interface; and
sending a fourth data unit to the second application system via a fourth network interface, the fourth data unit based at least in part on the third data unit.

21. The method of claim 20, wherein:
the first application system has a first application system address;
sending a second data unit to the first application system via a second network interface includes identifying the first application system address based at least in part on the service address and the first network interface;
receiving a third data unit from the first application system via a third network interface includes receiving a third data unit having a first application system source address;
the second application system has a second application system address; and
sending a fourth data unit to the second application system via a fourth network interface includes identifying the second application system address based at least in part on the first application system source address and the third network interface.

22. The method of claim 21, wherein:
the data packet includes a data packet service port identifier;
identifying the first application system address is further based at least in part on the service port identifier of the data packet;
receiving a third data unit from the first application system via a third network interface includes receiving a third data unit having a third data unit port identifier; and
identifying the second application system address is further based at least in part on the third data unit port identifier.

23. The method of claim 20, further comprising:
receiving a fifth data unit from the second application system via the fourth network interface;
sending a six data unit to the first application system via the third network interface, the six data unit based at least in part on the fifth data unit;
receiving a seventh data unit from the first application system via the second network interface; and
sending an eighth data unit to a source address of the data packet via the first network interface, the eighth data unit based at least in part on the seventh data unit.

24. The method of claim 23, wherein
the first application system has a first application system address;
sending a second data unit to the first application system via a second network interface includes identifying the first application system address based at least in part on the service address and the first network interface;
receiving a third data unit from the first application system via a third network interface includes receiving a third data unit having a first application system source address;
the second application system has a second application system address;
sending a fourth data unit to the second application system via a fourth network interface includes identifying the second application system address based at least in part on the first application system source address and the third network interface;
receiving a fifth data unit from the second application system via the fourth network interface includes receiving a fifth data unit having a second application system source address; and
sending a sixth data unit to the first application system via the third network interface includes identifying the first application system based at least in part on the second application system source address and the third network interface.

25. The method of claim 24, wherein:
the data packet includes a data packet service port identifier;
identifying the first application system address is further based at least in part on the service port identifier of the data packet;
receiving a third data unit from the first application system via a third network interface includes receiving a third data unit having a third data unit port identifier;
identifying the second application system address is further based at least in part on the third data unit port identifier;
receiving a fifth data unit from the second application system via the fourth network interface includes receiving a fifth data unit having a fifth data unit port identifier; and
sending a sixth data unit to the first application system via the third network interface includes identifying the first application system based at least in part on the fifth data unit port identifier.

26. The method of claim 21, wherein identifying the first application system is based at least in part on a stateless identification of the first application system.

27. The method of claim 21, wherein identifying the first application system is based at least in part on a stateful identification of the first application system.

28. The method of claim 23, further comprising:
sending the data packet to the first network interface; and
receiving the eighth data unit via the first network interface.

29. The method of claim 23, wherein sending a sixth data unit to the first application system via the third network interface includes generating the sixth data unit as a data product.

30. A method to manage delivery of a network service, the method comprising:
receiving a data packet having a service address and a service port identifier;
identifying a plurality of network applications based at least in part on the service address, the plurality of network applications including at least a first network application and a second network application;
sequentially processing the data packet through at least the first network application and the second network application based at least in part on the service address and the service port identifier; and
sending a data packet service response based at least in part on the data packet sequential processing.

31. The method of claim 30, wherein sequentially processing the data packet through at least the first network application and the second network application consists essentially of statelessly sequentially processing the data packet through at least the first network application and the second network application.

32. The method of claim 30, wherein:
receiving a data packet having a service address and a service port identifier includes receiving the data packet via a first network interface;
sequentially processing the data packet through at least the first network application and the second network application based at least in part on the service address and the service port identifier includes sequentially processing the data packet through at least the first network application and the second network application via one or more additional network interfaces, the one or more additional network interfaces being different from the first network interface; and
sending a data packet service response based at least in part on the data packet sequential processing includes sending the data packet service response via the first network interface.

33. The method of claim 30, wherein sending a data packet service response based at least in part on the data packet sequential processing includes generating the data packet service response as a data product based at least in part on the data packet sequential processing.

34. A system to manage delivery of a network service, the system comprising:
a first network interface to receive a data packet, the data packet including a service address;
packet sequencing logic to store packet sequential processing information, the packet sequential processing information including a service address field to store a service address, the packet sequential processing information including a plurality of packet sequencing entries, one or more of the packet sequencing entries of the plurality of packet sequencing entries including
a source address field to store a source address, and
a destination address to store a destination address; and
a second network interface to transmit at least the payload of the data packet to a first network application system of a plurality of network application systems associated with the service address, the second network interface being different from the first network interface;
a third network interface to receive a first network application response packet, the third network interface being different from the second network interface and the first network interface; and
a fourth network interface to send a second network application packet to a second network application system of the plurality of network application systems associated with the service address, the second network application packet based at least in part on the first network application response packet, the second network application system being different from the first network application system, the fourth network interface being different from the third network interface, the second network interface, and the first network interface.

35. The system of claim 34, wherein one or more of the packet sequencing entries of the plurality of packet sequencing entries include:
a received interface field to store a received interface identifier; and
a send interface field to store a send interface identifier.

36. The system of claim 34, wherein:
the data packet includes a first service port identifier, and
one or more packet sequencing entries of the plurality of packet sequencing entries include a service port field to store a service port identifier.

37. The system of claim 34, wherein:
the data packet includes a first service port identifier; and
one or more packet sequencing entries of the plurality of packet sequencing entries include
a received interface field to store a received interface identifier,
a service port field to store a service port identifier,
a send interface field to store a send interface identifier, and
a send address field to store a send address.

38. The system of claim 37, wherein the send address is a network address of a network application system of the plurality of network application systems.

39. The system of claim 37, wherein the send address is a media access controller address of a network application system of the plurality of network application systems.

40. The system of claim 37, wherein each packet sequencing entry of the plurality of packet sequencing entries includes a destination system type field to store a destination system type identifier.

41. The system of claim 34, wherein the first network application system is a first implementation of one network application system and the second network application system is a second implementation of the one network application system.

42. The system of claim 34, further comprising a plurality of network application systems, one or more of the plurality of network application systems coupled to one or more of the second network interface, the third network interface, and the fourth network interface.

43. The system of claim 42, wherein the plurality of network application systems include one or more of an intrusion detection application system, a virus detection application system, a virtual private network application system, a firewall application system, a web switch system, a network security application system, a proxy application system, a database application system, and a load balancing application system.

44. The system of claim 34, wherein:
the first network application system is selected from the group consisting of an intrusion detection application system, a virus detection application system, a firewall system, a web switch system, a network security application system, and a load balancing application system; and
the second network application system is a different network application system selected from the group consisting of an intrusion detection application system, a virus detection application system, a virtual private network application system, a firewall application system, a web switch system, a network security application system, a proxy application system, a database application system, and a load balancing application system.

45. The system of claim 34, wherein the data packet uses one or more protocols from one of a TCP/IP network protocol suite and a UDP/IP network protocol suite.

46. The system of claim 45, wherein the one or more protocols include an IPv4 network protocol.

47. The system of claim 45, wherein the one or more protocols include an IPv6 network protocol.

48. The system of claim 34, wherein the data packet uses one or more of a layer 2 protocol, a layer 3 protocol, and a layer 4 protocol.

49. The system of claim 48, wherein the layer 2 protocol is selected from the group consisting of ATM and frame relay.

50. The system of claim 48, wherein the layer 3 protocol is MPLS.

51. The system of claim 34, wherein the packet sequential processing information lacks information that supports stateful processing.

52. The system of claim 34, wherein the packet sequential processing information includes information that supports stateful processing.

53. The system of claim 34, wherein the packet sequential processing information consists essentially of information that supports stateless processing.

54. A system to manage delivery of a network service, the system comprising:
means for receiving a data packet having a service address and a service port identifier;
means for identifying a plurality of network applications based at least in part on the service address, the plurality of network applications including at least a first network application and a second network application;
means for sequentially processing the data packet through at least the first network application and the second network application based at least in part on the service address and the service port identifier; and
means for sending a data packet service response based at least in part on the data packet sequential processing.

55. The system of claim 54, wherein the means for sequentially processing the data packet through at least the first network application and the second network application includes means for statelessly sequentially processing the data packet through at least the first network application and the second network application.

56. The system of claim 54, wherein:
the means for receiving a data packet having a service address and a service port identifier includes means for receiving the data packet via a first network interface;
the means for sequentially processing the data packet through at least the first network application and the second network application based at least in part on the service address and the service port identifier includes means for sequentially processing the data packet through at least the first network application and the second network application via one or more additional network interfaces, the one or more additional network interfaces being different from the first network interface; and
the means for sending a data packet service response based at least in part on the data packet sequential processing includes means for sending the data packet service response via the first network interface.

57. A method to manage delivery of a network service, the method comprising:
a step for receiving a data packet having a service address and a service port identifier;
a step for identifying a plurality of network applications based at least in part on the service address, the plurality of network applications including at least a first network application and a second network application;
a step for sequentially processing the data packet through at least the first network application and the second network application based at least in part on the service address and the service port identifier; and
a step for sending a data packet service response based at least in part on the data packet sequential processing.

58. The method of claim 57, wherein the step for sequentially processing the data packet through at least the first network application and the second network application includes a step for statelessly sequentially processing the data packet through at least the first network application and the second network application.

59. The method of claim 57, wherein:
the step for receiving a data packet having a service ad-dress and a service port identifier includes a step for receiving the data packet via a first network interface;
the step for sequentially processing the data packet through at least the first network application and the second network application based at least in part on the service address and the service port identifier includes a step for sequentially processing the data packet through at least the first network application and the second network application via one or more additional network interfaces, the one or more additional network interfaces being different from the first network interface; and
the step for sending a data packet service response based at least in part on the data packet sequential processing includes a step for sending the data packet service response via the first network interface.

60. A computer-readable medium storing a plurality of instructions to be executed by a processor to manage delivery of a network service, the plurality of instructions comprising instructions to:
receive a data packet having a service address and a service port identifier;
identify a plurality of network applications based at least in part on the service address, the plurality of network applications including at least a first network application and a second network application;
sequentially process the data packet through at least the first network application and the second network application based at least in part on the service address and the service port identifier; and
send a data packet service response based at least in part on the data packet sequential processing.

61. The computer-readable medium of claim 60, wherein the instructions to sequentially process the data packet through at least the first network application and the second network application include instructions to statelessly sequentially process the data packet through at least the first network application and the second network application.

62. The computer-readable medium of claim 60, wherein:
the instructions to receive a data packet having a service address and a service port identifier include instructions to receive the data packet via a first network interface;
the instructions to sequentially process the data packet through at least the first network application and the second network application based at least in part on the service address and the service port identifier include instructions to sequentially process the data packet through at least the first network application and the second network application via one or more additional network interfaces, the one or more additional network interfaces being different from the first network interface; and
the instructions to send a data packet service response based at least in part on the data packet sequential processing include instructions to send the data packet service response via the first network interface.
